(19) United States
(12) Patent Application Publication
(10) Pub. No.: US 2026/0172743 A1
(43) Pub. Date: Jun. 18, 2026

(54) AUDIO-BASED USER ENGAGEMENT DETECTION

(71) Applicant: Amazon Technologies, Inc., Seattle, WA (US)

(72) Inventors: Carlo Murgia, Santa Clara, CA (US); Shobha Devi Kuruba Buchannagari, Fremont, CA (US); Carlos Renato Nakagawa, San Jose, CA (US); Ian Ernan Liu, San Diego, CA (US)

(21) Appl. No.: 18/980,211

(22) Filed: Dec. 13, 2024

(51) Int. Cl. H04R 1/32; G10L 15/22; H04R 3/00

(52) U.S. Cl. CPC H04R 1/326; G10L 15/22; H04R 3/005; G10L 2015/223; H04R 2430/20

(57) ABSTRACT

A system can operate a speech-controlled device to perform user engagement detection (UED) processing to determine whether a user is engaged with the device without requiring a wakeword. For example, the device may extract audio features from audio data and process these audio features using a classifier to estimate user engagement. Relevant features include an estimated distance to a user, a relative angle to the user, and an estimated direction in which the user is facing. Based on the user's distance, relative angle, and facing direction, the classifier may determine that the user is engaged with the device and/or estimate an amount of engagement.

### BACKGROUND

With the advancement of technology, the use and popularity of electronic devices has increased considerably. Electronic devices are commonly used to capture and process audio data.

### BRIEF DESCRIPTION OF DRAWINGS

For a more complete understanding of the present disclosure, reference is now made to the following description taken in conjunction with the accompanying drawings.

FIG. 1 illustrates a system configured to perform user engagement detection according to embodiments of the present disclosure.

FIG. 2 illustrates an example of estimating head orientation for a user according to embodiments of the present disclosure.

FIG. 3 is a block diagram illustrating an example of user orientation estimation according to embodiments of the present disclosure.

FIG. 4 is a block diagram illustrating an example of generating feature data for user orientation estimation according to embodiments of the present disclosure.

FIG. 5 is a block diagram illustrating an example of performing user engagement detection according to embodiments of the present disclosure.

FIG. 6 illustrates examples of generating a variety of user engagement detection data according to embodiments of the present disclosure.

FIGS. 7A-7B are block diagrams illustrating examples of outputting user engagement detection data to a system directed detector according to embodiments of the present disclosure.

FIG. 8 is a block diagram illustrating an example of a system directed detector according to embodiments of the present disclosure.

FIG. 9 is a block diagram illustrating an example of performing user engagement detection as part of detecting system directed speech, according to embodiments of the present disclosure.

FIG. 10 is a conceptual diagram illustrating example components of a system configured to use a language model to determine a response to a user input, according to embodiments of the present disclosure.

FIG. 11 is a conceptual diagram illustrating example processing of the system configured to use a language model, according to embodiments of the present disclosure.

FIG. 12 is a conceptual diagram illustrating example components of the system, according to embodiments of the present disclosure.

FIG. 13 is a conceptual diagram of components of a system to detect if input audio data includes system directed speech, according to embodiments of the present disclosure.

FIG. 14 is a block diagram conceptually illustrating example components of a device according to embodiments of the present disclosure.

FIG. 15 is a block diagram conceptually illustrating example components of system components according to embodiments of the present disclosure.

FIG. 16 illustrates an example of a computer network for use with a speech processing system.

### DETAILED DESCRIPTION

An electronic device can leverage different computerized voice-enabled technologies. Automatic speech recognition (ASR) is a field of computer science, artificial intelligence, and linguistics concerned with transforming audio data associated with speech into text representative of that speech. Similarly, natural language understanding (NLU) is a field of computer science, artificial intelligence, and linguistics concerned with enabling computers to derive meaning from text input containing natural language. ASR and NLU are often used together as part of a speech processing system, sometimes referred to as a spoken language understanding (SLU) system. Text-to-speech (TTS) is a field of computer science concerning transforming textual and/or other data into audio data that is synthesized to resemble human speech. ASR, NLU, and TTS may be used together as part of a speech-processing system.

The system may be configured to incorporate user permissions and may only perform activities disclosed herein if approved by a user. As such, the systems, devices, components, and techniques described herein would be typically configured to restrict processing where appropriate and only process user information in a manner that ensures compliance with all appropriate laws, regulations, standards, and the like. The system and techniques can be implemented on a geographic basis to ensure compliance with laws in various jurisdictions and entities in which the components of the system and/or user are located.

Dialog processing is a field of computer science that involves communication between a computing system and a human via text, audio, and/or other forms of communication. While some dialog processing involves only simple generation of a response given only a most recent input from a user (i.e., single-turn dialog), more complicated dialog processing involves determining and optionally acting on one or more goals expressed by the user over multiple turns of dialog, such as making a restaurant reservation and/or booking an airline ticket. These multi-turn “goal-oriented” dialog systems typically need to recognize, retain, and use information collected during more than one input during a back-and-forth or “multi-turn” interaction with the user.

To improve dialog processing and/or a user experience, a system may be configured to use audio data to track user engagement and determine if speech is directed to a device. By extracting relevant features from the audio data, a device may perform User Engagement Detection (UED) processing to determine whether a user is engaged with the device without requiring a wakeword. For example, relevant features include an estimated distance to a user, a relative angle to the user, and an estimated direction in which the user is facing. Based on the user's distance, relative angle, and facing direction, a classifier may determine that the user is engaged with the device.

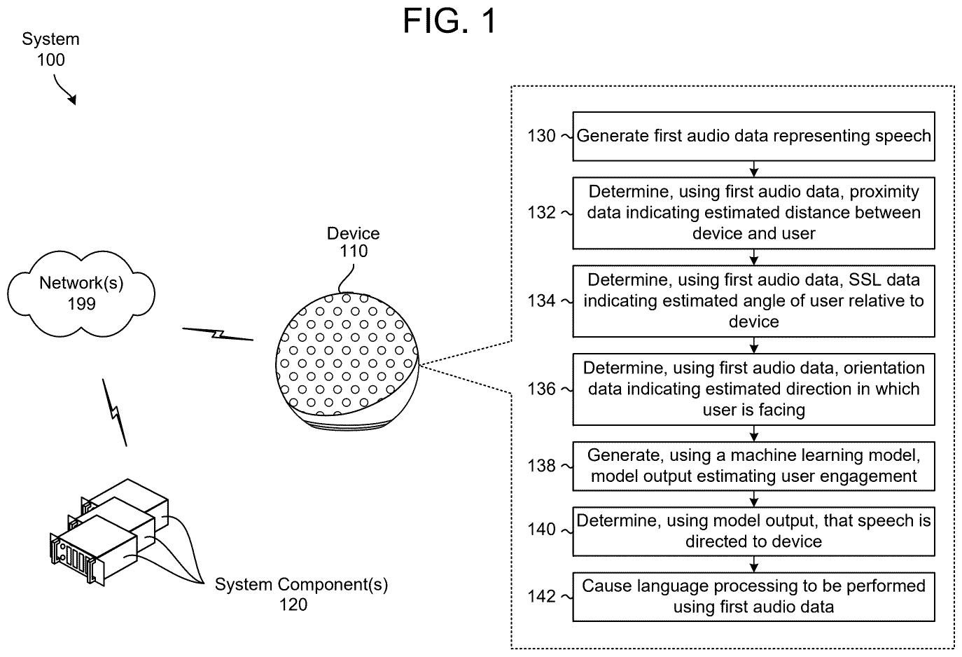

FIG. 1 illustrates a system configured to perform user engagement detection according to embodiments of the present disclosure. Although FIG. 1 and other figures/discussion illustrate the operation of the system in a particular order, the steps described may be performed in a different order (as well as certain steps removed or added) without departing from the intent of the disclosure. As illustrated in FIG. 1, the system 100 may include a device 110 and/or system component(s) 120 that may be communicatively coupled to network(s) 199.

The device 110 may receive audio corresponding to a spoken natural language input originating from a user. In some examples, the device 110 may process audio data and/or may send the audio data to the system component(s) 120. For example, the device 110 may send the audio data to the system component(s) 120 via an application that is installed on the device 110 and associated with the system component(s) 120. An example of such an application is the Amazon Alexa application that may be installed on a smart phone, tablet, or the like. The device 110 may also receive output data from the system component(s) 120 and generate a synthesized speech output.

In some examples, the device 110 may be an electronic device configured to capture audio data and/or image data. For example, the device 110 may include a microphone array configured to generate microphone audio data that captures input audio, although the disclosure is not limited thereto and the device 110 may include multiple microphones without departing from the disclosure. As is known and used herein, “capturing” an audio signal and/or generating audio data includes a microphone transducing audio waves (e.g., sound waves) of captured sound to an electrical signal and a codec digitizing the signal to generate the microphone audio data. In addition, the device 110 may include a camera or image sensor configured to generate image data that captures input video, although the disclosure is not limited thereto.

Whether the microphones are included as part of a microphone array, as discrete microphones, and/or a combination thereof, the device 110 may generate the microphone audio data using multiple microphones. For example, a first channel of the microphone audio data may correspond to a first microphone (e.g., k=1), a second channel may correspond to a second microphone (e.g., k=2), and so on until a final channel (K) corresponds to final microphone (e.g., k=K). For example, if the microphone array includes eight individual microphones, the audio data may include eight individual channels.

To improve a user experience, the system 100 may be configured to use audio data to track user engagement and/or determine if speech is directed to a device. By extracting relevant features from the audio data, a device may perform User Engagement Detection (UED) processing to determine whether a user is engaged with the device without requiring a wakeword. For example, relevant features include an estimated distance to a user, a relative angle to the user, and an estimated direction in which the user is facing. Based on the user's distance, relative angle, and facing direction, a classifier may determine that the user is engaged with the device.

As illustrated in FIG. 1, the device 110 may generate (130) first audio data corresponding to audio input captured by the microphone array. For example, the first audio data may include a representation of speech associated with a voice command or other user input, although the disclosure is not limited thereto.

As will be described in greater detail below, the device 110 may perform feature extraction to generate three sets of features that are effective for performing UED processing. As illustrated in FIG. 1, the device 110 may determine (132), using the first audio data, proximity data indicating an estimated distance between the device 110 and the user. In some examples, the device 110 may be configured to determine if a user is in proximity to the device 110 (e.g., within 6 feet) in an environment using ultrasound (e.g., ultrasonic frequencies). For example, the device 110 may estimate a distance between the device 110 and a user (e.g., user's distance) by emitting one or more ultrasonic signals and detecting reflection(s) caused by the ultrasonic signal(s) reflecting off of the user.

In some examples, the device 110 may estimate the user's distance based on a time delay between a first time that an ultrasonic signal was emitted and a second time that a corresponding reflection was detected. The disclosure is not limited thereto, however, and in other examples the device 110 may estimate the user's distance based on changes in energy measurements of a series of reflections without departing from the disclosure. Additionally or alternatively, the device 110 may detect movement of the user by emitting pulsed ultrasonic signals and detecting a change in energy measurements of reflections of the pulsed ultrasonic signals off of the user caused by the movement of the user relative to the device 110. Thus, in addition to and/or instead of determining an estimated distance, the device 110 may detect movement, and thus presence, of the user.

In some examples, the proximity data may correspond to an estimated distance and/or a confidence score associated with the estimated distance. For example, the device 110 may estimate an exact distance between the device 110 and the user, and the proximity data may indicate the estimated distance. The disclosure is not limited thereto, however, and in other examples the proximity data may correspond to a proximity indicator (e.g., proximity flag) and/or a confidence score without departing from the disclosure. In this example, the proximity indicator may indicate whether a user is in proximity to the device 110, while the confidence score may indicate a likelihood that the user is in proximity to the device 110. For example, the device 110 may estimate the exact distance between the device 110 and the user, and the proximity data may indicate whether the distance is below a threshold value (e.g., 4 feet, 6 feet, etc.). Additionally or alternatively, the device 110 may determine whether the user is in proximity to the device 110 (e.g., within 6 feet) without estimating the exact distance without departing from the disclosure. For example, the device 110 may detect movement of the user, and therefore presence in proximity to the device 110, without actually estimating the distance between the device 110 and the user.

As will be described in greater detail below, the device 110 may distinguish between multiple sound sources by performing sound source localization (SSL) processing. As illustrated in FIG. 1, the device 110 may determine (134), using the first audio data, SSL data indicating an estimated angle of the user relative to the device 110. For example, the device 110 may perform SSL processing to generate SSL data, which may indicate when an individual sound source is represented in the audio data, a direction/location associated with the sound source, power values and/or target likelihood estimates for each direction around the device (e.g., 360 degrees) and/or individual sound source, and/or the like, although the disclosure is not limited thereto. If the user is speaking, the SSL data may indicate a direction/location associated with the user.

As will be described in greater detail below, in some examples the device 110 may determine the SSL data by generating steered response power (SRP) data and determining direction data using the SRP data. For example, the device 110 may generate spatial power data by calculating a set of power values as a function of direction (e.g., spatial power). In addition, the device 110 may find a direction of a largest power peak represented in the spatial power data for each audio frame (e.g., every 8 ms) and may include corresponding direction information in the direction data. For example, the direction of the largest power peak may be represented using an azimuth defining a two-dimensional (2D) vector and/or an azimuth and an elevation defining a three-dimensional (3D) vector without departing from the disclosure. If the user is speaking, the SSL data may associate the user with the sound source corresponding to the largest power peak represented in the spatial power data.

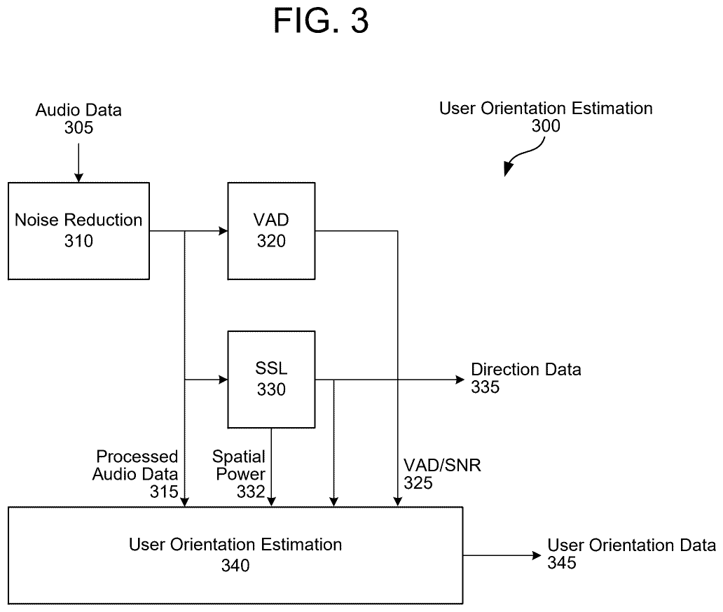

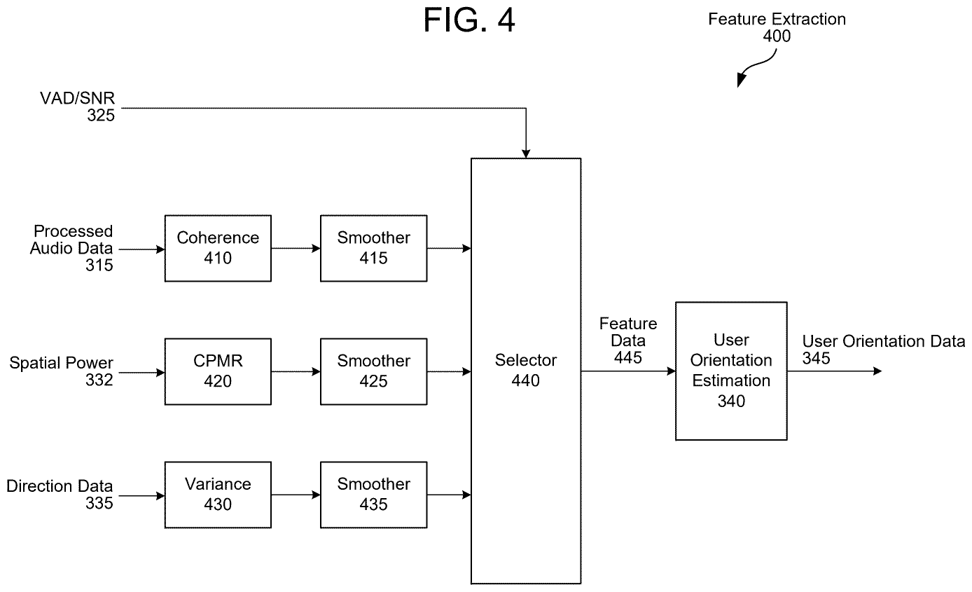

The device 110 may also determine (136), using the first audio data, orientation data indicating an estimated direction in which the user is facing (e.g., user orientation). In some examples, the device 110 may estimate the direction in which the user is facing by performing user orientation estimation, as described in greater detail below with regard to FIGS. 3-4. For example, the device 110 may extract a variety of features from the first audio data and may use these features to estimate the user orientation. Thus, the orientation data may indicate an estimated direction in which the user is facing (e.g., coarse estimate of head orientation associated with the user's head). As user engagement is strongly correlated with the user looking at the device 110, the user orientation corresponds to a direction in which the user's head is facing (e.g., not the user's body), and can be used as a cue to determine if the user is engaged with the device 110.

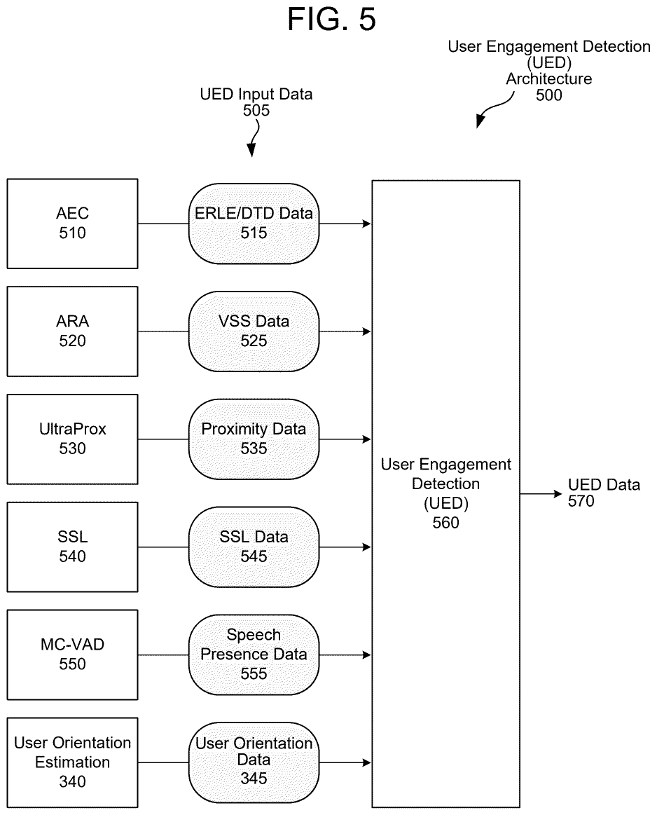

The device 110 may generate (138), using a machine learning model, model output estimating user engagement. For example, the device 110 may process the feature data described above (e.g., proximity data, SSL data, and/or orientation data) to determine whether the user is engaged with the device 110. In some examples, the machine learning model may correspond to a trained model, such as a Deep Neural Network (DNN), that operates on feature vector(s), which represent certain data that may be useful in determining whether or not speech is directed to the system. The disclosure is not limited thereto, however, and the machine learning model may vary without departing from the disclosure. Additionally or alternatively, in some examples the device 110 may receive additional inputs and/or generate additional sets of features without departing from the disclosure. For example, the device 110 may receive and/or generate additional features, as described in greater detail below with regard to FIG. 5.

In some examples, the device 110 may use a voice activity detection (VAD) component to mark time intervals of active speech and may include some form of SNR value(s) corresponding to the active speech. Thus, the device 110 may only extract the features described above when (i) the first audio data corresponds to the time intervals of active speech (e.g., speech is detected) and (ii) SNR value(s) associated with the time intervals exceed a threshold value. When those conditions are satisfied, the device 110 may generate the first feature data (e.g., spatial power as a function of direction), the second feature data (e.g., direction variance), and/or the third feature data (e.g., coherence values), which may be useful to UED determination.

The device 110 may determine (140), using the model output, that speech is directed to the device 110 and may cause (142) language processing to be performed using the first audio data. For example, the device 110 may use the model output (e.g., user engagement decision) as part of a larger user engagement detection processing. While detecting user engagement and/or estimating an amount of user engagement is useful on its own, it can also be beneficial when detecting a system-directed input command. For example, the model output may be input to a system directed detector (SDD) that is configured to determine whether an input is directed to the device 110. As will be described in greater detail below, the device 110 may cause language processing to be performed on the first audio data when the device 110 determines that the input is directed to the device 110, and the device 110 may ignore the first audio data when the device 110 determines that the input is not directed to the device 110.

In some examples, the device 110 may be configured to perform the language processing without departing from the disclosure. For example, the device 110 may send the output audio data to a language processing component associated with the device 110 and the language processing component may perform language processing using the output audio data to determine an action responsive to the voice command. To cause the action to be performed, the device 110 may perform the action itself, may send a command to other device(s) associated with the user profile, may send the command to the system component(s) 120, and/or the like without departing from the disclosure.

The disclosure is not limited thereto, however, and in other examples the system component(s) 120 may be configured to perform the language processing and the device 110 may send output audio data associated with the selected sound source (e.g., selected SSL track) to the system component(s) 120 via the network(s) 199. For example, the system component(s) 120 may perform language processing using the output audio data to determine an action to be performed that is responsive to the voice command. The system component(s) 120 may cause the action to be performed by sending a command to the device 110 and/or other device(s) associated with a user profile.

In some examples, when the device 110 determines that the user is speaking (e.g., detects an utterance) and that the user is engaged with the device 110 and/or the speech is directed to the device 110, the device 110 may generate second audio data representing the utterance, may perform language processing on the second audio data to determine a voice command, and may cause an action to be performed based on the voice command. For example, the device 110 may generate the second audio data using a portion of the first audio data that represents the utterance and then the device 110 may perform language processing using the second audio data and/or send the second audio data to the system component(s) 120 to perform language processing without departing from the disclosure.

The disclosure is not limited thereto, however, and in other examples the device 110 may determine that the user is engaged with the device 110 and may perform an action for a fixed time window (e.g., duration of time). For example, in response to determining that the user is engaged at a first time, the system 100 may perform language processing for a duration of time (e.g., 10 seconds) after the first time. If the user continues to be engaged during this time window, the system 100 may continue performing language processing, but if the user has not re-engaged, the system 100 may end the language processing without departing from the disclosure. For example, the device 110 may process the second audio data and/or stream the second audio data to the system component(s) 120 while the user is engaged with the device 110 and may stop processing and/or streaming once the user fails to re-engage with the device 110.

To process voice commands from a particular user or to send audio data that only corresponds to the particular user, the device may attempt to isolate desired speech associated with the user from undesired speech associated with other users and/or other sources of noise, such as audio generated by loudspeaker(s) or ambient noise in an environment around the device. In some examples, the device may perform sound source localization (SSL) processing to distinguish between multiple sound sources represented in the audio data, as will be described in greater detail below. For example, the device 110 may perform SSL processing to generate SSL data, which may indicate when an individual sound source is represented in the audio data, a direction/location associated with the sound source, target likelihood estimates for each direction around the device (e.g., 360 degrees) and/or individual sound source, and/or the like, although the disclosure is not limited thereto.

In some examples, the system 100 may be configured to capture audio representing a voice command and perform an action responsive to the voice command. For example, in response to determining that the user is engaged with the device 110 (e.g., detecting a system-directed input command), the device 110 may identify a sound source (e.g., perform SSL track selection) corresponding to desired speech and generate audio data representing the desired speech. Using the audio data, the system 100 may perform language processing to determine an action to perform that is responsive to the desired speech (e.g., voice command). For example, the voice command(s) may control the device 110, audio devices (e.g., play music over loudspeaker(s), capture audio using microphone(s), or the like), multimedia devices (e.g., play videos using a display, such as a television, computer, tablet or the like), smart home devices (e.g., change temperature controls, turn on/off lights, lock/unlock doors, etc.), and/or the like without departing from the disclosure.

The system component(s) 120 may be remote system such as a group of computing components located geographically remote from device 110 but accessible via network 199 (for example, servers accessible via the internet). The system component(s) 120 may also include a remote system that is physically separate from device 110 but located geographically close to device 110 and accessible via network 199 (for example a home server located in a same residence as device 110. System component(s) 120 may also include some combination thereof, for example where certain components/operations are performed via a home server(s) and others are performed via a geographically remote server(s).

In some examples, the device 110 may optionally include a camera for capturing image and/or video data, which is collectively referred to as image data. Thus, the system 100 may optionally use computer vision (CV) techniques operating on image data to perform active speaker detection. For example, the system 100 may use image data to determine when a user is speaking and/or which user is speaking. The system 100 may use face detection techniques to detect a human face represented in image data (for example using object detection component as discussed below). The system 100 may use a classifier or other model configured to determine whether a face is looking at a device 110. The system 100 may also be configured to track a face in image data to understand which faces in the video are belonging to the same person and where they may be located in image data and/or relative to a device 110. The system 100 may also be configured to determine an active speaker, for example by determining which face(s) in image data belong to the same person and whether the person is speaking or not. The system 100 may use components such as user recognition component, object tracking component, and/or other components to perform such operations.

The assistant can leverage different computerized voice-enabled technologies. Automatic speech recognition (ASR) is a field of computer science, artificial intelligence, and linguistics concerned with transforming audio data associated with speech into text representative of that speech. Similarly, natural language understanding (NLU) is a field of computer science, artificial intelligence, and linguistics concerned with enabling computers to derive meaning from text input containing natural language. ASR and NLU are often used together as part of a speech processing system, sometimes referred to as a spoken language understanding (SLU) system. Text-to-speech (TTS) is a field of computer science concerning transforming textual and/or other data into audio data that is synthesized to resemble human speech. ASR, NLU, and TTS may be used together as part of a speech-processing system.

The system 100 may be configured to incorporate user permissions and may only perform activities disclosed herein if approved by a user. As such, the systems, devices, components, and techniques described herein would be typically configured to restrict processing where appropriate and only process user information in a manner that ensures compliance with all appropriate laws, regulations, standards, and the like. The system and techniques can be implemented on a geographic basis to ensure compliance with laws in various jurisdictions and entities in which the components of the system and/or user are located.

Dialog processing is a field of computer science that involves communication between a computing system and a human via text, audio, and/or other forms of communication. While some dialog processing involves only simple generation of a response given only a most recent input from a user (i.e., single-turn dialog), more complicated dialog processing involves determining and optionally acting on one or more goals expressed by the user over multiple turns of dialog, such as making a restaurant reservation and/or booking an airline ticket. These multi-turn “goal-oriented” dialog systems typically need to recognize, retain, and use information collected during more than one input during a back-and-forth or “multi-turn” interaction with the user.

To improve dialog processing, a system 100 may be configured with a multi-user dialog (MUD) mode that allows the system to participate in a dialog with multiple users. As part of this mode (or operating in a normal mode using multi-user dialog components/operations) the system 100 may be configured to identify when a user is speaking to the system and respond accordingly. The system 100 may also be configured to identify when a user is speaking with another user and determine that such user-to-user speech does not require system action and so the system can ignore such speech. The system 100 may also be configured to identify when a user is speaking with another user and determine when such user-to-user speech is relevant to the system such that it is appropriate for the system to interject or respond to the user-to-user speech with information that is relevant to the user, as if the system were a participant in a conversation. The system 100 may also be configured to maintain a natural pace during a conversation and to insert conversational cues (such as “uh huh,” “mm,” or the like) to indicate to the user that the system is maintaining a connection with the user(s) for purposes in participating in the dialog. The system 100 may use models configured to make such determinations based on audio data, image data showing the user(s) and other information. The system 100 may also be configured to discontinue a multi-user dialog mode upon indication by the user, timeout, or other condition.

The system 100 may also use CV techniques operating on image data (for example in a multi-user scenario) to determine whether a particular input (for example speech or a gesture) is device directed. The system 100 may thus use image data to determine when a user is speaking to the system or to another user. The system 100 may start conversing with one person, and switch to a second person when the second person gives a visual indication that they are about to talk to the system. Such a visual indication may include, for example, raising a hand, turning to look from another user to look at a device 110, or the like. To make such determinations the system 100 may use face detection techniques to detect a human face represented in image data (for example using object detection component as discussed below). The system 100 may use a classifier or other model configured to determine whether a face is looking at a device 110 (for example using an object tracking component as discussed below). The system 100 may also be configured to track a face in image data to understand which faces in the video are belonging to the same person and where they may be located in image data and/or relative to a device 110 (for example using user recognition component and/or object tracking component as discussed below).

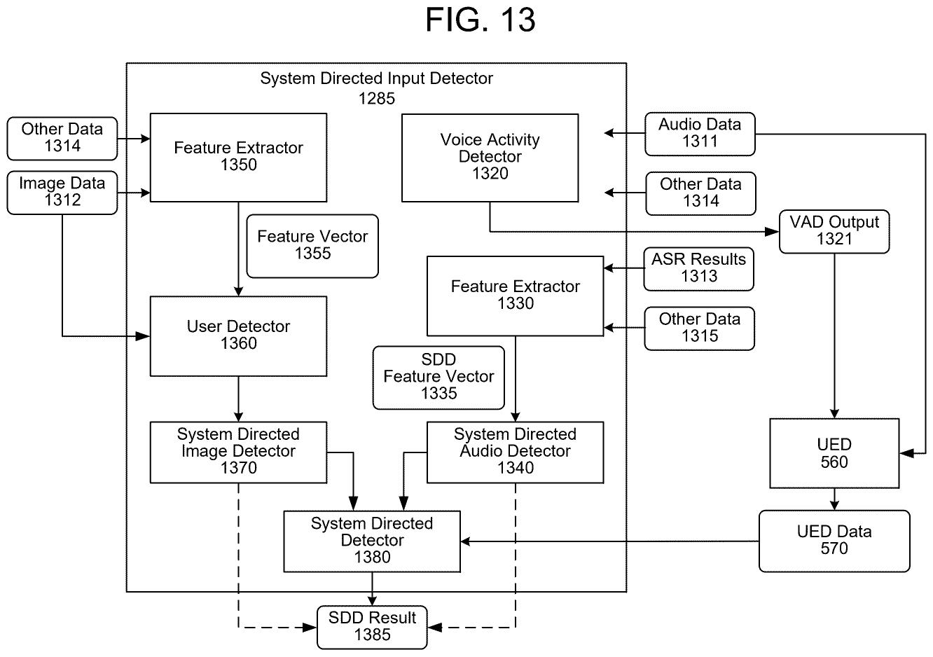

The system 100 may also be configured to determine an active speaker, for example by determining which face(s) in image data belong to the same person and whether the person is speaking or not (for example using image data of a user's lips to see if they are moving and matching such image data to data regarding a user's voice and/or audio data of speech and whether the words of the speech match the lip movement). The system 100 may use components such as user recognition component, object tracking component, and/or other components to perform such operations. To determine whether speech or another input is system directed, the system 100 may use the above information as well as techniques described below in reference to system directed input detector 1285 and FIG. 13.

Beamforming and/or other audio processing techniques may also be used to determine a voice's direction/distance relative to the device 110. Such audio processing techniques, in combination with image processing techniques may be used (along with user identification techniques or operations such as those discussed below) may be used to match a voice to a face and track a user's voice/face in an environment of the device 110 whether a user appears in image data (e.g., in the field of view of a camera of a device 110) or whether a user moves out of image data but is still detectable by the system 100 through audio data of the user's voice (or other data).

The system 100 may also be configured to discern user-to-user speech and determine when it is appropriate for the system to interject and participate in such a conversation and when it is appropriate for the system to allow the users to converse without interjecting/participating. The system 100 may be configured to provide personalized responses and proactively participate in a conversation, even when the system is not directly addressed. The system 100 may determine (in natural turn taking mode) when users are talking to each other, determine whether these are simply sidebar conversations or if they are relevant to the ongoing conversation with the system (for example relevant to the subject of a system-involved dialog), and may proactively interject with helpful information that is personalized and directed to the user addressed by the system. Such operations may allow the system to function as an equal participant in a multi-party conversation. To allow for such operations the system 100 may be configured for discourse understanding as part of NLU and dialog management as described below, for example in reference to NLU component 260 and dialog manager 272.

The system 100 may also be configured to allow a natural pace during a conversation. The system 100 may include component(s) to allow the system to “backchannel” during gaps in a conversation/dialog and to process breaks and turns within a conversation. For example, the system 100 may be configured to encourage a user to continue speaking by insertion of turn holding cues such as uh, mm, or utterances that are pragmatically and syntactically incomplete followed by a silence. This allows the system to not interrupt a user's flow of the thought and gives the user sufficient time to respond. A classifier or other model may be configured to take into account turn holding cues as part of a spoken interaction between the system and a user. Such a classifier may be included in (and such operations may be managed by) one or more system components, for example dialog manager, language output component, or other component(s). The system 100 may be configured to input audio data, image data, and other data to consider acoustic cues, prosody and other intonation classifications, as well as computer-vision features discussed herein. For example, if there is a silence that is classified as a pause, the system 100 may returns an empty TTS response and continue to “listen.” After an extended silence, the system 100 may return uh huh, ok, hmm, right, yeah, etc. to encourage a user to continue talking. Such backchannel expressions the system's attention to the user without interruption of the user. For example when a user is adding elements to a list, the system 100 may insert a backchannel indication in a gap after an utterance with the anticipation that more elements might get added by the user. This gives the customer more time while being reminded that the system is waiting and so encourages more participation from them or other parties in the conversation. The system 100 may be trained to recognize such conversational components using simulated and model utterances which are syntactically and pragmatically incomplete. The system 100 may also be trained using simulated syntactic incompleteness with utterances including pauses randomly included at the end of phrases within the utterance. The system 100 may also be trained using simulated pragmatic incompleteness with utterances including pauses before all entities that are requested to be updated are provided.

The audio data may be generated by a microphone array of the device 110 and therefore may correspond to multiple channels. For example, if the microphone array includes eight individual microphones, the audio data may include eight individual channels. In some examples, the device 110 may perform sound source localization (SSL) processing to separate the audio data based on sound source(s) and indicate when an individual sound source is represented in the audio data and/or a direction/location associated with the sound source.

An audio signal is a representation of sound and an electronic representation of an audio signal may be referred to as audio data, which may be analog and/or digital without departing from the disclosure. For ease of illustration, the disclosure may refer to either audio data (e.g., microphone audio data, input audio data, etc.) or audio signals (e.g., microphone audio signal, input audio signal, etc.) without departing from the disclosure. Additionally or alternatively, portions of a signal may be referenced as a portion of the signal or as a separate signal and/or portions of audio data may be referenced as a portion of the audio data or as separate audio data. For example, a first audio signal may correspond to a first period of time (e.g., 30 seconds) and a portion of the first audio signal corresponding to a second period of time (e.g., 1 second) may be referred to as a first portion of the first audio signal or as a second audio signal without departing from the disclosure. Similarly, first audio data may correspond to the first period of time (e.g., 30 seconds) and a portion of the first audio data corresponding to the second period of time (e.g., 1 second) may be referred to as a first portion of the first audio data or second audio data without departing from the disclosure. Audio signals and audio data may be used interchangeably, as well; a first audio signal may correspond to the first period of time (e.g., 30 seconds) and a portion of the first audio signal corresponding to a second period of time (e.g., 1 second) may be referred to as first audio data without departing from the disclosure.

In some examples, the audio data may correspond to audio signals in a time-domain. However, the disclosure is not limited thereto and the device 110 may convert these signals to a subband-domain or a frequency-domain prior to performing additional processing without departing from the disclosure. For example, the device 110 may convert the time-domain signal to the subband-domain by applying a bandpass filter or other filtering to select a portion of the time-domain signal within a desired frequency range. Additionally or alternatively, the device 110 may convert the time-domain signal to the frequency-domain using a Fast Fourier Transform (FFT) and/or the like.

As used herein, audio signals or audio data (e.g., microphone audio data, or the like) may correspond to a specific range of frequency bands. For example, the audio data may correspond to a human hearing range (e.g., 20 Hz-20 kHz), although the disclosure is not limited thereto.

As used herein, a frequency band (e.g., frequency bin) corresponds to a frequency range having a starting frequency and an ending frequency. Thus, the total frequency range may be divided into a fixed number (e.g., 256, 512, etc.) of frequency ranges, with each frequency range referred to as a frequency band and corresponding to a uniform size. However, the disclosure is not limited thereto and the size of the frequency band may vary without departing from the disclosure.

In some examples, the device 110 may generate microphone audio data z(t) in the time-domain, which is comprised of a sequence of individual samples of audio data. Thus, z(t) denotes an individual sample that is associated with a time t. While the microphone audio data z(t) is comprised of a plurality of samples, in some examples the device 110 may group a plurality of samples and process them together. For example, the device 110 may group a number of samples together in a frame to generate microphone audio data z(n). As used herein, a variable z(n) corresponds to the time-domain signal and identifies an individual frame (e.g., fixed number of samples s) associated with a frame index n.

In some examples, the device 110 may convert microphone audio data z(t) from the time-domain to the subband-domain. For example, the device 110 may use a plurality of bandpass filters to generate microphone audio data z(t, k) in the subband-domain, with an individual bandpass filter centered on a narrow frequency range. Thus, a first bandpass filter may output a first portion of the microphone audio data z(t) as a first time-domain signal associated with a first subband (e.g., first frequency range), a second bandpass filter may output a second portion of the microphone audio data z(t) as a time-domain signal associated with a second subband (e.g., second frequency range), and so on, such that the microphone audio data z(t, k) comprises a plurality of individual subband signals (e.g., subbands). As used herein, a variable z(t, k) corresponds to the subband-domain signal and identifies an individual sample associated with a particular time t and tone index k.

For ease of illustration, the previous description illustrates an example of converting microphone audio data z(t) in the time-domain to microphone audio data z(t, k) in the subband-domain. However, the disclosure is not limited thereto, and the device 110 may convert microphone audio data z(n) in the time-domain to microphone audio data z(n, k) the subband-domain without departing from the disclosure.

Additionally or alternatively, the device 110 may convert microphone audio data z(n) from the time-domain to a frequency-domain. For example, the device 110 may perform Discrete Fourier Transforms (DFTs) (e.g., Fast Fourier transforms (FFTs), short-time Fourier Transforms (STFTs), and/or the like) to generate microphone audio data Z(n, k) in the frequency-domain. As used herein, a variable Z(n, k) corresponds to the frequency-domain signal and identifies an individual frame associated with frame index n and tone index k.

A Fast Fourier Transform (FFT) is a Fourier-related transform used to determine the sinusoidal frequency and phase content of a signal, and performing FFT produces a one-dimensional vector of complex numbers. This vector can be used to calculate a two-dimensional matrix of frequency magnitude versus frequency. In some examples, the system 100 may perform FFT on individual frames of audio data and generate a one-dimensional and/or a two-dimensional matrix corresponding to the microphone audio data Z(n). However, the disclosure is not limited thereto and the system 100 may instead perform short-time Fourier transform (STFT) operations without departing from the disclosure. A short-time Fourier transform is a Fourier-related transform used to determine the sinusoidal frequency and phase content of local sections of a signal as it changes over time.

Using a Fourier transform, a sound wave such as music or human speech can be broken down into its component “tones” of different frequencies, each tone represented by a sine wave of a different amplitude and phase. Whereas a time-domain sound wave (e.g., a sinusoid) would ordinarily be represented by the amplitude of the wave over time, a frequency-domain representation of that same waveform comprises a plurality of discrete amplitude values, where each amplitude value is for a different tone or “bin.” So, for example, if the sound wave consisted solely of a pure sinusoidal 1 kHz tone, then the frequency-domain representation would consist of a discrete amplitude spike in the bin containing 1 kHz, with the other bins at zero. In other words, each tone “k” is a frequency index (e.g., frequency bin). To illustrate an example, the system 100 may apply FFT processing to the time-domain microphone audio data z(n), producing the frequency-domain microphone audio data Z(n, k), where the tone index “k” (e.g., frequency index) ranges from 0 to K and “n” is a frame index ranging from 0 to N. Thus, the history of the values across iterations is provided by the frame index “n”, which ranges from 1 to N and represents a series of samples over time.

As part of generating audio data corresponding to an individual sound source and/or SSL track, the device 110 may be configured to perform beamforming. For example, the device 110 may process the audio data using a beamformer component to generate directional audio data in order to isolate a speech signal represented in the audio data. However, in order to isolate the desired speech signal, in some examples the device 110 may identify a look direction associated with the desired speech signal. The disclosure is not limited thereto, however, and in other examples the device 110 may perform beamforming to generate a plurality of directional audio data without departing from the disclosure. For example, the device 110 may determine a first number of directional audio signals using a fixed configuration, although the disclosure is not limited thereto.

The device 110 may perform sound source localization processing to separate the audio data based on sound source and indicate when an individual sound source is represented in the audio data. To illustrate an example, the device 110 may detect a first sound source (e.g., first portion of the audio data corresponding to a first direction relative to the device 110) during a first time range, a second sound source (e.g., second portion of the audio data corresponding to a second direction relative to the device 110) during a second time range, and so on. Thus, the SSL data may include a first portion or first SSL data indicating when the first sound source is detected, a second portion or second SSL data indicating when the second sound source is detected, and so on.

The device 110 may use Time of Arrival (TOA) processing, Delay of Arrival (DOA) processing, and/or the like to determine the SSL data, although the disclosure is not limited thereto. In some examples, the SSL data may include multiple SSL tracks (e.g., individual SSL track for each unique sound source represented in the audio data), along with additional information for each of the individual SSL tracks. For example, for a first SSL track corresponding to a first sound source (e.g., audio source), the SSL data may indicate a position and/or direction associated with the first sound source location, a signal quality metric (e.g., power value) associated with the first SSL track, and/or the like, although the disclosure is not limited thereto.

The device 110 may be configured to track a sound source over time, collecting information about the sound source and maintaining a position of the sound source relative to the device 110. Thus, the device 110 may track the sound source even as the device 110 and/or the sound source move relative to each other. In some examples, the device 110 may determine position data including a unique identification indicating an individual sound source, along with information about a position of the sound source relative to the device 110, a location of the sound source using a coordinate system or the like, an audio type associated with the sound source, additional information about the sound source (e.g., user identification, type of sound source, etc.), and/or the like, although the disclosure is not limited thereto.

The device 110 may process the audio data to identify unique sound sources and determine a direction corresponding to each of the sound sources. For example, the device 110 may identify a first sound source in a first direction (e.g., first user), a second sound source in the second direction (e.g., reflection associated with an acoustically reflective surface), and/or a third sound source in a third direction (e.g., second user). In some examples, the device 110 may determine the directions associated with each of the sound sources and represent these directions as a value in degrees (e.g., between 0-360 degrees) relative to a position of the device 110, although the disclosure is not limited thereto.

As part of identifying unique sound sources, the device 110 may generate sound track data representing sound tracks. For example, the sound track data may include an individual sound track for each sound source, enabling the device 110 to track multiple sound sources simultaneously. The sound track data may represent a sound track using a power sequence as a function of time, with one power value per frame. The power sequence may include one or more peaks, with each peak (e.g., pulse) corresponding to an audible sound.

As described in greater detail below, the device 110 may detect an audible sound by identifying a short power sequence corresponding to a peak and may attempt to match the short power sequence to an already established sound track. For example, the device 110 may compare the short power sequence and a corresponding direction (e.g., direction of arrival associated with the audible sound) to existing sound tracks and match the short power sequence to an already established sound track, if appropriate. Thus, an individual sound track may include multiple audible sounds associated with a single sound source, even as a direction of the sound source changes relative to the device 110. The sound track may describe acoustic activities and have a start time, end time, power, and direction. In some examples, each audible sound (e.g., peak) included in the sound track may be associated with a start time, end time, power, and/or direction corresponding to the audible sound, although the disclosure is not limited thereto.

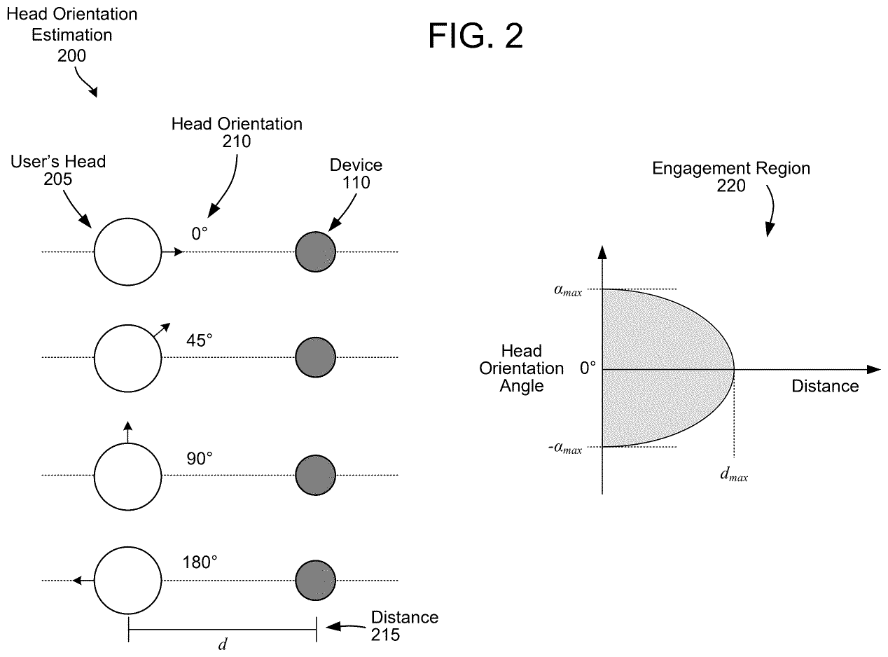

FIG. 2 illustrates an example of estimating head orientation for a user according to embodiments of the present disclosure. As described above, in some examples the device 110 may perform user engagement detection (UED) processing based at least in part on using head orientation as a proxy for user engagement. For example, a user may be considered to be engaged with the device 110 if one or more of the following conditions are true:
The user is talking;
The user is in close proximity to the device 110;
The user is located in front of the device 110; and/or
The user is looking at the device, which can be determined by estimating a head orientation angle.

To determine whether the fourth condition is true, the device 110 may perform head orientation estimation 200 to estimate a head orientation 210 associated with the user's head 205 and determine whether it is within an engagement region 220. As illustrated in FIG. 2, the head orientation 210 associated with the user's head 205 indicates a direction that the user is facing (e.g., user's face is pointed in a first direction) relative to a reference direction associated with the device 110 (e.g., direct path from user's head 205 to the device 110 corresponds to a second direction). For example, the second direction may be associated with a first angle (e.g., 0°) and the head orientation 210 may indicate an offset between the first direction and the second direction. As illustrated in FIG. 2, facing directly at the device 110 corresponds to a first head orientation angle (e.g., 0°), facing partially toward the device 110 corresponds to a second head orientation angle (e.g., 45°), facing perpendicular to the device 110 corresponds to a third orientation angle (e.g., 90°), and facing in the opposite direction as the device 110 corresponds to a fourth orientation angle (e.g., 180°).

While the third orientation angle (e.g., 90°) and the fourth orientation angle (e.g., 180°) are not considered to be engaged with the device 110, the second orientation angle (e.g., 45°) may be engaged with the device 110 depending on a distance 215 between the user's head 205 and the device 110. This is illustrated in the engagement region 220, which extends to a maximum orientation angle (e.g., +/−αₘₐₓ) when the user is in close proximity to the device 110 (e.g., distance is close to zero) and gradually decreases as the distance increases. For example, the range of head orientation angles considered to be within the engagement region 220 narrows considerably as the distance between the user and the device 110 approaches a maximum distance (e.g., dₘₐₓ), indicating that the user has to be looking directly at the device 110 at farther distances. If the user is beyond the maximum distance (e.g., dₘₐₓ), the user is not considered to be engaged with the device 110 regardless of the head orientation 210.

The device 110 may estimate a head orientation angle by analyzing frequency components of the received sound (e.g., audio data generated by microphones). For example, when the user's head 205 is not facing directly toward the device 110, sound emanating from the user's mouth becomes obstructed, leading to various degrees of high-frequency attenuation. Further, a direct-to-reverberant-ratio (DRR) becomes weaker at the fourth orientation angle (e.g., 180°) compared to the first orientation angle (e.g., 0°), as the signals reach the microphones as reflections caused by the environment.

In some examples, the user may be considered to be engaged with the device 110 for purposes of user engagement detection when the user is talking to the device 110 (e.g., speech is detected) while a head orientation angle is near the first orientation angle (e.g., 0°) or within a desired range, such as the engagement region 220. For example, at close distance the user is said to be engaged if the head orientation angle is within a first range [+/−αₘₐₓ], such as [−45°, 45°], although the disclosure is not limited thereto. However, this range gradually decreases as the distance between the user and the device 110 increases and approaches the maximum distance (e.g., dₘₐₓ), beyond which the user is not considered to be engaged with the device 110 regardless of head orientation. Thus, the user is considered to be engaged with the device 110 when the distance 215 does not exceed the maximum distance (e.g., dₘₐₓ) and the head orientation 210 is within a range of head orientation angles indicated by the engagement region 220. While FIG. 2 illustrates a simple example of the engagement region 220, the disclosure is not limited thereto and the exact boundaries of the engagement region 220 may vary depending on the user, the room or environment, historical data, and/or the like.

FIG. 3 is a block diagram illustrating an example of user orientation estimation according to embodiments of the present disclosure. As described above, the device 110 may perform user engagement detection (UED) processing to determine whether an input is system directed (e.g., directed to the device 110). As part of performing UED processing, the device 110 may perform user orientation estimation 300 to estimate a user orientation, which indicates an estimated direction in which the user is facing. As user engagement is strongly correlated with the user looking at the device 110, the user orientation indicates an estimated direction in which the user's head is facing (e.g., not the user's body), and can be used as a cue to determine if the user is engaged with the device 110. For example, a user orientation estimation component 340 may be configured to process one or more inputs (e.g., feature data) extracted from the audio data 305 to generate user orientation data 345 indicating an estimated direction in which the user is facing, which may be used as a proxy for whether the user is engaged with the device 110 and/or whether an input is system directed. Thus, when the user orientation data 345 indicates that the user is facing the device 110, the device 110 may determine that the user is engaged with the device 110 and may therefore perform additional processing using the audio data 305 and/or send the audio data 305 to the system component(s) 120 for additional processing. In contrast, when the user orientation data 345 indicates that the user is not facing the device 110 (e.g., facing away from the device 110), the device 110 may determine that the user is not engaged with the device 110 and may therefore ignore the audio data 305.

In addition to the user orientation estimation component 340, the device 110 may perform user orientation estimation 300 using noise reduction component(s) 310, a voice activity detection (VAD) component 320, and a sound source localization (SSL) component 330. As illustrated in FIG. 3, the noise reduction component(s) 310 may be configured to process the audio data 305 to generate processed audio data 315. For example, the noise reduction component(s) 310 may correspond to an audio front end (AFE) of the device 110 and may be configured to perform echo cancellation, noise reduction, adaptive interference cancellation, and/or the like to generate the processed audio data 315. While the processed audio data 315 may be input to the user orientation estimation component 340 to generate first feature data, it may also be input to the VAD component 320 and/or the SSL component 330 to generate additional feature data.

In some examples, the VAD component 320 may process the processed audio data 315 and generate VAD/SNR data 325, which may be input to the user orientation estimation component 340 as second feature data. For example, the VAD component 320 may determine whether voice activity (e.g., speech) is detected in the processed audio data 315 and, if voice activity is detected (e.g., speech is represented in the processed audio data 315), may determine signal-to-noise ratio (SNR) values associated with the speech. Thus, the VAD/SNR data 325 may indicate that speech is present and/or SNR values corresponding to the speech, although the disclosure is not limited thereto.

While FIG. 3 illustrates an example in which the device 110 performs user orientation estimation 300 using the VAD component 320, the disclosure is not limited thereto and the VAD component 320 is optional. For example, the user orientation estimation component 340 can generate the user orientation data 345 with or without the VAD/SNR data 325 without departing from the disclosure. In fact, in some examples the user orientation estimation component 340 may be able to determine whether voice activity is present based on other input features (e.g., spectral cues, such as spectral power). Thus, in the example of performing user orientation estimation 300 illustrated in FIG. 3, the VAD component 320 operates more as a noise gate to ignore audio when speech is not detected rather than as an input feature correlated with user engagement.

The VAD component 320 may operate to detect whether the processed audio data 315 includes speech or not. In some examples, the VAD/SNR data 325 may include a binary indicator. Thus, if the processed audio data 315 includes speech, the VAD component 320 may output a first indicator that the processed audio data 315 does include speech (e.g., a 1) and if the processed audio data 315 does not include speech, the VAD component 320 may output a second indicator that the processed audio data 315 does not include speech (e.g., a 0). In other examples, the VAD/SNR data 325 may include a score (e.g., a number between 0 and 1) corresponding to a likelihood that the processed audio data 315 includes speech, although the disclosure is not limited thereto.

In addition, the VAD component 320 may also perform start-point detection as well as end-point detection where the VAD component 320 determines when speech starts in the processed audio data 315 and when it ends in the processed audio data 315. Thus the VAD/SNR data 325 may also include indicators of a speech start point and/or a speech endpoint for use by other components of the system. For example, the start-point and end-points may demarcate the processed audio data 315 that is sent to a speech processing component and/or language processing component, although the disclosure is not limited thereto. The VAD/SNR data 325 may be associated with a same unique ID as the processed audio data 315 for purposes of tracking system processing across various components.

The VAD component 320 may use various techniques to determine whether the processed audio data 315 includes speech. In some examples, the VAD component 320 may apply voice activity detection (VAD) techniques. Such techniques may determine whether speech is present in the audio data based on various quantitative aspects of the audio data, such as the spectral slope between one or more frames of the audio data; the energy levels of the audio data in one or more spectral bands; the signal-to-noise ratios of the audio data in one or more spectral bands; or other quantitative aspects. In other examples, the VAD component 320 may implement a classifier configured to distinguish speech from background noise. The classifier may be implemented by techniques such as linear classifiers, support vector machines, and decision trees. In still other examples, the VAD component 320 may apply hidden Markov model (HMM) or Gaussian mixture model (GMM) techniques to compare the audio data to one or more acoustic models in storage, which acoustic models may include models corresponding to speech, noise (e.g., environmental noise or background noise), or silence. Still other techniques may be used to determine whether speech is present in audio data.

The VAD component 320 may be configured to be robust to background noise so as to accurately detect when audio data actually includes speech or not. The VAD component 320 may operate on the processed audio data 315 such as that sent by device 110 or may operate on feature vectors or other data representing the processed audio data 315. For example, the VAD component 320 may take the form of a deep neural network (DNN) and may operate on a single feature vector representing the entirety of processed audio data 315 received from the device or may operate on multiple feature vectors, for example feature vectors representing frames of audio data where each frame covers a certain amount of time of audio data (e.g., 25 ms).

In some examples, the VAD component 320 may consider speaker ID information (such as may be output by a user recognition component) and/or directionality data that may indicate what direction (relative to the device 110) the incoming audio was received from. For example, the directionality data may have been determined by a beamformer or other component of the device 110. While not illustrated in FIG. 3, in some examples the VAD component 320 may receive the directionality data from the SSL component 330, such as spatial power data 332 and/or direction data 335, although the disclosure is not limited thereto. The VAD component 320 may also consider data regarding a previous utterance which may indicate whether the further audio data received by the system is likely to include speech. Other VAD techniques may also be used without departing from the disclosure.

If the VAD/SNR data 325 indicates that no speech was detected, the device 110 may discontinue processing with regard to the processed audio data 315, thus saving computing resources that might otherwise have been spent on other processes (e.g., ASR for the processed audio data 315, etc.). If the VAD/SNR data 325 indicates that speech was detected, the system 100 may make a determination as to whether the speech was or was not directed to the device 110 using the user orientation estimation component 340, as described in greater detail below.

As described in greater detail above, in some examples the device 110 may perform sound source localization (SSL) processing to distinguish between multiple sound sources represented in the processed audio data 315. For example, the device 110 may perform SSL processing to generate SSL data, which may indicate when an individual sound source is represented in the audio data, a direction/location associated with the sound source, power values and/or target likelihood estimates for each direction around the device (e.g., 360 degrees) and/or individual sound source, and/or the like, although the disclosure is not limited thereto.

In the example illustrated in FIG. 3, the SSL component 330 may perform SSL processing using the processed audio data 315 to generate spatial power data 332 and direction data 335. In some examples, the SSL component 330 may calculate steered response power (SRP) using the multi-channel processed audio data 315. For example, the SSL component 330 may generate the spatial power data 332 by calculating a set of power values as a function of direction (e.g., spatial power). In addition, the SSL component 330 may find a direction of a largest power peak represented in the spatial power data 332 for each audio frame (e.g., every 8 ms) and may include corresponding direction information in the direction data 335. For example, the direction of the largest power peak may be represented using an azimuth defining a two-dimensional (2D) vector and/or an azimuth and an elevation defining a three-dimensional (3D) vector without departing from the disclosure. Additionally or alternatively, the direction data 335 may indicate a distance associated with a sound source that corresponds to the largest power peak without departing from the disclosure. For example, the device 110 may identify a sound source associated with the largest power peak and determine a distance between the sound source and the device 110.

As illustrated in FIG. 3, the user orientation estimation component 340 may receive a variety of inputs and may generate the user orientation data 345. For example, inputs to the user orientation estimation component 340 may include the processed audio data 315, the VAD/SNR data 325, the spatial power data 332, and/or the direction data 335, although the disclosure is not limited thereto. As described above, the VAD/SNR data 325 may mark time intervals of active speech and may include some form of SNR value(s) corresponding to the active speech. In some examples, the user orientation estimation component 340 may only perform user orientation estimation when (i) the processed audio data 315 corresponds to the time intervals of active speech (e.g., speech is detected in the processed audio data 315) and (ii) SNR value(s) associated with the time intervals exceed a threshold value. When those conditions are satisfied, the user orientation estimation component 340 may take as input one or more audio signals (e.g., processed audio data 315), the VAD/SNR data 325 (e.g., SNR value(s)), the spatial power data 332 (e.g., spatial power as a function of direction), and/or the direction data 335 (e.g., direction of the dominant sound source) to derive features (e.g., feature vector(s)) used to generate the user orientation data 345.

The disclosure is not limited thereto, however, and in some examples the device 110 may receive additional inputs and/or generate additional sets of features without departing from the disclosure. For example, the device 110 may receive and/or generate additional features associated with an environment of the device 110. To illustrate an example, the device 110 may receive and/or generate features associated with room information, such as a size of the room, a reflection or reverberation level associated with the room (e.g., reverberation time), a room impulse response (RIR), and/or the like, although the disclosure is not limited thereto. By knowing the room information, the device 110 may condition other features and/or determine an expected range or limits associated with variables.

As described in greater detail above, the user orientation estimation component 340 may estimate a user orientation (e.g., estimated direction in which the user is facing) based on these features. In some examples, the user orientation estimation component 340 may include a trained model, such as a Deep Neural Network (DNN), that operates on feature vector(s), which represent certain data that may be useful in determining whether or not speech is directed to the system. For example, the processed audio data 315, the VAD/SNR data 325, the spatial power data 332, and/or the direction data 335 may be used to create the feature vector(s) operable by the user orientation estimation component 340, as described in greater detail below with regard to FIG. 4.

As described above, the user orientation estimation component 340 may receive a variety of inputs and derive features with which to perform user orientation estimation 300 and generate the user orientation data 345. For example, FIG. 3 illustrates an example in which the user orientation estimation component 340 receives the processed audio data 315, the VAD/SNR data 325 (e.g., SNR value(s)), the spatial power data 332 (e.g., spatial power as a function of direction), and/or the direction data 335 (e.g., direction of the dominant sound source). The disclosure is not limited thereto, however, and in some examples the user orientation estimation component 340 may receive additional inputs and/or features without departing from the disclosure. For example, the user orientation estimation component 340 may receive and/or generate additional features associated with an environment associated with the device 110. To illustrate an example, the user orientation estimation component 340 may receive and/or generate features associated with room information, such as a size of the room, a reflection or reverberation level associated with the room (e.g., reverberation time), a room impulse response (RIR), and/or the like, although the disclosure is not limited thereto. By knowing the room information, the device 110 may condition other features and/or determine an expected range or limits associated with variables.

FIG. 4 is a block diagram illustrating an example of generating feature data for user orientation estimation according to embodiments of the present disclosure. In some examples, the device 110 may perform feature extraction 400 to derive features (e.g., feature vector(s)) that can be used by the user orientation estimation component 340 to generate the user orientation data 345. In the example illustrated in FIG. 4, for example, the device 110 may perform feature extraction 400 to generate three sets of features that are effective for performing user orientation estimation, which are based on cross-channel spectral characteristics, spatial power distribution, and direction data determined during SSL processing.

As illustrated in FIG. 4, the device 110 may perform feature extraction 400 using the processed audio data 315 to generate first feature data (e.g., first feature vector(s)) that correspond to cross-channel spectral characteristics. For example, a coherence component 410 may estimate a cross-channel spectral coherence between two channels of the processed audio data 315 on a frame-by-frame basis. After estimating the coherence and generating magnitude squared coherence (MSC) features, the coherence component 410 may output the MSC features to a smoother component 415 to generate the first feature data. For example, the smoother component 415 may perform time-based and/or power-based smoothing to yield a given feature, although the disclosure is not limited thereto.

Similarly, the device 110 may perform feature extraction 400 using the spatial power data 332 to generate second feature data (e.g., second feature vector(s)) that corresponds to the spatial power distribution. For example, a cell peak mean ratio (CPMR) component 420 may process the spatial power data 332 to generate CPMR features, which may be useful for head orientation estimation. The CPMR is defined as the ratio of the power of the cell with the highest power with respect to an average power of the rest of the cells. After generating the CPMR features, the CPMR component 420 may output the CPMR features to a smoother component 425 to generate the second feature data. For example, the smoother component 425 may perform time-based and/or power-based smoothing to yield a given feature, although the disclosure is not limited thereto.

Finally, the device 110 may perform feature extraction 400 using the direction data 335 to generate third feature data (e.g., third feature vector(s)) that corresponds to the direction data generated during SSL processing. For example, a variance component 430 may process the direction data 335 to generate distance variance features, which reflects the spatial stationarity of the sound source. After generating the distance variance features, the variance component 430 may output the distance variance features to a smoother component 435 to generate the third feature data. For example, the smoother component 435 may perform time-based and/or power-based smoothing to yield a given feature, although the disclosure is not limited thereto.

In the example illustrated in FIG. 4, the device 110 performs feature extraction 400 using several separate smoother components 415/425/435. For example, the first smoother component 415 is configured to generate the first feature data based on MSC features, the second smoother component 425 is configured to generate the second feature data based on the CPMR features, and the third smoother component 435 is configured to generate the third feature data based on the direction variance features. While each of the smoother components 415/425/435 are configured to perform smoothing to generate corresponding feature data, they are not identical and the smoothing processing being performed may vary between the respective components without departing from the disclosure. For example, each smoother component 415/425/435 may be associated with unique parameters, such that a type and/or amount of smoothing may vary between the respective components.

In some examples, the features may be time-smoothed, and only features associated with high-SNR frames are included in the feature data. However, both time-based and power-based smoothing may be applied to yield a given feature without departing from the disclosure. In a time-based approach, the device 110 may rely on the parameters collected for a number of frames and compute a mean (e.g., plain average) or weighted mean (e.g., power-weighted average), although the disclosure is not limited thereto. Additionally or alternatively, in a power-based approach the device 110 may use the power of an audio frame or the power associated with an individual frequency bin to determine a weighted mean (e.g., power-weighted average). A duration of the time-interval used to find the mean determines how fast the user orientation estimation component 340 responds to change. In addition, by including power in the smoothing process, the device 110 may place higher priority to higher-power events, while downplaying or ignoring weaker events (e.g., lower-power events).

As described above, the VAD/SNR data 325 may mark time intervals of active speech and may include some form of SNR value(s) corresponding to the active speech. In some examples, the user orientation estimation component 340 may only perform user orientation estimation processing when (i) the processed audio data 315 corresponds to the time intervals of active speech (e.g., speech is detected in the processed audio data 315) and (ii) SNR value(s) associated with the time intervals exceed a threshold value. An example of this selective processing is illustrated in FIG. 4 by a selector component 440, which is configured to generate feature data 445 based on the VAD/SNR data 325. For example, the selector component 440 may continuously receive the three sets of feature data generated during feature extraction 400, but may only generate the feature data 445 when the VAD/SNR data 325 indicates that the conditions are satisfied. Thus, the selector component 440 may selectively process portions of the feature data that are associated with (i) active speech and (ii) reduced noise and interference (e.g., high SNR value(s)), which improves an accuracy and/or reliability of the user orientation estimation.

While FIG. 4 illustrates an example in which the device 110 performs feature extraction 400 using the VAD/SNR data 325, the disclosure is not limited thereto and the VAD/SNR data 325 and/or the VAD component 320 are optional. For example, the user orientation estimation component 340 can generate the user orientation data 345 with or without the VAD/SNR data 325 without departing from the disclosure. In fact, in some examples the user orientation estimation component 340 may be able to determine whether voice activity is present based on other input features (e.g., spectral cues, such as spectral power). Thus, in the example of performing feature extraction 400 illustrated in FIG. 4, the VAD/SNR data 325 is used more as a noise gate to ignore audio when speech is not detected rather than as an input feature correlated with user engagement.

In some examples, the device 110 may selectively perform feature extraction 400 using the selector component 440. For example, the device 110 may use the selector component 440 to control when feature extraction 400 is performed based on the VAD/SNR data 325, as illustrated in FIG. 4. The disclosure is not limited thereto, however, and the device 110 may use the selector component 440 to control when feature extraction 400 is performed based on other input signals without departing from the disclosure. For example, the selector component 440 may perform feature extraction 400 whenever a power value associated with the processed audio data 315 and/or the spatial power 332 exceeds a threshold value, although the disclosure is not limited thereto. Additionally or alternatively, in some examples the device 110 may perform feature extraction 400 without using the selector component 440. For example, the user orientation estimation component 340 may continuously receive the three sets of feature data and may be configured to generate the user orientation data 345 selectively and/or continuously based on the feature data itself without departing from the disclosure.

In some examples, the selector component 440 may be configured to combine feature data for a first number of audio frames. For example, the selector component 440 may concatenate feature data for three consecutive frames each time that the user orientation estimation component 340 needs to generate the user orientation data 345. Thus, if the selector component 440 determines that the VAD/SNR data 325 satisfies the condition(s), the selector component 440 may retrieve feature data associated with a current audio frame as well as two previous audio frames in order to generate the feature data 445.

To illustrate an example, if the selector component 440 receives three sets of feature data, the selector component 440 may generate the feature data 445 as a nine-dimensional (9D) feature vector that includes the three most recent feature vectors for each of the three sets of feature data (e.g., three concatenated feature vectors corresponding to the coherence component 410, three concatenated feature vectors corresponding to the CPMR component 420, and three concatenated feature vectors corresponding to the variance component 430). Thus, the user orientation estimation component 340 is configured to perform user orientation estimation for an individual audio frame (e.g., 8 ms of audio) based on feature data 445 that corresponds to a current audio frame as well as the prior two audio frames. The disclosure is not limited thereto, however, and a number of separate features and/or a length of history (e.g., number of previous audio frames) may vary without departing from the disclosure.

While FIG. 4 illustrates an example in which the device 110 performs feature extraction 400 to generate three sets of feature data, the disclosure is not limited thereto. In some examples, the feature data 445 may include additional inputs and/or features without departing from the disclosure. For example, the user orientation estimation component 340 may receive additional features associated with room information, such as a size of the room, a reflection or reverberation level associated with the room (e.g., reverberation time), a room impulse response (RIR), and/or the like, although the disclosure is not limited thereto. By knowing the room information, the device 110 may condition other features and/or determine an expected range or limits associated with variables.

As illustrated in FIG. 4, the selector component 440 may output the feature data 445 to the user orientation estimation component 340 and the user orientation estimation component 340 may use the feature data 445 to generate the user orientation data 345. For example, the feature data may be input to a classifier that is trained to estimate user orientation based on audio features. An output of the classifier may represent an estimated direction in which the user is facing, and popular choices for classifier design include neural networks and Gaussian mixture models. In some examples, the classifier may be trained to generate a coarse estimate of head orientation associated with the user's head, which may be output to downstream components to provide additional functionality.

Various machine learning techniques may be used to train and operate models to perform various steps described herein, such as user orientation estimation. Models may be trained and operated according to various machine learning techniques. Such techniques may include, for example, neural networks (such as deep neural networks and/or recurrent neural networks), inference engines, trained classifiers, etc. Examples of trained classifiers include Support Vector Machines (SVMs), neural networks, decision trees, AdaBoost (short for “Adaptive Boosting”) combined with decision trees, and random forests. Focusing on SVM as an example, SVM is a supervised learning model with associated learning algorithms that analyze data and recognize patterns in the data, and which are commonly used for classification and regression analysis. Given a set of training examples, each marked as belonging to one of two categories, an SVM training algorithm builds a model that assigns new examples into one category or the other, making it a non-probabilistic binary linear classifier. More complex SVM models may be built with the training set identifying more than two categories, with the SVM determining which category is most similar to input data. An SVM model may be mapped so that the examples of the separate categories are divided by clear gaps. New examples are then mapped into that same space and predicted to belong to a category based on which side of the gaps they fall on. Classifiers may issue a “score” indicating which category the data most closely matches. The score may provide an indication of how closely the data matches the category.

In order to apply the machine learning techniques, the machine learning processes themselves need to be trained. Training a machine learning component such as, in this case, one of the first or second models, requires establishing a “ground truth” for the training examples. In machine learning, the term “ground truth” refers to the accuracy of a training set's classification for supervised learning techniques. Various techniques may be used to train the models including backpropagation, statistical learning, supervised learning, semi-supervised learning, stochastic learning, or other known techniques.

As described above, in some examples the SSL component 330 may calculate steered response power (SRP) using the multi-channel processed audio data 315. For example, the SSL component 330 may generate the spatial power data 332 by calculating a set of power values as a function of direction (e.g., spatial power). In addition, the SSL component 330 may find a direction of a largest power peak represented in the spatial power data 332 for each audio frame (e.g., every 8 ms) and may include corresponding direction information in the direction data 335. For example, the SSL component 330 may determine an azimuth and elevation corresponding to the largest power peak represented in the spatial power data 332, although the disclosure is not limited thereto.

The device 110 may calculate the steered response power such that power values are calculated for available direction vectors stored in a codebook. For example, the device 110 may determine the steered response power using a delay-direction codebook in order to calculate power as a function of direction. For ease of use, the direction vectors may be assigned to a set of rectangular location cells surrounding the device 110, and the device 110 may perform SSL processing by selecting a location cell associated with the largest power value. For example, the device 110 may use the delay-direction codebook to calculate the power values and may then use the power values to estimate a direction associated with the sound source.

The codebook may consist of a collection of delay vectors (e.g., TDOA vectors) together with location vectors, and the codebook may be determined based on the locations of the microphones and the physical dimensions or shape of an enclosure of the device 110. The location vectors may be represented as either spherical coordinates (e.g., azimuth θ and elevation Φ) and/or rectangular coordinates (e.g., three components in the x, y, and z axes, with the resultant vector having unit length), and the device 110 may convert from one representation to the other without departing from the disclosure.

The delay-location codebook for SRP location consists of

$$\{ {a}_{m} , {t}_{m} \} , m = 0 to M - 1 \qquad [ 1 ]$$

where aₘ denotes the 3D location vectors, tₘ denotes the time-differential of arrival (TDOA) vectors, and M is the codebook size. Each TDOA vector contains time delays measured between two microphones.

In some examples, the device 110 may perform codebook generation to generate an initial codebook and then reduce a number of delay vectors to generate a final codebook. For example, the device 110 may generate a first set of M₀ candidate location vectors (e.g., aₘ, where m=0 to M₀−1) and the initial codebook may include each of the M₀ candidate location vectors. Thus, the initial codebook may represent all potential directions of sound sources (e.g., depending on a desired resolution) with respect to the microphone array and/or the device 110. In contrast, the final codebook may include a second set of M₁ candidate location vectors (e.g., aₘ, where m=0 to M₁−1) that corresponds to a subset of the potential directions of sound sources, as described in greater detail below.

The number of candidate location vectors (e.g., M₀) may vary depending on a desired resolution associated with the codebook and/or the device 110. For example, if the device 110 includes a small number of microphones, an individual TDOA value may correspond to a large range of directions, so the device 110 may generate the codebook using a lower resolution. In contrast, if the device 110 includes a large number of microphones, the TDOA values may correspond to a small range of directions, so the device 110 may generate the codebook using a higher resolution to take advantage of the increased precision offered by the large number of microphones.

In some examples, the device 110 may generate the candidate location vectors based on an elevation increment, an azimuth range, an elevation range, and/or a distance value (e.g., radius), although the disclosure is not limited thereto. While the system 100 may generate the candidate location vectors using a variety of techniques without departing from the disclosure, SSL processing may be improved if the candidate location vectors are near-uniformly distributed for the entire sphere: θ∈[−π, π] and φ∈[0, π]. Thus, each candidate location vector may be specified by spherical coordinates {r, θ, φ}, which can also be converted to rectangular coordinates {x, y, z}.

The microphone array may include K microphones, with known locations given by:

$${u}_{n} = [ \begin{matrix}{x}_{n} \\ {y}_{n} \\ {𝓏}_{n}\end{matrix} ] , n = 0 to K - 1 \qquad [ 2 ]$$

where uₙ indicates three-dimensional (3D) coordinates of the nth microphone, which are expressed in some unit of distance (e.g., meter). Depending on the microphone locations, and the direction-of-arrival of a given sound, said sound reaches different microphones at different times. By measuring the TDOA caused by the sound, it is possible to estimate the direction-of-arrival. For example, there are a total of:

$$P = ( \begin{matrix}K \\ 2\end{matrix} ) = \frac{K ( K - 1 )}{2} \qquad [ 3 ]$$

microphone pairs for which the device 110 must calculate delay values in order to accurately estimate the direction-of-arrival. Thus, each TDOA vector may include P elements, which is the number of microphone pairs with K as the number of microphones.

Table 1 shows an example of microphone indices for the case of K=4. For example, a first microphone pair may include Mic0 and Mic1, a second microphone pair may include Mic0 and Mic2, and so on.

TABLE 1
The indices for microphone pairs when K = 4.

| k | index0 | index1 |
|---|---|---|
| 0 | 0 | 1 |
| 1 | 0 | 2 |
| 2 | 0 | 3 |
| 3 | 1 | 2 |
| 4 | 1 | 3 |
| 5 | 2 | 3 |

In order to estimate the direction-of-arrival, the device 110 may find a TDOA vector for each location vector. To find the TDOA vector, the device 110 may calculate the location difference vectors using:

$${d}_{k} = {u}_{index 1 [ k ]} - {u}_{index 0 [ k ]} , k = 0 to P - 1 \qquad [ 4 ]$$

where dₖ denotes the location difference vector for an individual microphone pair, which is a 3D vector with the three elements of the vector representing distance quantities.

Given the candidate location vectors (e.g., aₘ) and the location difference vectors dₖ described above, the device 110 may determine elements of the TDOA vectors, as shown below:

$${τ}_{m , k} = {a}_{m}^{T} {d}_{k} / c \qquad [ 5 ]$$

where τ_{m,k} denotes a time delay, the candidate location vectors aₘ are unit-length 3D vectors representing a direction in rectangular coordinates, and c is the speed of sound (e.g., 343 m/s).

The resulting time delay τ_{m,k} is a real number (or floating-point number) that may be negative or positive, measured in seconds. Thus, the device 110 may convert the time delay τ_{m,k} to a positive integer in the range of [0, intFactor·N−1], with intFactor a positive integer interpolation factor, and N the length of discrete Fourier transform (DFT) used. Typically DFT is used in cross-correlation calculation. The conversion is done with

$$t = modulo ( round ( τ \cdot fs \cdot intFactor ) , intFactor \cdot N ) \qquad [ 6 ]$$

where fs is a sampling frequency measured in Hertz (Hz), and round(x) is a function that rounds x to the nearest integer. Given |x|<N, then:

$$modulo ( x , N ) = \{ \begin{matrix}x , & if x \geq 0 \\ x + N , & otherwise\end{matrix} \qquad [ 7 ]$$

The device 110 may calculate (330) the TDOA vectors as:

$${t}_{m} = [ \begin{matrix}{t}_{m , 0} \\ {t}_{m , 1} \\ ⋮ \\ {t}_{m , P - 1}\end{matrix} ] , m = 0 to M - 1 \qquad [ 8 ]$$

where tₘ denotes a TDOA vector containing P elements (k=0 to P−1), where the kth element (t_{m,k}) contains the time delay between the microphones at index0[k] and index1[k] having values in the range of [0, intFactor·N−1], with N equal to the DFT length used in cross-correlation calculation.

As illustrated in FIG. 4 and described above, the device 110 may perform feature extraction 400 to generate second feature data from the spatial power data 332. For example, the CPMR component 420 may generate the CPMR features by calculating a cell peak mean ratio (CPMR), which is defined as the ratio of the power of the location cell with the highest power with respect to an average power of the rest of the location cells. The CPMR value represents a form of direct to reverberant ratio (DRR), with the direct power given by the highest power value of the location cells, while the rest of the location cells provide the power of reverberant components (e.g., excluding the location cell with the highest power value). For example, the CPMR component 420 may calculate a CPMR value by (i) determining that a first power value is a highest value of a first series of power values (e.g., spatial power data 332), (ii) determining an average power value by calculating a mean of the remaining power values (e.g., average value of the first series of power values, excluding the first power value), and (iii) determining a ratio of the first power value with respect to the average power value. The CPMR value should be highest when a head orientation is close to zero degrees and lower for other head orientation angles.

FIG. 5 is a block diagram illustrating an example of performing user engagement detection according to embodiments of the present disclosure. As described above, the device 110 may perform user engagement detection (UED) processing 500 to determine whether the user is engaged with the device 110. While detecting user engagement and/or estimating an amount of user engagement is useful on its own, it can also be beneficial when determining whether an input is directed to the device 110 (e.g., system directed). As part of performing UED processing, the device 110 may determine an estimated distance between the device 110 and the user (e.g., user's distance), an estimated angle of the user relative to the device 110 (e.g., relative angle of the user), and/or an estimated direction in which the user is facing (e.g., user orientation). For example, a user may be considered to be engaged with the device 110 if one or more of the following conditions are true:
The user is talking;
The user is in close proximity to the device 110;
The user is located in front of the device 110; and/or
The user is looking at the device.

To determine that the first condition is true, the device 110 may determine that near-end speech is represented in the audio data (e.g., user is talking). To determine that the second condition is true, the device 110 may estimate a distance to the user and determine that the estimated distance is below a distance threshold (e.g., user is in close proximity). To determine that the third condition is true, the device 110 may estimate a relative angle of the user and determine that the estimated angle is within a first desired range (e.g., user is in front of the device 110). To determine that the fourth condition is true, the device 110 may estimate the user orientation and determine that the user orientation is within a second desired range (e.g., user is looking at or near the device 110).

In some examples, the device 110 may determine that the user is engaged with the device 110 if one or more of the above-mentioned conditions are true. For example, the device 110 may detect whether the user is speaking and, if near-end speech is detected, may determine whether the user is in proximity to the device 110 (e.g., within 6 feet) using the estimated distance. If near-end speech is detected and the user is in proximity to the device 110, the device 110 may determine whether the estimated angle is within the first desired range and/or the user orientation is within the second desired range, which may vary depending on the estimated distance. If both conditions are satisfied, the device 110 may determine that the user is engaged with the device 110. For example, the device 110 may generate user engagement decision data indicating that the user is engaged with the device 110, an amount of user engagement, and/or a confidence score, although the disclosure is not limited thereto.

In other examples, the device 110 may determine that the user is engaged with the device 110 using a trained model (e.g., classifier, machine learning model, neural network, etc.). For example, the device 110 may generate input data indicating whether near-end speech is detected, the estimated distance, the estimated angle, the user orientation, and/or the like, and may process the input data using the trained model to determine whether the user is engaged with the device 110 and/or estimate an amount of user engagement. As described above, the device 110 may generate user engagement decision data indicating whether the user is engaged with the device 110, an amount of user engagement, and/or a confidence score, although the disclosure is not limited thereto. For example, in some examples the user engagement decision data may correspond to a binary value indicating whether a user is engaged (e.g., 1) or not engaged (e.g., 0) without departing from the disclosure. Additionally or alternatively, the user engagement decision data may correspond to a coarse estimate of user engagement and/or a confidence score associated with the user engagement decision, which may be output to downstream components to provide additional functionality.

In some examples, the device 110 may perform an action in response to determining that the user is engaged with the device 110. For example, the device 110 may send the user engagement decision data and/or the audio data to downstream components to provide additional functionality, may perform language processing on the audio data, may maintain a current state for a fixed time window (e.g., duration of time), and/or the like, although the disclosure is not limited thereto. Thus, when the device 110 determines that the user is engaged with the device 110, the device 110 may perform additional processing using the audio data and/or send the audio data to system component(s) 120 for additional processing, whereas when the device 110 determines that the user is not engaged with the device 110, the device 110 may ignore the audio data.

In the example illustrated in FIG. 5, UED processing 500 is performed by a user engagement detection (UED) component 560. For example, the UED component 560 may determine whether the user is engaged with the device 110 by processing a variety of input signals, which may be collectively referred to as UED input data 505. As illustrated in FIG. 5, the UED input data 505 may include first inputs received from an Acoustic Echo Cancellation (AEC) component 510, second inputs received from an Adaptive Reference Algorithm (ARA) component 520, third inputs received from an Ultrasound Proximity Sensor (UltraProx) component 530, fourth inputs received from a Sound Source Localization (SSL) component 540, fifth inputs received from a Multi-Channel Voice Activity Detection (MC-VAD) component 550, and/or sixth inputs received from the user orientation estimation component 340 described in greater detail above.

As described above with regard to FIG. 3, the device 110 may include an audio front end (AFE) that is configured to generate processed audio data by performing echo cancellation, noise reduction, adaptive interference cancellation, and/or the like. For example, the AEC component 510 may be configured to perform echo cancellation by generating an estimated echo signal and then subtracting the estimated echo signal from input audio data, while the ARA component 520 may be configured to perform adaptive interference cancellation. While not illustrated in FIG. 5, in some examples the AFE may detect playback and send a playback signal to the AEC component 510, the MC-VAD component 550, and/or the UED component 560, although the disclosure is not limited thereto.

As part of performing echo cancellation, the AEC component 510 may determine AEC data, which may include echo return loss enhancement (ERLE) data and/or double talk detection (DTD) data. As will be described in greater detail below, the ERLE data may indicate how much of the input audio data corresponds to the echo signal, while the DTD data may indicate whether double-talk conditions are detected. In some examples, double-talk conditions may be detected when the input audio data includes a representation of speech while playback is active (e.g., the device 110 is generating playback audio). The disclosure is not limited thereto, however, and in other examples double-talk conditions may be detected when the input audio data includes a representation of both near-end speech (e.g., speech generated by a user) and far-end speech (e.g., speech represented in the echo signal).

In some examples, the AEC component 510 may determine the ERLE data by determining an echo return loss enhancement (ERLE) value, which corresponds to a ratio of a first power spectral density of the AEC input (e.g., microphone audio signals Z(n, k)) and a second power spectral density of the AEC output (e.g., isolated microphone audio signals Z′(n, k)), as shown below:

$$E R L E ( n , k ) = \frac{{S}_{dd} ( n , k )}{{S}_{ee} ( n , k ) + ϵ} \qquad [ 9 ]$$

where n denotes a sample index (e.g., frame index), k denotes a bin index (e.g., frequency bin), ERLE(n, k) is the ERLE value for the nth sample index and the kth bin index, S_{dd}(n, k) is the power spectral density of the microphone audio signals Z(n, k) for the nth sample index and the kth bin index, Sₑₑ(n, k) is the power spectral density of the isolated microphone audio signals Z′(n, k) for the nth sample index and the kth bin index, and c is a nominal value. As used herein, a power spectral density may be referred to as a power spectral density function, power spectral density data, and/or the like without departing from the disclosure. Thus, the first power spectral density may be referred to as first power spectral density data and the second power spectral density may be referred to as second power spectral density data, although the disclosure is not limited thereto.

The ERLE value may enable the device 110 to distinguish between the microphone signal corresponding to an external audio source (e.g., near-end speech, such as a user talking, audible sounds, and/or environmental noise) or the microphone signal recapturing a portion of the playback audio generated by the device 110 itself (e.g., echo signal), which can trigger false user engagement. For example, the ERLE value being closer to a value of one corresponds to the second power spectral density of the AEC output being large relative to the first power spectral density of the AEC input, which indicates that a local sound source (such as near-end speech) is present in the bin index. In contrast, the ERLE value being much larger than a value of one corresponds to the second power spectral density of the AEC output being small relative to the first power spectral density of the AEC input, which indicates that the microphone signal mostly represents the echo signal (e.g., large portion of the microphone signal is being attenuated during echo cancellation).

To improve user engagement detection, the device 110 may distinguish between high ERLE conditions (e.g., false user engagement triggered by the echo signal) and low ERLE conditions (e.g., actual user engagement triggered by near-end speech). For example, the device 110 may determine that high ERLE conditions are present when the ERLE value is above a first threshold value, which indicates that the microphone signal corresponds to the echo signal (e.g., near-end speech is not present). In some examples, the device 110 may determine that low ERLE conditions are present when the ERLE value is below the first threshold value, which indicates that the microphone signal includes a representation of near-end speech. The disclosure is not limited thereto, however, and in other examples the device 110 may determine that low ERLE conditions are present when the ERLE value is below a second threshold value without departing from the disclosure. In some examples, the first threshold value and/or the second threshold value may vary without departing from the disclosure. For example, the first threshold value and/or the second threshold value may be dependent on a playback volume and/or the like, although the disclosure is not limited thereto.

While the example described above refers to the device 110 distinguishing between high ERLE conditions and low ERLE conditions, the disclosure is not limited thereto. Additionally or alternatively, the device 110 may use the ERLE value to distinguish between double-talk conditions and single-talk conditions without departing from the disclosure. For example, when playback is active and an ERLE value is above a third threshold value (e.g., 1.0) but still relatively low (e.g., below the first threshold value), the device 110 may determine that double-talk conditions are present (e.g., near-end speech is present in the bin index). In contrast, when playback is active but an ERLE value is above the first threshold value, the device 110 may determine that far-end single talk conditions are present (e.g., near-end speech is not present). In this example, an ERLE value below the third threshold value may indicate that echo cancellation has diverged or not yet converged.

In the example illustrated in FIG. 5, the first portion of the UED input data 505 received from the AEC component 510 is illustrated as ERLE/DTD data 515. In some examples, the AEC component 510 may send both the ERLE data and the DTD data to the UED component 560. The disclosure is not limited thereto, however, and in other examples the AEC component 510 may send the ERLE data or the DTD data to the UED component 560 without departing from the disclosure.

As described above, the ARA component 520 may be configured to perform adaptive interference cancellation. In some examples, the ARA component 520 may determine a variable step size (VSS) that controls an adaptation rate associated with performing adaptive interference cancellation. This step size is inversely proportional to a signal-to-noise ratio (SNR) estimate, which in turn roughly indicates speech activity. In the example illustrated in FIG. 5, the second portion of the UED input data 505 received from the ARA component 520 is illustrated as VSS data 525, which may correspond to a single VSS value or a series of VSS values without departing from the disclosure. Due to the relationship between a VSS value and speech activity, the UED component 560 may use the VSS value(s) to detect user engagement.

In some examples, the Ultrasound Proximity Sensor (UltraProx) component 530 may be configured to determine if a user is in proximity to the device 110 (e.g., within 6 feet) in an environment using ultrasound (e.g., ultrasonic frequencies). For example, the device 110 may estimate a distance between the device 110 and a user (e.g., user's distance) by emitting one or more ultrasonic signals and detecting reflection(s) caused by the ultrasonic signal(s) reflecting off of the user.

In some examples, the UltraProx component 530 may estimate the user's distance based on a time delay between a first time that an ultrasonic signal was emitted and a second time that a corresponding reflection was detected. The disclosure is not limited thereto, however, and in other examples the UltraProx component 530 may estimate the user's distance based on changes in energy measurements of a series of reflections without departing from the disclosure. Additionally or alternatively, the device 110 may detect movement of the user by emitting pulsed ultrasonic signals and detecting a change in energy measurements of reflections of the pulsed ultrasonic signals off of the user caused by the movement of the user relative to the device 110. Thus, in addition to and/or instead of determining an estimated distance, the device 110 may detect movement, and thus presence, of the user.

In some examples, the device 110 may vary a pulse width and/or a pulse strength of the ultrasonic signal depending on distance. For example, the device 110 may increase the pulse widths and/or pulse strengths when estimating user distances at longer distance ranges, or the device 110 may decrease the pulse widths and/or pulse strengths when estimating user distances at shorter distance ranges. Additionally or alternatively, the device 110 may increase the amount of time between pulse emissions when the user is walking around the environment (e.g., major motion) as compared to when the user is static or the environment is empty.

As described above, the device 110 may generate playback audio using one or more loudspeakers. For example, the device 110 may play media content, output notifications, generate sound effects, and/or the like by generating playback audio corresponding to a human hearing range (e.g., 20 Hz-20 kHz). In some examples, the device 110 may emit the ultrasonic signal(s) using a separate loudspeaker that is configured to only output ultrasound. For example, in addition to the one or more loudspeakers configured to generate the playback audio described above, the device 110 may include a separate tweeter configured to play the ultrasonic signal(s). The disclosure is not limited thereto, however, and in other examples the device 110 may emit the ultrasonic signal(s) using a full range driver. For example, a loudspeaker may be configured to play both bass and high frequency content (e.g., ultrasonic frequencies) without departing from the disclosure.

In the example illustrated in FIG. 5, the third portion of the UED input data 505 received from the UltraProx component 530 is illustrated as proximity data 535, which can be used as a cue to determine if the user is engaged with the device 110.

In some examples, the proximity data 535 may correspond to an estimated distance and/or a confidence score associated with the estimated distance. For example, the device 110 may estimate an exact distance between the device 110 and the user, and the proximity data 535 may indicate the estimated distance. The disclosure is not limited thereto, however, and in other examples the proximity data 535 may correspond to a proximity indicator (e.g., proximity flag) and/or a confidence score without departing from the disclosure. In this example, the proximity indicator may indicate whether a user is in proximity to the device 110, while the confidence score may indicate a likelihood that the user is in proximity to the device 110. For example, the device 110 may estimate the exact distance between the device 110 and the user, and the proximity data 535 may indicate whether the distance is below a threshold value (e.g., 4 feet, 6 feet, etc.). Additionally or alternatively, the device 110 may determine whether the user is in proximity to the device 110 (e.g., within 6 feet) without estimating the exact distance without departing from the disclosure. For example, the device 110 may detect movement of the user, and therefore presence in proximity to the device 110, without actually estimating the distance between the device 110 and the user.

As described in greater detail above, the device 110 may distinguish between multiple sound sources by performing sound source localization (SSL) processing. For example, the device 110 may perform SSL processing to generate SSL data, which may indicate when an individual sound source is represented in the audio data, a direction/location associated with the sound source, power values and/or target likelihood estimates for each direction around the device (e.g., 360 degrees) and/or individual sound source, and/or the like, although the disclosure is not limited thereto.

In some examples, the SSL component 540 may correspond to the SSL component 330 described in greater detail above with regard to FIG. 3. Thus, the SSL component 540 may calculate steered response power (SRP) using multi-channel audio data to generate spatial power data and/or direction data. For example, the SSL component 540 may generate the spatial power data by calculating a set of power values as a function of direction (e.g., spatial power). In addition, the SSL component 540 may find a direction of a largest power peak represented in the spatial power data for each audio frame (e.g., every 8 ms) and may include corresponding direction information in the direction data. For example, the direction of the largest power peak may be represented using an azimuth defining a two-dimensional (2D) vector and/or an azimuth and an elevation defining a three-dimensional (3D) vector without departing from the disclosure. Additionally or alternatively, the direction data may indicate a distance associated with a sound source that corresponds to the largest power peak without departing from the disclosure. For example, the device 110 may identify a sound source associated with the largest power peak and determine a distance between the sound source and the device 110. However, the disclosure is not limited thereto, and in other examples the SSL component 540 may function differently and/or may be a different component from the SSL component 330 described above.

In the example illustrated in FIG. 5, the fourth portion of the UED input data 505 received from the SSL component 540 is illustrated as SSL data 545. In some examples, the SSL data 545 may correspond to the spatial power data and/or the direction data described above. For example, the SSL data 545 may include a set of power values as a function of direction (e.g., spatial power) and/or target likelihood estimates for each direction around the device (e.g., 360 degrees). The disclosure is not limited thereto, however, and in other examples the SSL data 545 may indicate direction information (e.g., direction, distance, location, likelihood estimate, and/or the like) associated with each sound source detected by the device 110 without departing from the disclosure. For example, the device 110 may detect one or more sound sources by identifying power peak(s) represented in the spatial power data for each audio frame (e.g., every 8 ms), and the SSL data 545 may include direction information corresponding to each of the detected sound sources. As described above, the SSL data 545 may indicate the direction associated with each sound source using an azimuth defining a two-dimensional (2D) vector and/or an azimuth and an elevation defining a three-dimensional (3D) vector without departing from the disclosure.

As described in greater detail above, the device 110 may detect near-end speech by performing voice activity detection (VAD) processing. For example, the device 110 may perform VAD processing to determine whether voice activity (e.g., speech) is detected. If voice activity is detected, in some examples the device 110 may perform additional processing associated with the voice activity. For example, the device 110 may perform start-point detection, end-point detection, and/or may determine additional information such as signal-to-noise ratio (SNR) values associated with the speech, although the disclosure is not limited thereto.

As illustrated in FIG. 5, the MC-VAD component 550 is configured to perform multichannel VAD processing to determine whether voice activity is detected and generate speech presence data 555. In addition to detecting voice activity, the MC-VAD component 550 may also determine whether the speech was generated by the user or the device 110 (e.g., distinguish between whether the user or the device is talking). For example, the MC-VAD component 550 may distinguish between near-end speech generated by the user and machine-generated speech corresponding to an echo signal. In some examples, the MC-VAD component 550 may include a Deep Neural Network (DNN) or other trained model that is configured to take multichannel input (e.g., after spatial processing is performed) and use these spatial cues to determine if near-end speech is present (e.g., speech is active or not). Thus, the speech presence data 555 may indicate whether near-end speech is represented in the input audio data.

As the MC-VAD component 550 performs complex processing to distinguish between machine-generated speech and speech generated by the user, the MC-VAD component 550 does not correspond to the VAD component 320 illustrated in FIG. 3. However, in some examples the MC-VAD component 550 may perform VAD processing using techniques similar to the ones described in greater detail above with regard to the VAD component 320 without departing from the disclosure. For example, the MC-VAD component 550 may determine whether voice activity (e.g., speech) is detected, and, if voice activity is detected, may determine signal-to-noise ratio (SNR) values associated with the speech without departing from the disclosure. In addition, the MC-VAD component 550 may also perform start-point detection (e.g., determine when speech starts) and/or end-point detection (e.g., determine when speech ends), although the disclosure is not limited thereto.

The MC-VAD component 550 may use various techniques to determine whether the microphone audio data includes speech. In some examples, the MC-VAD component 550 may apply voice activity detection (VAD) techniques. Such techniques may determine whether speech is present in the audio data based on various quantitative aspects of the audio data, such as the spectral slope between one or more frames of the audio data; the energy levels of the audio data in one or more spectral bands; the signal-to-noise ratios of the audio data in one or more spectral bands; or other quantitative aspects. In other examples, the MC-VAD component 550 may implement a classifier configured to distinguish speech from background noise. The classifier may be implemented by techniques such as linear classifiers, support vector machines, and decision trees. In still other examples, the MC-VAD component 550 may apply hidden Markov model (HMM) or Gaussian mixture model (GMM) techniques to compare the audio data to one or more acoustic models in storage, which acoustic models may include models corresponding to speech, noise (e.g., environmental noise or background noise), or silence. Still other techniques may be used to determine whether speech is present in audio data.

The MC-VAD component 550 may be configured to be robust to background noise so as to accurately detect when audio data actually includes speech or not. The MC-VAD component 550 may operate on audio data, feature vectors, and/or other data representing the microphone audio data. For example, the MC-VAD component 550 may take the form of a deep neural network (DNN) and may operate on a single feature vector representing the entirety of the microphone audio data or may operate on multiple feature vectors, for example feature vectors representing frames of audio data where each frame covers a certain amount of time of audio data (e.g., 25 ms).

In some examples, the MC-VAD component 550 may consider speaker ID information (such as may be output by a user recognition component) and/or directionality data that may indicate what direction (relative to the device 110) the incoming audio was received from. For example, the directionality data may have been determined by a beamformer or other component of the device 110. While not illustrated in FIG. 5, in some examples the MC-VAD component 550 may receive the directionality data from the SSL component 540, such as spatial power data and/or direction data, although the disclosure is not limited thereto. The MC-VAD component 550 may also consider data regarding a previous utterance which may indicate whether the further audio data received by the system is likely to include speech. Other VAD techniques may also be used without departing from the disclosure.

In the example illustrated in FIG. 5, the fifth portion of the UED input data 505 received from the MC-VAD component 550 is illustrated as speech presence data 555. In some examples, the speech presence data 555 may include a binary indicator. Thus, if the microphone audio data includes speech, the MC-VAD component 550 may output a first indicator that the microphone audio data does include speech (e.g., a 1) and if the microphone audio data does not include speech, the MC-VAD component 550 may output a second indicator that the microphone audio data does not include speech (e.g., a 0). In other examples, the speech presence data 555 may include a score (e.g., a number between 0 and 1) corresponding to a likelihood that the microphone audio data includes speech, although the disclosure is not limited thereto. Additionally or alternatively, the speech presence data 555 may include indicators of a speech start point and/or a speech endpoint without departing from the disclosure.

As described in greater detail above with regard to FIGS. 3-4, the device 110 may estimate a direction in which the user is facing (e.g., user orientation) by performing user orientation estimation. For example, the user orientation estimation component 340 may receive a variety of inputs and generate the user orientation data 345. As user engagement is strongly correlated with the user looking at the device 110, the user orientation data 345 indicates an estimated direction in which the user's head is facing (e.g., not the user's body), and can be used as a cue to determine if the user is engaged with the device 110. In the example illustrated in FIG. 3, for example, the user orientation estimation component 340 uses one or more audio signals (e.g., processed audio data 315), the VAD/SNR data 325 (e.g., SNR value(s)), the spatial power data 332 (e.g., spatial power as a function of direction), and/or the direction data 335 (e.g., direction of the dominant sound source) to derive features (e.g., feature vector(s)) used to generate the user orientation data 345.

In the example illustrated in FIG. 5, the sixth portion of the UED input data 505 received from the user orientation estimation component 340 is illustrated as user orientation data 345, which may indicate an estimated direction in which the user is facing (e.g., coarse estimate of head orientation associated with the user's head). As user engagement is strongly correlated with the user looking at the device 110, the user orientation can be used as a cue to determine if the user is engaged with the device 110.

As illustrated in FIG. 5, the user engagement detection (UED) component 560 may receive a variety of inputs and derive features with which to perform user engagement detection and generate the UED data 570. For example, FIG. 5 illustrates an example in which the UED component 560 receives the ERLE/DTD data 515, the VSS data 525, the proximity data 535, the SSL data 545, the speech presence data 555, and/or the user orientation data 345. The disclosure is not limited thereto, however, and in some examples the UED component 560 may receive additional inputs and/or features without departing from the disclosure. For example, the UED component 560 may receive and/or generate additional features associated with an environment associated with the device 110. To illustrate an example, the UED component 560 may receive and/or generate features associated with room information, such as a size of the room, a reflection or reverberation level associated with the room (e.g., reverberation time), a room impulse response (RIR), and/or the like, although the disclosure is not limited thereto. By knowing the room information, the device 110 may condition other features and/or determine an expected range or limits associated with variables.

In some examples, the UED component 560 may only perform UED processing when (i) the speech presence data 555 corresponds to time intervals of active speech (e.g., speech is detected in the microphone audio data) and/or (ii) SNR value(s) associated with the time intervals exceed a threshold value. When those conditions are satisfied, the UED component 560 may perform UED processing to generate the UED data 570. When those conditions are not satisfied, however, the UED component 560 may ignore the microphone audio data and/or generate UED data 570 indicating that user engagement is not detected.

As illustrated in FIG. 5, the UED component 560 may use the UED input data 505 to generate the UED data 570. For example, the UED input data 505 may be input to a classifier that is trained to recognize patterns related to positive and negative user engagement. An output of the classifier may represent a user engagement decision, and popular choices for classifier design include neural networks and Gaussian mixture models. In some examples, the classifier may be trained using labeled data, where a feature vector is associated with a label having binary value indicating whether a user is engaged (e.g., 1) or not engaged (e.g., 0), although the disclosure is not limited thereto. Additionally or alternatively, in some examples the UED component 560 may be configured to generate a coarse estimate of user engagement and/or a confidence score associated with the user engagement decision, which may be output to downstream components to provide additional functionality.

Various machine learning techniques may be used to train and operate models to perform various steps described herein, such as user engagement detection, system directed detection, etc. Models may be trained and operated according to various machine learning techniques. Such techniques may include, for example, neural networks (such as deep neural networks and/or recurrent neural networks), inference engines, trained classifiers, etc. Examples of trained classifiers include Support Vector Machines (SVMs), neural networks, decision trees, AdaBoost (short for “Adaptive Boosting”) combined with decision trees, and random forests. Focusing on SVM as an example, SVM is a supervised learning model with associated learning algorithms that analyze data and recognize patterns in the data, and which are commonly used for classification and regression analysis. Given a set of training examples, each marked as belonging to one of two categories, an SVM training algorithm builds a model that assigns new examples into one category or the other, making it a non-probabilistic binary linear classifier. More complex SVM models may be built with the training set identifying more than two categories, with the SVM determining which category is most similar to input data. An SVM model may be mapped so that the examples of the separate categories are divided by clear gaps. New examples are then mapped into that same space and predicted to belong to a category based on which side of the gaps they fall on. Classifiers may issue a “score” indicating which category the data most closely matches. The score may provide an indication of how closely the data matches the category.

In order to apply the machine learning techniques, the machine learning processes themselves need to be trained. Training a machine learning component such as, in this case, one of the first or second models, requires establishing a “ground truth” for the training examples. In machine learning, the term “ground truth” refers to the accuracy of a training set's classification for supervised learning techniques. Various techniques may be used to train the models including backpropagation, statistical learning, supervised learning, semi-supervised learning, stochastic learning, or other known techniques.

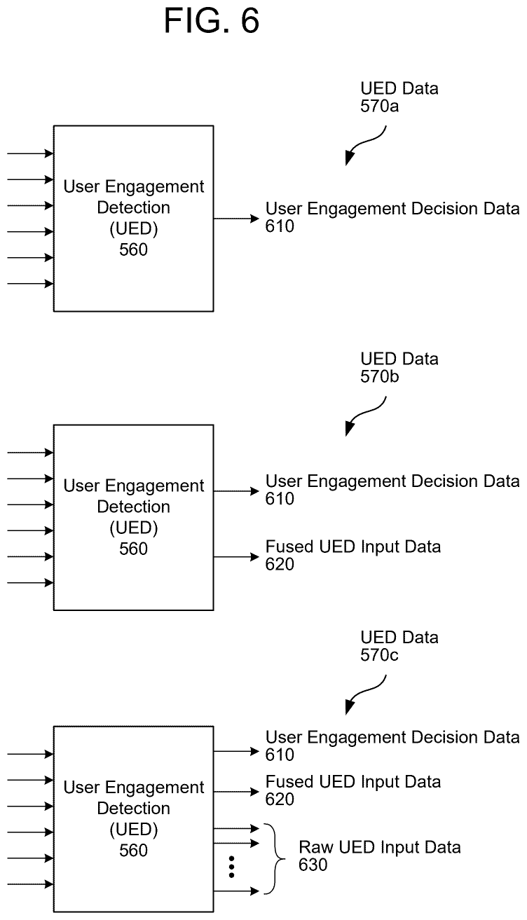

FIG. 6 illustrates examples of generating a variety of user engagement detection data according to embodiments of the present disclosure. As described above, the UED component 560 may process the UED input data 505 to generate the UED data 570. For example, the UED component 560 may generate user engagement decision data 610 indicating whether the user is engaged with the device 110, an amount of user engagement, a confidence score, and/or the like, although the disclosure is not limited thereto. In some examples, the user engagement decision data 610 may correspond to a binary value indicating whether a user is engaged with the device 110 (e.g., 1) or not engaged with the device 110 (e.g., 0) without departing from the disclosure. Additionally or alternatively, the user engagement decision data 610 may correspond to a coarse estimate of user engagement and/or a confidence score associated with the user engagement decision, which may be output to downstream components to provide additional functionality.

In some examples, the UED data 570 may only correspond to the user engagement decision data 610. For example, FIG. 6 illustrates an example of first UED data 570a, which only includes the user engagement decision data 610. Thus, the UED component 560 may determine the user engagement decision data 610 indicating whether the user is engaged with the device 110, an amount of user engagement, a confidence score, and/or the like, and may output the user engagement decision data 610 to downstream components for additional processing and/or functionality. The disclosure is not limited thereto, however, and in other examples the UED data 570 may include additional information associated with the UED input data 505 without departing from the disclosure.

In some examples, the UED input data 505 may correspond to a variety of features and the UED component 560 may combine at least a portion of these features to generate fused UED input data 620. By generating the fused UED input data 620, the UED component 560 may pass some or all of the features to downstream components, while providing a consistent data structure regardless of variations in capabilities and/or an amount of features included in the UED input data 505.

To generate the fused UED input data 620, the UED component 560 may implement a late fusion model based on the confidence score generated by the UED component 560 and/or confidence estimate(s) generated by the other components. In some examples, the UED component 560 may generate the fused UED input data 620 using the ERLE/DTD data 515, the VSS data 525, the proximity data 535, the SSL data 545, the speech presence data 555, and/or the user orientation data 345. The disclosure is not limited thereto, however, and in some examples the UED component 560 may generate the fused UED input data 620 using additional inputs and/or features without departing from the disclosure. Additionally or alternatively, the UED component 560 may generate the fused UED input data 620 using fewer inputs and/or features without departing from the disclosure.

In some examples, the UED data 570 may correspond to both the user engagement decision data 610 and the fused UED input data 620. For example, FIG. 6 illustrates an example of second UED data 570b, which includes the user engagement decision data 610 and the fused UED input data 620. The disclosure is not limited thereto, however, and in other examples the UED data 570 may also include a portion of the UED input data 505 without departing from the disclosure. For example, FIG. 6 illustrates an example of third UED data 570c, which includes the user engagement decision data 610, the fused UED input data 620, and raw UED input data 630.

In this example, the raw UED input data 630 may correspond to some or all of the UED input data 505 without departing from the disclosure. For example, the UED component 560 may send important features from the UED input data 505 to downstream components for additional processing. Additionally or alternatively, the UED component 560 may send a majority of features and/or all of the features from the UED input data 505 to downstream components for additional processing.

While FIG. 6 illustrates an example in which the third UED data 570c includes the user engagement decision data 610, the fused UED input data 620, and the raw UED input data 630, the disclosure is not limited thereto and the UED data 570 may vary without departing from the disclosure. Thus, the UED data 570 may correspond to any combination of the user engagement decision data 610, the fused UED input data 620, and/or the raw UED input data 630. For example, the UED data 570 may correspond to the user engagement decision data 610 and the raw UED input data 630, without including the fused UED input data 620, without departing from the disclosure. Additionally or alternatively, the type and/or amount of features included in the raw UED input data 630 may vary without departing from the disclosure.

In some examples, when the device 110 determines that the user is speaking (e.g., detects an utterance) and the user engagement decision data 610 indicates that the user is engaged with the device 110 (e.g., the speech is directed to the device 110), the device 110 may generate first audio data representing the utterance, may perform language processing on the first audio data to determine a voice command, and may cause an action to be performed based on the voice command. For example, the device 110 may generate the first audio data using a portion of the microphone audio data that represents the utterance and then the device 110 may perform language processing using the first audio data and/or send the first audio data to the system component(s) 120 to perform language processing without departing from the disclosure.

The disclosure is not limited thereto, however, and in other examples the device 110 may determine that the user is engaged with the device 110 and may perform an action for a fixed time window (e.g., duration of time). For example, in response to determining that the user is engaged at a first time, the system 100 may perform language processing for a duration of time (e.g., 10 seconds) after the first time. If the user continues to be engaged during this time window, the system 100 may continue performing language processing, but if the user has not re-engaged, the system 100 may end the language processing without departing from the disclosure. For example, the device 110 may process the first audio data and/or stream the first audio data to the system component(s) 120 while the user is engaged with the device 110 and may stop processing and/or streaming once the user fails to re-engage with the device 110.

In some examples, the system 100 may be configured to capture audio representing a voice command and perform an action responsive to the voice command. For example, in response to determining that the user is engaged with the device 110 and/or detecting a system-directed input command, the device 110 may identify a sound source (e.g., perform SSL track selection) corresponding to desired speech and generate audio data representing the desired speech. Using the audio data, the system 100 may perform language processing to determine an action to perform that is responsive to the desired speech (e.g., voice command). For example, the voice command(s) may control the device 110, audio devices (e.g., play music over loudspeaker(s), capture audio using microphone(s), or the like), multimedia devices (e.g., play videos using a display, such as a television, computer, tablet or the like), smart home devices (e.g., change temperature controls, turn on/off lights, lock/unlock doors, etc.), and/or the like without departing from the disclosure.

In some examples, the device 110 may be configured to perform the language processing without departing from the disclosure. For example, the device 110 may send the output audio data to a language processing component associated with the device 110 and the language processing component may perform language processing using the output audio data to determine an action responsive to the voice command. To cause the action to be performed, the device 110 may perform the action itself, may send a command to other device(s) associated with the user profile, may send the command to the system component(s) 120, and/or the like without departing from the disclosure. The disclosure is not limited thereto, however, and in other examples the system component(s) 120 may be configured to perform the language processing and the device 110 may send output audio data associated with the selected sound source (e.g., selected SSL track) to the system component(s) 120 via the network(s) 199. For example, the system component(s) 120 may perform language processing using the output audio data to determine an action to be performed that is responsive to the voice command. The system component(s) 120 may cause the action to be performed by sending a command to the device 110 and/or other device(s) associated with a user profile.

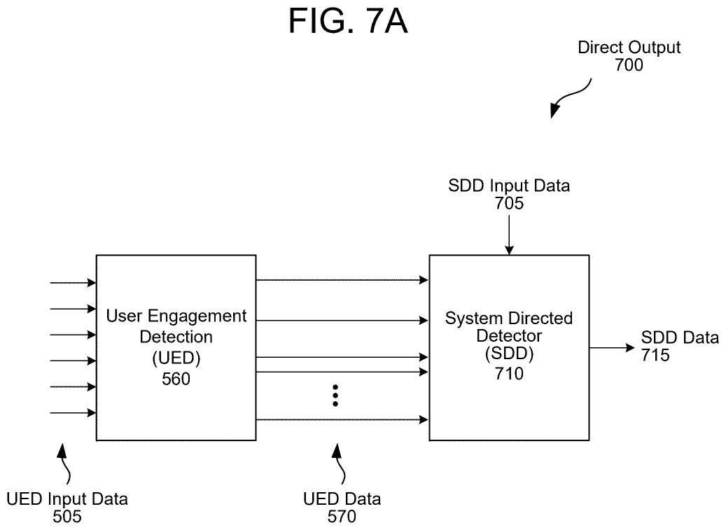

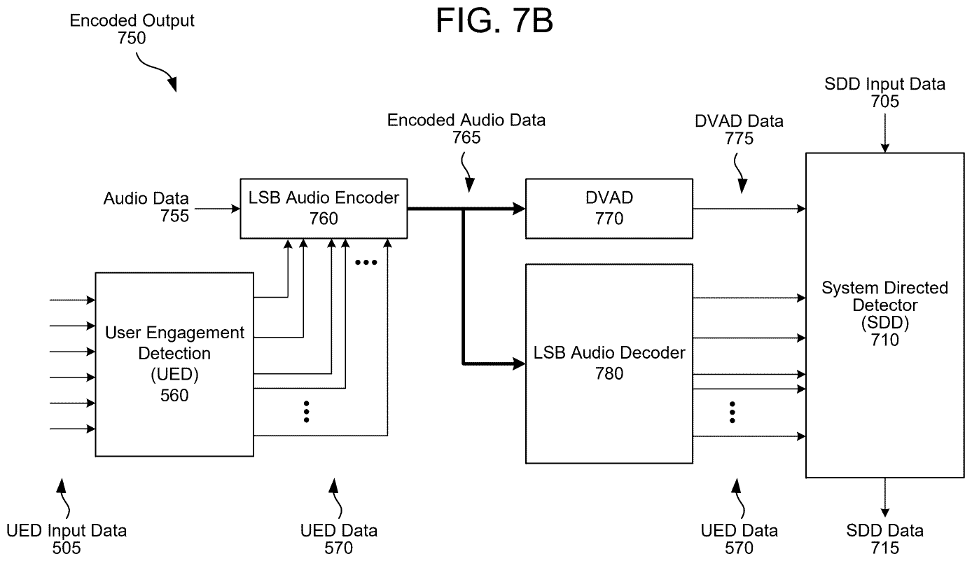

FIGS. 7A-7B are block diagrams illustrating examples of outputting user engagement detection data to a system directed detector according to embodiments of the present disclosure.

As described above, the UED component 560 may send the user engagement decision data 610 and/or some or all of the features from the UED input data 505 to downstream components for additional processing. For example, the UED component 560 may send UED data 570 corresponding to any combination of the user engagement decision data 610, the fused UED input data 620, and/or the raw UED input data 630 to the downstream components.

In some examples, the device 110 may use the user engagement decision data 610 and/or the UED data 570 as part of a larger user engagement detection processing. While detecting user engagement and/or estimating an amount of user engagement is useful on its own, it can also be beneficial when detecting a system-directed input command. For example, the UED data 570 may be input to a system directed detector (SDD) component 710 that is configured to determine whether an input is directed to the device 110.

FIG. 7A illustrates an example of the UED component 560 sending the UED data 570 to downstream components via direct output 700. For example, the UED component 560 may send the UED data 570 directly to the SDD component 710 for additional processing. As illustrated in FIG. 7A, the SDD component 710 may process SDD input data 705 and the UED data 570 to generate SDD data 715. In some examples, the SDD data 715 may correspond to a binary value indicating whether an input is directed to the device 110 (e.g., 1) or not directed to the device 110 (e.g., 0) without departing from the disclosure. Additionally or alternatively, the SDD data 715 may correspond to a coarse estimate of whether the input is directed to the device 110 and/or a confidence score. The disclosure is not limited thereto, however, and the SDD data 715 may correspond to the SDD result 1385, which will be described in greater detail below with regard to FIG. 13, without departing from the disclosure.

FIG. 7B illustrates an example of the UED component 560 sending the UED data 570 to downstream components via encoded output 750. For example, instead of sending the UED data 570 directly to the SDD component 710, in some examples the UED component 560 may send the UED data 570 to a least significant bit (LSB) audio encoder component 760.

As illustrated in FIG. 7B, the LSB audio encoder component 760 may receive audio data 755 and the UED data 570 and may generate encoded audio data 765. For example, the LSB audio encoder component 760 may generate the encoded audio data 765 by combining the UED data 570 with the audio data 755 using various techniques without departing from the disclosure. In some examples the LSB audio encoder component 760 may generate the encoded audio data 765 by encoding the UED data 570 in a least significant bit (LSB) of the audio data 755, although the disclosure is not limited thereto. For example, the LSB audio encoder component 760 may encode a portion of the UED data 570 in an individual audio frame of the encoded audio data 765 by replacing one or more least significant bits of the audio data 755, such that an entirety of the UED data 570 is represented in the encoded audio data 765 over a series of audio frames.

As illustrated in FIG. 7B, the LSB audio encoder component 760 may send the encoded audio data 765 to downstream components, such as a directive voice activity detection (DVAD) component 770 and/or a LSB audio decoder component 780. The DVAD component 770 may process the encoded audio data 765 to generate DVAD data 775, which the DVAD component 770 may output to the SDD component 710. For example, the DVAD component 770 may ignore the least significant bits and process the encoded audio data 765 the same as the DVAD component 770 would have processed the audio data 755 itself, as will be described in greater detail below.

While the DVAD component 770 processes the encoded audio data 765 as audio data (e.g., ignoring the least significant bits), the LSB audio decoder component 780 may do the opposite and process the least significant bits of the encoded audio data 765 while ignoring the rest of the audio data. For example, the LSB audio decoder component 780 may decode the encoded audio data 765 to generate the UED data 570, which the LSB audio decoder component 780 may output to the SDD component 710. While not illustrated in FIG. 7B, the UED component 560 and the LSB audio encoder component 760 may be associated with a first processor and/or first interface of the device 110, while the LSB audio decoder component 780 and the SDD component 710 may be associated with a second processor and/or second interface of the device 110. Thus, generating the encoded audio data 765 enables the device 110 to easily transfer the UED data 570 to the SDD component 710.

As illustrated in FIG. 7B, the DVAD component 770 may process the encoded audio data 765 to generate the DVAD data 775. While the DVAD component 770 may not correspond to the VAD component 320 illustrated in FIG. 3, the DVAD component 770 may perform VAD processing using techniques similar to the ones described in greater detail above with regard to the VAD component 320 without departing from the disclosure. For example, the DVAD component 770 may determine whether voice activity (e.g., speech) is detected. In addition, the DVAD component 770 may also perform start-point detection (e.g., determine when speech starts) and/or end-point detection (e.g., determine when speech ends), although the disclosure is not limited thereto.

The DVAD component 770 may use various techniques to determine whether the microphone audio data includes speech. In some examples, the DVAD component 770 may apply voice activity detection (VAD) techniques. Such techniques may determine whether speech is present in the audio data based on various quantitative aspects of the audio data, such as the spectral slope between one or more frames of the audio data; the energy levels of the audio data in one or more spectral bands; the signal-to-noise ratios of the audio data in one or more spectral bands; or other quantitative aspects. In other examples, the DVAD component 770 may implement a classifier configured to distinguish speech from background noise. The classifier may be implemented by techniques such as linear classifiers, support vector machines, and decision trees.

In still other examples, the DVAD component 770 may apply hidden Markov model (HMM) or Gaussian mixture model (GMM) techniques to compare the audio data to one or more acoustic models in storage, which acoustic models may include models corresponding to speech, noise (e.g., environmental noise or background noise), or silence. Still other techniques may be used to determine whether speech is present in audio data.

The DVAD component 770 may be configured to be robust to background noise so as to accurately detect when audio data actually includes speech or not. The DVAD component 770 may operate on audio data, feature vectors, and/or other data representing the microphone audio data. For example, the DVAD component 770 may take the form of a deep neural network (DNN) and may operate on a single feature vector representing the entirety of the microphone audio data or may operate on multiple feature vectors, for example feature vectors representing frames of audio data where each frame covers a certain amount of time of audio data (e.g., 25 ms).

While the MC-VAD component 550 may detect speech and determine whether the speech was generated by the user or the device 110 (e.g., distinguish between whether the user or the device is talking), the DVAD component 770 is only configured to detect speech. For example, the DVAD component 770 does not distinguish between near-end speech generated by the user and machine-generated speech corresponding to an echo signal. Thus, the DVAD data 775 may indicate that voice activity is detected even when the user is not talking, which may be referred to as a false wake event. For example, the DVAD data 775 may indicate that speech is detected during TTS playback due to residual echo represented in the encoded audio data 765. However, the SDD component 710 may use other input features to ignore these false wake events and/or distinguish between far-end single-talk conditions (e.g., when only device playback is active) and double-talk conditions (e.g., when the user is trying to talk over device playback).

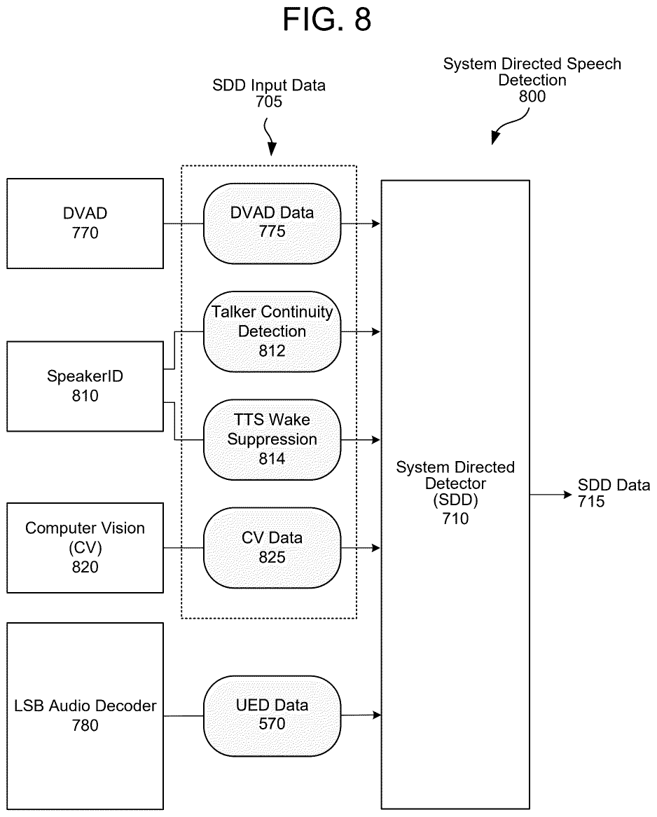

FIG. 8 is a block diagram illustrating an example of a system directed detector according to embodiments of the present disclosure. As described above, in some examples the device 110 may use the user engagement decision data 610 and/or the UED data 570 as part of a larger user engagement detection processing. For example, the UED data 570 may be input to the system directed detector (SDD) component 710, which is configured to determine whether an input is directed to the device 110.

As illustrated in FIG. 8, the SDD component 710 may perform system directed speech detection 800 to generate the SDD data 715. For example, the SDD component 710 may process SDD input data 705 and/or UED data 570 to generate the SDD data 715 indicating whether an input is directed to the device 110. In the example illustrated in FIG. 8, the SDD input data 705 may include the DVAD data 775 along with Talker Continuity Detection (TCD) data 812, TTS wake suppression data 814, and/or CV data 825, although all three of these inputs are optional.

As illustrated in FIG. 8, the TCD data 812 and the TTS wake suppression data 814 may be determined at least partially based on a speaker identifier (e.g., speakerID) 810. For example, the device 110 may distinguish between different sound sources and/or users and associate each individual sound source with a unique speaker identifier. Thus, the device 110 may track the speaker identifiers over time by generating speaker identifier data, which may include a series of speaker identifiers. In some examples, the speaker identifier 810 may correspond to speaker ID information output by a user recognition component, although the disclosure is not limited thereto.

Assuming that a conversation is between the device 110 and a single user, detecting that the same talker is speaking a follow-up utterance is an important signal for the SDD component 710. Thus, the device 110 may generate the TCD data 812 to indicate whether the same user is continuing to speak to the device 110. In some examples, the device 110 may use the speaker identifier data to generate the TCD data 812. For example, the device 110 may generate the TCD data 812 by determining when the unique speaker identifier changes over time. The disclosure is not limited thereto, however, and the device 110 may generate the TCD data 812 without using the speakerID 810 without departing from the disclosure. Thus, in other examples the device 110 may use other input features to determine that the same user is continuing to speak to the device 110. For example, the device 110 may use the SSL data 545 to determine that a current utterance is associated with the same direction as a previous utterance. Additionally or alternatively, the device 110 may use the CV data 825 to determine that there is talker continuity without departing from the disclosure. For example, the device 110 may determine that a face associated with the current utterance is also associated with the previous utterance. The disclosure is not limited thereto, however, and the device 110 may generate the TCD data 812 using a variety of techniques without departing from the disclosure.

In some examples, the device 110 may use the speaker identifier data (e.g., speakerID 810) to generate the TTS wake suppression data 814. As mentioned above, the device 110 may distinguish between different sound sources and/or users and associate each individual sound source with a unique speaker identifier. Thus, if the unique speaker identifier corresponds to an echo signal (e.g., sound source is the device 110) and/or does not correspond to a user, the device 110 may generate TTS wake suppression data 814 to prevent false triggering during TTS playback, although the disclosure is not limited thereto.

As described above, the DVAD component 770 is only configured to detect speech and does not distinguish between near-end speech generated by the user and machine-generated speech corresponding to an echo signal. Thus, the DVAD data 775 may indicate that voice activity is detected even when the user is not talking (e.g., false wake event). For example, the DVAD data 775 may indicate that speech is detected during TTS playback due to residual echo represented in the encoded audio data 765. In some examples, the SDD component 710 may use the TTS wake suppression data 814 to ignore these false wake events. Additionally or alternatively, the SDD component 710 may use other input features to ignore these false wake events and/or distinguish between far-end single-talk conditions (e.g., when only device playback is active) and double-talk conditions (e.g., when the user is trying to talk over device playback). For example, the SDD component 710 may perform self-wake prevention by determining that (i) TTS playback is present and (ii) near-end speech is not present, based on the ERLE/DTD data 515, the VSS data 525, and/or additional input features.

In some examples, the device 110 may optionally include a camera for capturing image and/or video data, which is collectively referred to as image data. Thus, the system 100 may optionally use computer vision (CV) techniques operating on image data as part of performing the system directed speech detection 800. For example, a CV component 820 may use image data to determine when a user is speaking and/or which user is speaking, which may be used to generate CV data 825. The system 100 may use face detection techniques to detect a human face represented in image data (for example using object detection component as discussed below). The system 100 may use a classifier or other model configured to determine whether a face is looking at a device 110. The system 100 may also be configured to track a face in image data to understand which faces in the video are belonging to the same person and where they may be located in image data and/or relative to a device 110. The system 100 may also be configured to determine an active speaker, for example by determining which face(s) in image data belong to the same person and whether the person is speaking or not. The system 100 may use components such as user recognition component, object tracking component, and/or other components to perform such operations.

To illustrate an example, the SDD component 710 may use the UED data 570 (e.g., user engagement decision data 610) in conjunction with image-based user engagement detection (e.g., computer vision decision) without departing from the disclosure. For example, the device 110 may use a camera to generate image data and may perform computer vision processing using the image data to determine whether a face is speaking and/or a user is engaged with the device 110. By combining the image-based UED processing with the audio-based UED processing described above (e.g., user engagement decision data 610), the device 110 may improve an overall accuracy of the UED determination. To illustrate a simple example, a first user may be visible in the image data while a second user may be speaking but not visible. Thus, while the device 110 may detect a face represented in the image data, the user engagement decision data 610 may indicate that the person is not engaged with the device 110 and the device 110 may accurately ignore the speech.

In some examples, when the device 110 determines that the user is speaking (e.g., detects an utterance) and that the speech is directed to the device 110, the device 110 may generate first audio data representing the utterance, may perform language processing on the first audio data to determine a voice command, and may cause an action to be performed based on the voice command. For example, the device 110 may generate the first audio data using a portion of the microphone audio data that represents the utterance and then the device 110 may perform language processing using the first audio data and/or send the first audio data to the system component(s) 120 to perform language processing without departing from the disclosure.

The disclosure is not limited thereto, however, and in other examples the device 110 may determine that the speech is directed to the device 110 and may perform an action for a fixed time window (e.g., duration of time). For example, in response to determining that the speech is directed to the device 110 at a first time, the system 100 may perform language processing for a duration of time (e.g., 10 seconds) after the first time. If the user continues to be engaged during this time window, the system 100 may continue performing language processing, but if the user has not re-engaged, the system 100 may end the language processing without departing from the disclosure. For example, the device 110 may process the first audio data and/or stream the first audio data to the system component(s) 120 while the user is engaged with the device 110 and may stop processing and/or streaming once the user fails to re-engage with the device 110.

In some examples, the system 100 may be configured to capture audio representing a voice command and perform an action responsive to the voice command. For example, in response to detecting a system-directed input command, the device 110 may identify a sound source (e.g., perform SSL track selection) corresponding to desired speech and generate audio data representing the desired speech. Using the audio data, the system 100 may perform language processing to determine an action to perform that is responsive to the desired speech (e.g., voice command). For example, the voice command(s) may control the device 110, audio devices (e.g., play music over loudspeaker(s), capture audio using microphone(s), or the like), multimedia devices (e.g., play videos using a display, such as a television, computer, tablet or the like), smart home devices (e.g., change temperature controls, turn on/off lights, lock/unlock doors, etc.), and/or the like without departing from the disclosure.

In some examples, the device 110 may be configured to perform the language processing without departing from the disclosure. For example, the device 110 may send the output audio data to a language processing component associated with the device 110 and the language processing component may perform language processing using the output audio data to determine an action responsive to the voice command. To cause the action to be performed, the device 110 may perform the action itself, may send a command to other device(s) associated with the user profile, may send the command to the system component(s) 120, and/or the like without departing from the disclosure. The disclosure is not limited thereto, however, and in other examples the system component(s) 120 may be configured to perform the language processing and the device 110 may send output audio data associated with the selected sound source (e.g., selected SSL track) to the system component(s) 120 via the network(s) 199. For example, the system component(s) 120 may perform language processing using the output audio data to determine an action to be performed that is responsive to the voice command. The system component(s) 120 may cause the action to be performed by sending a command to the device 110 and/or other device(s) associated with a user profile.

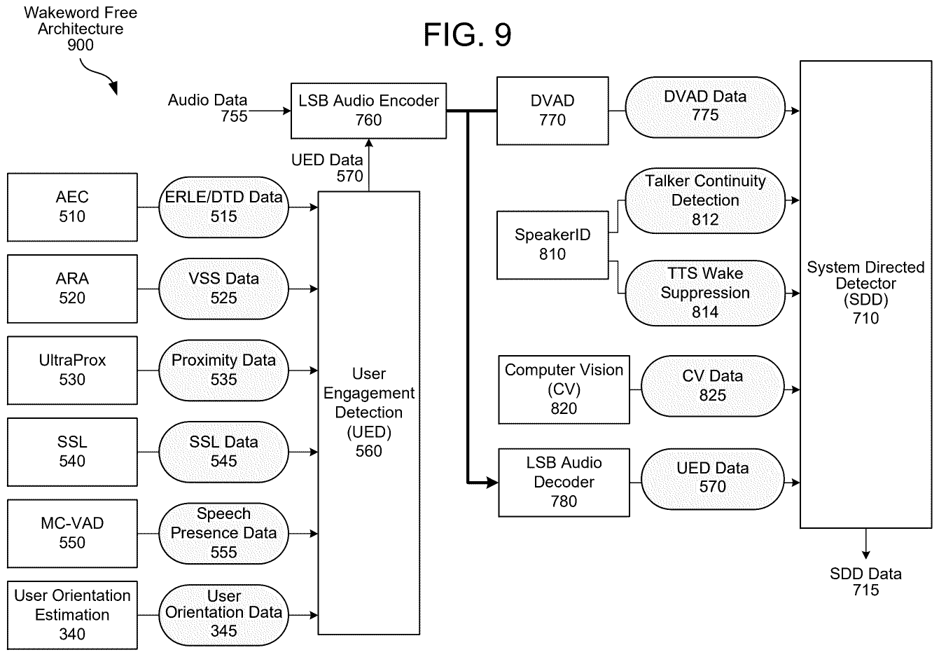

FIG. 9 is a block diagram illustrating an example of performing user engagement detection as part of detecting system directed speech, according to embodiments of the present disclosure. As illustrated in FIG. 9, wakeword free architecture 900 may include the components described in greater detail above with regard to FIGS. 5-8 without departing from the disclosure. However, as the components illustrated in FIG. 9 are described in greater detail above, a redundant description is omitted.

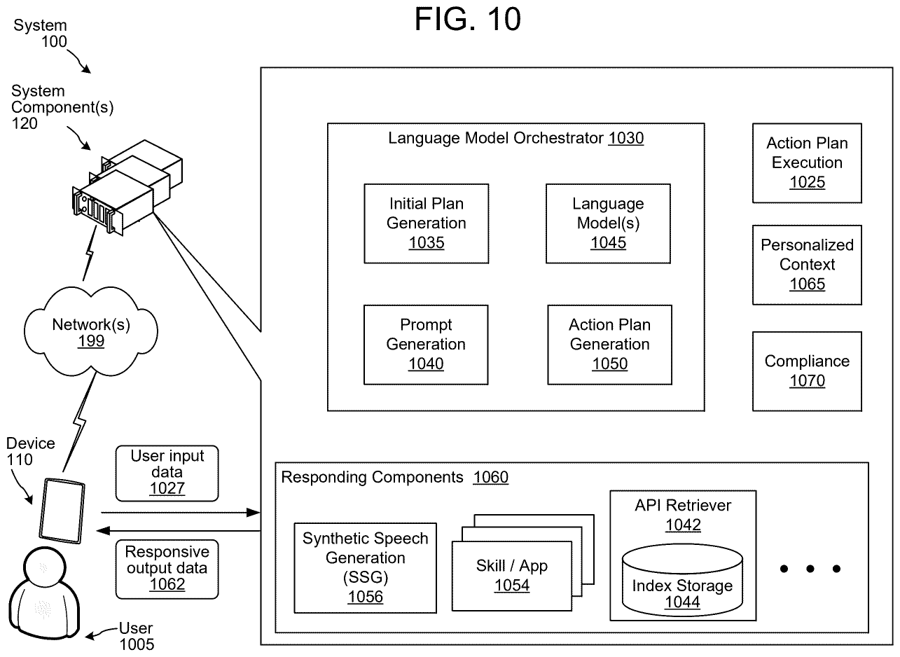

FIG. 10 illustrates further example components included in the system 100 configured to use a language-model based approach to determine an action to be performed in response to a user input and determine a response to be presented to a user 1005. As shown in FIG. 10, the system 100 may include computing device 110, local to the user 1005, in communication with one or more system component(s) 120 via a network(s) 199. The network(s) 199 may include the Internet and/or any other wide- or local-area network, and may include wired, wireless, and/or cellular network hardware.

In some embodiments, the system component(s) 120 may include various components that may support processing by a language model, such as a language model orchestrator component 1030. In example embodiments, the language model orchestrator component 1030 may include an initial plan generation component 1035, a prompt generation component 1040, at least one language model 1045, and an action plan generation component 1050. The system component(s) 120 may further include an action plan execution component 1025 configured to facilitate/cause performance of actions that may be determined by the language model 1045. The system component(s) 120 may further include one or more responding components 1060 that may perform the actions.

The responding components 1060 may be configured to perform an action related to a user input, including, but not limited to retrieving information potentially relevant for determining a response to the user input (e.g., data from a knowledge base, Internet search, database, an application, etc.; context related to the interaction; relevant exemplars for a prompt to the language model; relevant application programming interfaces (APIs); etc.), operating a user device (e.g., a smart home device such as a TV, lights, a kitchen appliance, etc.), determining a synthesized speech output, or other actions described herein. As shown in FIG. 10, the responding components 1060 may include an API retriever component 1042 (further described below), a synthesized speech generation (SSG) component 1056, one or more skill/app components 1054 and other components described herein.

APIs are a way for one program/component to interact with another. API calls are a mechanism by which the program/component interact. An API call, or API command, is a message sent to a system component asking an API to perform an action, provide a service or information, or the like. An API call may be formatted for the particular API and may include a particular command, optionally using particular arguments and argument values. API calls may be used for a variety of purposes, such as controlling other devices (e.g., an API call of turn_on_device (device=“indoor light 1”) corresponds to a command for a component to turn on a device associated with the identifier “indoor light 1”), obtaining information from other components (e.g., an API call of InfoQA.question (“Who is the president of USA?”) corresponds to a command for a component to find and provide an answer to the indicated question), and performing other actions (e.g., generating synthesized speech, searching data sources, etc.). The system 100 may interact with the responding components 1050 via API calls.

The language model orchestrator component 1030 may be configured to orchestrate processing by the language model 1045. In some embodiments, the language model 1045 may be configured to perform one or more stages of processing, which may be referred to as a task generation stage, an action (or directive) generation stage, and a response generation stage.

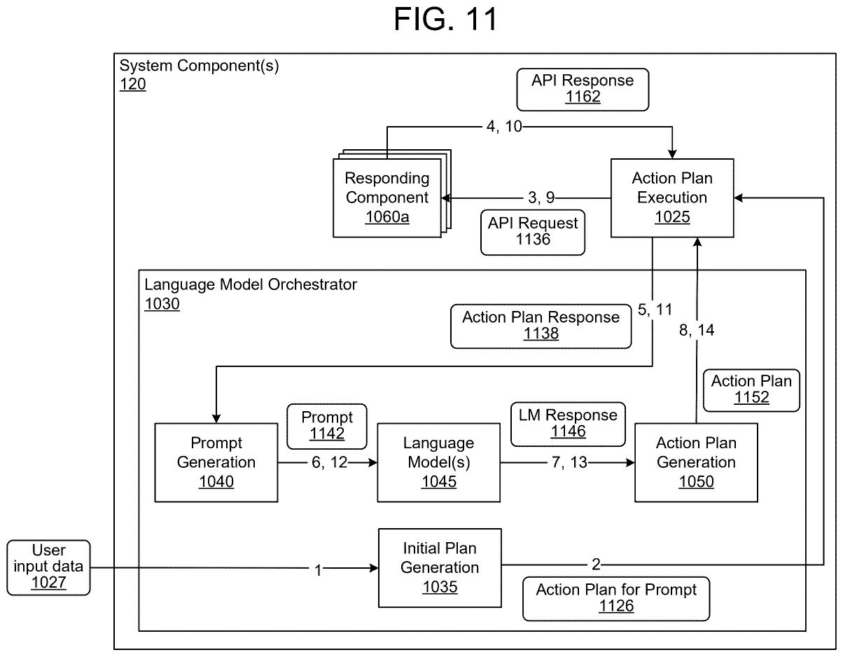

The processing stages may be performed in a particular order. For example, during a first stage of processing, the language model 1045 may be tasked with performing task generation to generate a list of tasks to be performed in order to respond to a user input. During a second stage of processing, based on the list of tasks, the language model 1045 may be tasked with performing action generation to generate action requests (or directives) for a responding component(s) 1060 to perform an action(s) related to the tasks/user input. During a third stage of processing, based on information received from the responding component(s) 1060, the language model 1045 may be tasked with generating a response to the user input and/or causing a component(s) of the system 100 to perform further action(s). Further details are described herein in relation to FIG. 11.

In some cases, a subset of the stages may be performed. For some user inputs, the language model 1045 may only perform the task generation stage and the response generation stage, where a response to a user input is generated by the language model 1045 using parametric knowledge. For example, for a user input “What kind of fruit is lemon?”, the language model 1045 may determine that the task is to answer the user's question and may generate a response “Lemon is a citrus fruit that grows on tress” based on the model's parameter knowledge learned during configuration/training operations. In such examples, the language model 1045 may not determine an action that is to be performed using a system component, such as sending a request for information to a knowledge base (e.g., the language model 1045 may respond without using external knowledge).

In some embodiments, the system may use Retrieval-Augmented Generation (RAG) techniques to inform processing of a language model. RAG techniques may involve referencing an authoritative knowledge base or other type of data source outside of the model's training data sources before generating a response by the model. RAG techniques may extend the already powerful capabilities of language models to specific domains, an organization's internal knowledge base, etc., without the need to retrain the model. In some embodiments, information (e.g., relevant facts, up-to-date information, current/trending topics, etc.) from one or more components (e.g., responding component(s) 1060) may be provided to the language model 1045 and the model may generate a output based on the received information.

In some embodiments, the language model orchestrator component 1030 may be configured to orchestrate processing by multiple different language models, where an individual language model may perform one (or more) of the processing stages described above. For example, a first language model may perform task generation, a second language model may perform action generation, and a third language model may perform response generation. In some embodiments, the language models may be different types of models, for example, a first language model may be a text-to-text generative model, a second language model may be a multi-modal generative model, a third language model may be a text-to-speech generative model, etc. In some embodiments, the language models may be different sizes (e.g., number of parameters), may have different processing capabilities, etc.

Some embodiments may enable use of other components, such as plugins, with the language model 1045, where the plugins may add functionality and features to the language model capabilities. For example, the plugins may be used to perform mathematical calculations (e.g., a calculator plugin), statistical analysis (e.g., a statistics plugin), natural language translation, speech generation, etc. For further example, the plugins may additionally, or alternatively, be used to perform an action responsive to a user input based on the response generated by the language model. As a further example, the plugins may cause the language model to process and output according to an enabled plugin, which may result in a different response, reasoning, processing, etc. from the language model than when the plugin is not enabled. In some cases, a user or a system may enable a plugin(s) for use with the language model.

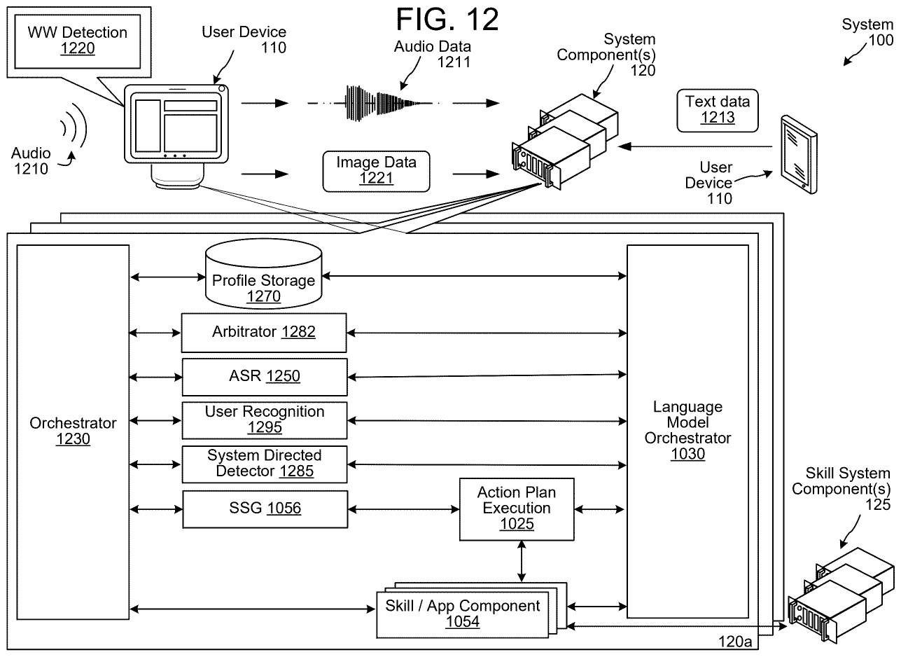

The system component(s) 120 may include other processing components configured to process user inputs and other type of inputs (e.g., sensor data, audio data, data indicative of an event occurring, etc.) received via the user computing device 110. In example embodiments, the system component(s) 120 may process spoken inputs using ASR processing. The system component(s) 120 may also be configured to process non-spoken inputs, such as gestures, textual inputs, selection of GUI elements, selection of device buttons, etc. The system component(s) 120 may also include other components to understand an input, determine an action to be performed in response to receiving the input, generate an output responsive to the input, and the like. Such other components may perform natural language processing, SSG processing, etc., some of which are described herein in relation to FIG. 12.

As shown in FIG. 10, the system component(s) 120 may receive user input data 1027, which may be provided to the language model orchestrator component 1030 (as shown in FIG. 11). In some instances, the user input data 1027 may include one or more types of data, such as text (e.g., a text or tokenized representation of a user input), audio, image, video, etc. Such data may be encoded/embedded data that represent the underlying type of data (e.g., text, audio, image, etc.). For example, the user input data 1027 may include text (or tokenized) data when the user input is a natural language user input. In some embodiments, an ASR component 1250 of the system 100 may receive audio data representing a spoken natural language user input from the user 1005. The ASR component 1250 may perform ASR processing on the audio data to determine ASR data representing the spoken user input, which may correspond to a transcript of the user input. As described herein, with respect to FIG. 12, the ASR component 1250 may determine ASR data that includes an ASR N-best list including multiple ASR hypotheses and corresponding confidence scores representing what the user may have said. The ASR hypotheses may include text data, token data, ASR confidence score, etc. as representing the input utterance. The confidence score of each ASR hypothesis may indicate the ASR component's 1250 level of confidence that the corresponding hypothesis represents what the user said. The ASR component 1250 may also determine token scores corresponding to each token/word of the ASR hypothesis, where the token score indicates the ASR component's 1250 level of confidence that the respective token/word was spoken by the user. The token scores may be identified as an entity score when the corresponding token relates to an entity. In some instances, the user input data 1027 may include a top scoring ASR hypothesis of the ASR data. As an even further example, in some embodiments, the user input may correspond to an actuation of a physical button, data representing selection of a button displayed on a graphical user interface (GUI), image data of a gesture user input, combination of different types of user inputs (e.g., gesture and button actuation), etc. In such embodiments, the system 100 may include one or more components configured to process such user inputs to generate the text or tokenized representation of the user input (e.g., the user input data 1027). As a further example, the user input data 1027 may include image data representing information being displayed at the user device 110 (e.g., on-screen context data) when the user 1005 provides the user input or at substantially the same time as the user 1005 provides the user input. As yet a further example, the user input data 1027 may include audio data representing audio signals (e.g., background noise, audio from other devices such as TV, appliances, etc.) occurring in the environment of the user 1005 that can be captured by the user device 110 (e.g., audio environment context). As yet a further example, the user input data 1027 may include image data representing one or more objects in the environment of the user 1005 (e.g., visual environment context). As yet a further example, the system may receive image data including text (and other data), and the user input data 1027 may include text determined from the image data using optical character recognition or other techniques.

In some embodiments, the system component(s) 120 may receive input data that may not be provided directly/explicitly by a user. Such other type of input data may be processed in a similar manner as the user input data 1027 as described herein. Such other type of input data may be received in response to detection of an event. Example events include change in a device state (e.g., front door opening, garage door closing, TV turned off, thermostat detecting a particular temperature, etc.), occurrence of an acoustic event (e.g., baby crying, appliance beeping, glass breaking, etc.), presence of a user (e.g., a user approaching the user device 110, a user entering the home, etc.), occurrence of an event indicated by a user (e.g., a reminder/notification requested by the user, sporting event score change, start of a TV program, calendar event, etc.), and others. In some embodiments, the system 100 may process the input data and generate a response/output. For example, the input data may be received in response to detection of a user generally or a particular user, an expiration of a timer, a time of day, detection of a change in the weather, a device state change, etc. In some embodiments, the input data may include data corresponding to the event, such as sensor data (e.g., image data, audio data, proximity sensor data, short-range wireless signal data, etc.), a description associated with the timer, the time of day, a description of the change in weather, an indication of the device state that changed, etc. The system 100 may include one or more components configured to process the input data to generate a natural language representation of the input data. The system 100, for example, the language model orchestrator component 1030 may process the input data and may cause performance of an action. For example, in response to detecting a garage door opening, the system 100 may cause garage lights to turn on, living room lights to turn on, etc. As another example, in response to detecting an oven beeping, the system 100 may cause a user device 110 (e.g., a smartphone, a smart speaker, etc.) to present an alert to the user. The language model orchestrator component 1030 may process the input data to generate tasks (e.g., an action plan) that may cause the foregoing example actions to be performed.

FIG. 11 illustrates example processing of the user input data 1027 by the system component(s) 120 using the language model 1045. Although the figure and discussion of the present disclosure illustrate certain components and steps in a particular order, the components may be implemented in a different manner (as well as certain components removed or added) and the steps described may be performed in a different order (as well as certain steps removed or added) without departing from the present disclosure.

In some embodiments, the language model 1045 may perform iterative processing (e.g., multiple processing cycles, multiple processing stages, etc.) with respect to individual user input data 1027. Such iterative processing is illustrated and described herein with respect to FIG. 11. For example, in a first iteration of processing the language model 1045 may receive a first prompt from the prompt generation component 1040, in response to which the language model 1045 may determine one or more tasks to be performed with respect to the user input data 1027, then at least one of the determined task(s) may be performed via the action plan execution component 1025, the results of the performed task(s) may be provided to the language model 1045 via a second prompt, in response to which the language model 1045 may determine further tasks to be performed or may determine that a (final) response to the user input is determined.

The initial plan generation component 1035 may be configured to determine various information relevant to processing of the user input data 1027 by the language model orchestrator component 1030. The initial plan generation component 1035 may generate an action plan (e.g., action plan for prompt data 1126) representing one or more tasks/actions to be performed to determine the various relevant information. The relevant information may be included in a prompt to the language model 1045. The initial plan generation component 1035 may receive (step 1) the user input data 1027 representing a user input from the user 1005. Based on the user input data 1027, the initial plan generation component 1035 may determine information relevant for processing the user input data 1027 and may output (step 2) the action plan for prompt data 1126. The action plan for prompt data 1126 may include one or more tasks to be performed to retrieve the relevant information. The tasks may be represented as action descriptions, API requests/calls, API descriptions, requests to a component(s) (e.g., the responding components 1060), and the like. Examples tasks that may be included in the action plan for prompt data 1126 may relate to obtaining certain information like context data, user profile data, user preferences, available/relevant exemplars, available/relevant APIs, etc.

In example embodiments, the initial plan generation component 1035 may determine one or more types of context data relevant for the user input data 1027. Types of context data may include user context (e.g., user location, user profile identifier, user demographics, user profile data, user preferences, personalized catalogs, enabled skills/applications, etc.), device context (e.g., device type, device identifier, device location (e.g., living room, kitchen, office, etc.), device capabilities, device state, etc.), environmental context (e.g., time/date the past user input was received/processed, device that received the user input, device that responded to the user input, objects proximate to the device/user, background audio/noises, state/status of device(s) in the user's environment (e.g., TV is on, thermostat temperature, etc.), dialog context (e.g., prior user inputs of a dialog, prior system responses of the dialog, dialog topic, actions performed during the dialog, etc.), and the like. As an example, if the user input data 1027 corresponds to operation of a device (e.g., the user input corresponds to a smart home domain), the initial plan generation component 1035 may determine that device context information, in particular device states for the devices associated with the user/user profile of the user 1005, may be relevant information. As another example, if the user input data 1027 corresponds to output of media, such as music, movies, TV shows, etc., the initial plan generation component 1035 may determine that user context information, in particular user preference for media genre associated with the user/user profile of the user 1005, may be relevant information.

Based on the type of context data determined to be relevant, the initial plan generation component 1035 may output the action plan for prompt data 1126 to include a request for the type(s) of context data. For example, if device context is relevant information, then the action plan for prompt data 1126 may include an API call/description corresponding to a component (e.g., a device state component, a smart home component, a user profile storage, etc.) capable of providing device information. As another example, if user context is relevant information, then the action plan for prompt data 1126 may include an API call/description corresponding to a component (e.g., a user profile storage, a personalized context component, etc.) capable of providing user information.

In some embodiments, the initial plan generation component 1035 may determine one or more components or types of components that may be relevant for processing the user input data 1027. As an example, if the user input data 1027 corresponds to operation of a device (e.g., the user input corresponds to a smart home domain), the initial plan generation component 1035 may determine that components (e.g., APIs) corresponding to device operation or smart home domain may be relevant, and the initial plan generation component 1035 may output the action plan for prompt data 1126 to include device operation components or smart home domain components. As another example, if the user input data 1027 corresponds to output of media, the initial plan generation component 1035 may determine components corresponding to media output or music domain may be relevant, and the initial plan generation component 1035 may output the action plan for prompt data 1126 to include media output components or music domain components.

In some embodiments, the initial plan generation component 1035 may determine a query to retrieve exemplars and/or APIs relevant for processing the user input data 1027 using the language model 1045. As used herein, an exemplar refers to information that may be included in a prompt to a language model that provides an example of how the language model is to process or respond, including, among other things, what actions the language model can request performance of. A prompt may include more than one exemplar. Few shot learning or in-context learning by the language model is enabled by including the exemplars in the prompt. The query (or request) to retrieve relevant exemplars and/or APIs may be included in the action plan for prompt data 1126. The query (or an API request based on the query) may be processed by the responding component 1060 (e.g., an exemplar retriever component, the API retriever component 1042, etc.). The query, in some embodiments, may include the user input data 1027 or a portion or representation thereof.

The initial plan generation component 1035 may employ one or more techniques to determine relevant information or to determine the tasks to obtain relevant information. Examples of such techniques include using one or more of machine learning models (e.g., classifiers), statistical models, rules engines, etc. to determine the relevant information. The initial plan generation component 1035 may determine a topic/category corresponding to the user input data 1027, a (semantically or lexically) similar past user input and relevant information corresponding to the similar past user input, and the like.

In example embodiments, the initial plan generation component 1035 may use a language model to determine the types of information relevant for processing the user input data 1027. The initial plan generation component 1035 may input a prompt to the language model, for example, “What types of information is relevant for responding to the user input: [user input data 1027]”, and the language model may output one or more types of context data, one or more types of components, etc. that may be relevant. In some embodiments, the initial plan generation component 1035 may input a prompt to the language model 1045 requesting relevant information for the user input data 1027.

The action plan for prompt data 1126, which includes types of relevant information for the user input data 1027 or tasks to be performed to obtain the relevant information, may be processed by the action plan execution component 1025 to retrieve the relevant information. The action plan execution component 1025 may process the action plan for prompt data 1126 to generate one or more requests to perform an action (e.g., API requests 1136) for a particular responding component 1060. For example, if the action plan for prompt data 1126 indicates that device information/context is relevant, then the action plan execution component 1025 may generate an API request 1136 for a responding component 1060a capable of providing the device information, where the API request 1136 may include a user profile identifier associated with the user 1005, a device identifier associated with the user device 110, and/or other information based on information required in the API call for the responding component 1060a.

The API request 1136 may be sent (step 3) to the corresponding responding component(s) 1060. The responding component(s) 1060 may include components that the action plan execution component 1025 may communicate with via API requests or other type requests. As shown in FIG. 10, the responding component(s) 1060 may include one or more skill/app components 1054, the SSG component 1056 (e.g., configured to convert input data to audio data representing synthesized speech), and the API retriever component 1042 (e.g., configured to provide APIs and corresponding information supported by the system 100). The responding component(s) 1060 may also include an orchestrator component 1230 (e.g., configured to facilitate processing by other system components 120 such as those shown in FIG. 12), a context source component (e.g., configured to provide user context data, device context data, environmental context data, dialog context data, personalized context data, etc.), a multimodal response component (e.g., configured to respond to a user input via outputs in more than one data form), a content moderation component (e.g., configured to moderate certain types of content such as biased content, harmful content, offensive content, etc.), a smart home devices component (e.g., configured to provide device information such as device state, device capabilities, etc.), a language model-based agent (e.g., a component that uses a language model (e.g., a LLM) or other type of generative model to provide information), an exemplar provider component (e.g., configured to respond to a query for relevant exemplars), a knowledge base component (e.g., including one or more knowledge bases or other structured data that can be searched to obtain information), an entity resolution component (e.g., configured to determine specific entities corresponding to entities represented in a user input or language model output), and the like.

In response to receiving the API request 1136 (at step 3), the responding component(s) 1060 may provide (step 4) an API response(s) 1162 to the action plan execution component 1025. At step 3, the API request(s) 1136 is based on the action plan for prompt data 1126, and thus, at step 4, the API response(s) 1162 may include information relevant for processing the user input data 1027. In examples, the API response(s) 1162 may include relevant context information (e.g., device context, user context, environment context, dialog context, personalized context, etc.), relevant APIs and/or API descriptions for processing the user input data (e.g., API(s) for operating devices, API(s) for outputting media content, etc.), relevant exemplars, and other relevant information requested via the action plan for prompt data 1126.

In example embodiments, the API request 1136 may be sent to the API retriever component 1042. In such cases, the API request 1136 may include a query to retrieve relevant APIs based on the user input data 1027. The API retriever component 1042 may be configured to receive a search query and output one or more APIs or API data corresponding to (e.g., satisfying, matching, etc.) the search query. API data may include an API call, an API description, and other information associated with the API. In some embodiments, the API retriever component 1042 may include or may be in communication with an index storage 1044 (shown in FIG. 10). The index storage 1044 may store various information associated with multiple APIs. Examples of information stored in the index storage 1044 include: API/component descriptions (e.g., a description of one or more function that the API can be used to perform), API arguments (e.g., parameter inputs, input types, examples of input values, examples of output values, output type, etc.), identifiers for components corresponding to the API (e.g., alphanumerical component ID, component name, etc.), and other information. In some embodiments, the index storage 1044 may include other information associated with the API, such as historical accuracy/defect rate, historical latency value, feedback (e.g., user satisfaction/feedback, system-based feedback), etc. The index storage 1044 may also include sample user inputs corresponding to the API, where the sample user input may represent a user input for which the API can perform an action for.

The API retriever component 1042 may apply one or more retrieval techniques to determine API data corresponding to the search query. For example, the API retriever component 1042 may compare one or more APIs included/represented in the index storage 1044 to the user input data 1027 represented in the search query to determine one or more APIs (top-k list). Such comparison may involve a semantic comparison between the user input data 1027 and the API data. In some embodiments, the API retriever component 1042 may use a neural-based retrieval technique that may involve determining an encoded representation of the user input/search query and comparing (e.g., using cosine distance) the encoded representation(s) of the API data in the index storage 1044. The relevant APIs may be included in the API response 1162.

In a non-limiting example, for a user input “book a flight”, the API retriever component 1042 may determine one or more API calls corresponding to booking a flight (e.g., Bookflight.location (“departing airport code”, “arrival airport code”), Bookflight.date (“departing date”), bookflight.rountrip (“departing location”, “arrival location”, “departure date”, “return date”), AirlineBookFlight (“departing airport code”, “arrival airport code”), etc.).

Some embodiments may include an exemplar provider component that may operate in a similar manner as the API retriever component 1042 in terms of implementing one or more retrieval techniques to determine exemplars corresponding to (e.g., satisfying, matching, etc.) a search query based on the user input data 1027. The exemplar provider component may search an index storage including various information related to multiple different exemplars. In some embodiments, the index storage may include sample user inputs associated with an exemplar, and the relevant exemplars may be retrieved based on a comparison of the sample user inputs and the user input data 1027. The retrieved exemplars may be included in the API response 1162.

The information from the API response(s) 1162 may be included in a prompt to the language model 1045. The action plan execution component 1025 may determine action plan response data 1138 based on the API response(s) 1162. The action plan execution component 1025 may combine (e.g., aggregate, summarize, de-duplicate, etc.) multiple API responses 1162 to generate the action plan response data 1138. In some examples, the action plan response data 1138 may be the same or similar to the API response(s) 1162. The action plan execution component 1025 may send (step 5) the action plan response data 1138 to the prompt generation component 1040.

Using the action plan response data 1138, the prompt generation component 1040 may determine prompt 1142 for the language model 1045. The prompt 1142 may be a natural language input (e.g., a natural language request, a natural language instruction, etc.). In some embodiments, the prompt 1142 may include information in a manner that the language model 1045 is trained for. The prompt generation component 1040 may send (step 6) the prompt 1142 to the language model 1045, where the prompt 1142 may include the user input data 1027 (or a representation of the user input data 1027) and the relevant information for processing the user input data 1027. For example, the prompt 1142 (at step 6) may include relevant context data, relevant APIs or API descriptions, etc. that may be included in the action plan response data 1138. In some embodiments, the prompt 1142 may include a request or directive for the language model 1045 to respond to the user input data 1027. In some embodiments, the prompt 1142 may include one or more exemplars (e.g., in-context learning examples) for processing the user input data 1027.

The prompt 1142 may include indicators (e.g., labels, specific tokens, etc.) to identify certain information. In example embodiments, the prompt 1142 may include a “User” indicator (to indicate that the following string of characters/tokens are the user input), an “Exemplar” indicator (to indicate exemplars), and so on.

In some embodiments, the prompts for the language model described herein may include a request for the language model to output a response that satisfies certain conditions. Such conditions may relate to generating a response that is unbiased (toward protected classes, such as gender, race, age, etc.), non-harmful, profanity-free, etc. For example, prompt data generated by a prompt generation component described herein may include “Please generate a polite, respectful, and safe response and one that does not violate protected class policy.”

In some embodiments, the prompt 1142 may include an indication the processing stages (e.g., the task generation stage, the action generation stage, and the response generation stage) that the language model 1045 is to perform. In some examples, for the task generation stage, the prompt 1142 may direct the language model 1045 to generate an output (e.g., tokens) representing the model's interpretation of the user input and/or one or more tasks to be performed to respond to the user input (the model output may be, for example, the user is requesting [intent of the user input], the user wants to [desired user action], need to determine [information needed to properly process the user input], etc.). For the task generation stage, the prompt 1142 may also direct the language model 1045 to prioritize a list of tasks to be performed, if more than one task is to be performed and select one (or more) task for the current iteration of processing.

In some examples, for the action generation stage, the prompt 1142 may direct the language model 1045 to generate an output (e.g. tokens) representing an action(s) (or directive(s)) and/or an API call(s) corresponding to the user input, where performance of the action(s) or execution of the API(s) can be done to retrieve information to determine a response to the user's input, perform the user requested action, retrieve information/data to perform other tasks on the task list, etc. In some examples, for the action generation stage, the prompt 1142 may direct the language model 1045 to process the results of the action(s)/API(s) determined by the language model 1045, and to determine whether a response to the user input can be generated or whether there are further tasks to be performed from the task list.

In some examples, for the response generation stage, the prompt 1142 may direct the language model 1045 to generate an output (e.g., tokens) representing a response (e.g., a final response) to the user input data 1027. In examples, the language model 1045 may be directed to generate the response based on the results of performing the action(s)/API(s).

The prompt generation component 1040 may send (step 6) the prompt 1142 to the language model 1045, which may process the prompt 1142 to generate a language model (LM) response 1146. The LM response 1146 may be a natural language output generated based on the prompt 1142. The LM response 1146 may include text tokens. In other embodiments, where the language model 1045 may be a multi-modal model, the LM response 1146 may include other types of tokens, for example, audio tokens, image tokens, etc.

Based on receiving the prompt 1142 at step 6, the language model 1045 may generate the LM response 1146 at step 7, where the instant LM response 1146 may include outputs corresponding to the task generation stage and the action generation stage. The LM response 1146 may include an action for determining information relevant to or responsive to the user input data 1027. For example, the LM response 1146 may include an action to search a knowledge base (e.g., to find a response to a user question), an action to determine information from a particular skill/app or language model-based agent (e.g., to determine current weather information, to determine a cost of an item, to book travel, etc.), an action to operate a device (e.g., turn on lights, set thermostat to a particular temperature, etc.), an action to request information from the user 1005, etc.

In some embodiments, the LM response 1146 may include an API or API description corresponding to the determined action. For example, the LM response 1146 may include an API to operate a device or an API call(s) to output media content. The language model 1045 may determine the actions and/or the API information based on the relevant APIs included in the prompt 1142. The language model 1045 may generate actions and/or API information that is not based on (e.g., correspond to, is similar to, etc.) the relevant APIs included in the prompt 1142 (for example, the language model 1045 may generate incorrect/unsupported actions and/or API information).

The LM response 1146 may follow the format included in the prompt 1142 or that the language model 1045 is trained to follow. An example prompt 1142 may be:

```
  {
  Please process the following user input and context data to determine at
least one action or API to execute and generate a response to the user.
  First determine a task to perform (use “Task” label), then determine an
API to perform the task (use “Action” label), then process the results from
the API, and then generate a response to the user input (use “Response”
label). You may determine multiple tasks to perform. You may
have to process iteratively.
  User: Turn on living room TV
  Available context:
  User devices: “living room TV” = [device id]
  “living room TV” device state = Off
  Available APIs:
  TurnOn.device (device)
  TurnVolumeUp.device (device)
  SetTVChannel (device, input channel)
  }
```

Based on processing the above example prompt 1142, an example LM response 1146 (at step 7) may be:

{
Task: User wants to turn on living room TV that is operation of a user
device.
Action: I need an API to operate a device. TurnOn.device (device =
“living room TV”)
}

The LM response 1146 may be sent (step 7) to the action plan generation component 1050, which may determine action plan data 1152. As described herein, the language model 1045 may generate tokens in sequence, as such, the language model 1045 may generate portions of the LM response 1146 in a tokens-by-tokens basis. In some embodiments, the LM response 1146 may be processed by the action plan generation component 1050 based on the language model 1045 generating the tokens representing the action or corresponding to the action generation stage.

The action plan generation component 1050 may process the LM response 1146 to identify one or more actions/APIs generated by the language model 1045. In examples, the action plan generation component 1050 may parse the tokens/text included in the LM response 1146 to extract tokens/text representing an action or API. In some embodiments, the action plan generation component 1050 may be configured to determine one or more components (e.g., responding components 1060a-n) configured to perform the identified action or API. Based on the LM response 1146, the action plan generation component 1050 may determine the action plan data 1152, which may in turn cause performance of an action (e.g., execution of API calls) to determine a potential responses(s) to the user input. The action plan data 1152 may include one or more APIs to be executed, where the APIs may be determined based on (e.g., extracted from) the LM response 1146. For example, if the LM response 1146 includes an action of “determine weather forecast for today” or an API call of “GetWeather.location ([city])”, then the action plan generation component 1050 may determine the action plan data 1152 to include an API call “GetWeather.location ([city])” and include an identifier for the responding component(s) 1060a (e.g., a weather skill component). Instead of or in addition to an API call, the action plan data 1152 may include a request to perform an action, an API description, etc. In some embodiments, the action plan generation component 1050 may determine the responding components 1060 based on user permissions, subscriptions, authorization or other use-enabling information associated with the user 1005 (e.g., included in user profile data).

In some embodiments, the action plan generation component 1050 may be configured to determine more than one responding component 1060 to perform the action/execute the API indicated in the LM response 1146. In some embodiments, the action plan generation component 1050 may determine APIs corresponding to multiple responding components 1060. For example, for the “GetWeather.location ([city])” API, the action plan data 1152 may include an identifier for a first weather skill component, an identifier for a second weather skill component, an identifier for a search engine component, etc.

The action plan data 1152 may be sent (step 8) to the action plan execution component 1025. The action plan execution component 1025 may identify the APIs in the action plan data 1152 and generate executable API calls for the corresponding responding components 1060. Based on the action plan data (received at step 8), the action plan execution component 1025 may generate an additional (a second) API request (or multiple API requests) 1136. The (additional/second) API request(s) 1136 may be sent (step 9) to the responding component(s) 1060. For example, the action plan execution component 1025 may send a first API call to a first responding component 1060a and a second API call to a second responding component 1060b.

In some cases, the action plan data 1152 may include incomplete API calls and the action plan execution component 1025 may be configured to generate executable API calls (e.g., complete API calls) corresponding to the action plan data 1152.

The action plan execution component 1025 may generate one or more executable API calls including one or more parameters using information included in the action plan data 1152 and/or various other contextual information (e.g., speaker recognition results, a user ID, user profile information (e.g., age, gender, location, language, geographic marketplace, etc.), device ID, device profile information, device state indicators, a dialog history, and/or a interaction history associated with the user and/or the device, etc.). In some embodiments, the various contextual information may be contextual information not provided to the language model orchestrator component 1030. Prior to generating the executable commands, the action plan execution component 1025 may modify (e.g., remove, filter, preempt, etc.) a directive included in the action plan data 1152 that is determined to be in conflict with a system operating policy. The action plan execution component 1025 may generate one or more additional executable commands corresponding to directives not included in the action plan data 1152.

In response to receiving the API request(s) 1136 (at step 9), the responding component(s) 1060 may send (step 10) an (additional/second) API response(s) 1162 to the action plan execution component 1025. The action plan execution component 1025 may determine (additional/second) action plan response data 1138 based on the (additional/second) API response(s) 1162. The action plan execution component 1025 may combine (e.g., aggregate, summarize, de-duplicate, etc.) multiple API responses 1162 to generate the action plan response data 1138. In some examples, the action plan response data 1138 may be the same or similar to the API response(s) 1162. In some examples, the action plan response data 1138 may include an identifier associated with the responding component 1060 that provided the API response 1162. For example, the (additional/second) action plan response data 1138 may include first weather information from a first weather skill component, second weather information from a second weather skill component, third weather information from a search engine component, etc. In some embodiments, the action plan execution component 1025 may remove/filter information from the API response 1162 that is determined to include information not beneficial to the processing by the language model 1045.

The action plan execution component 1025 may send (step 11) the (additional/second) action plan response data 1138 to the prompt generation component 1040. The information from the API response(s) 1162 may be included, by the prompt generation component 1040, in a (additional/second) prompt to the language model 1045. The prompt generation component 1040 may generate the second prompt 1142 to include the action plan response data 1138 or a representation thereof. The second prompt 1142 may also include information from the prior/first prompt (from step 6). For example, the second prompt 1142 may include the user input data 1027 (or a representation thereof), the relevant information for processing the user input data 1027 (e.g., relevant context data, relevant API information, relevant exemplars, etc.), the processing stages information, and the action plan response data 1138 (from step 11). In some embodiments, the second prompt 1142 may also include at least a portion of the LM response 1146 generated during a prior iteration of processing (e.g., the outputs based on performing the task generation stage and the action generation stage) to indicate actions/results of the prior iteration of processing by the language model 1045. The second prompt 1142 may include an indicator (e.g., label, identifier, etc.) associated with the action plan response data 1138 to indicate, to the language model 1045, that the string of characters/tokens following the indicator represent information determined based on performance of the actions determined during the action generation stage.

The second prompt 1142 may be sent (step 12) to the language model 1045 for processing. At this point, the language model 1045 may perform the action generation stage of processing the results of the performed actions, which may involve interpreting or understanding the results included in the action plan response data 1138. The language model 1045 may generate (step 13) a (additional/second) LM response 1146 based on the second prompt 1142. The second prompt 1142 may include a request or directive to the language model 1045 to perform further processing with respect to the user input data 1027. As described above, the second prompt 1142 may provide, among other things, responses/results of performance of the action determined by the language model 1045 determined during the prior iteration of processing. The language model 1045 may generate further actions to be performed to respond to the user input data 1027 (as part of the action generation stage) or may generate a (final/user-facing) response to the user input data 1027 (as part of the response generation stage).

An example second prompt 1142 may be:

```
  {
  Please process the following user input and context data to determine at
least one action or API to execute and generate a response to the user.
    First determine a task to perform (use “Task” label), then determine
an API to perform the task (use “Action” label), then process the results
from the API, and then generate a response to the user input (use
“Response” label). You may determine multiple tasks to perform.
You may have to process iteratively.
  User: Turn on living room TV
  Available context:
    User devices: “living room TV” = [device id]
    “living room TV” device state = Off
  Available APIs:
    TurnOn.device (device)
    Turn VolumeUp.device (device)
    SetTVChannel (device, input channel)
  Prior Iteration:
    Action: TurnOn.device (device = “living room TV”)
  TurnOn.device (device = “living room TV”); API response: “living
room TV” device state = ON
}
```

Based on the above example prompt 1142, an example LM response 1146 may be:

{
Task: User wants to turn on living room TV that is operation of a user
device.
Action: I need an API to operate a device. TurnOn.device (device =
“living room TV”)
Action result is “living room TV” device state = ON
Response: The living room TV is on now. Can I help you with anything
else?
}

As described herein, the language model 1045 may generate the LM response 1146 on tokens-by-tokens basis. As such, in some examples, the second LM response 1146 may include additional tokens (e.g., newly generated tokens) to the first LM response 1146 (from step 7). In other examples, the second LM response 1146 may include different tokens than the first LM response 1146, where the currently generated tokens may represent outputs for further steps of the action generation stage and/or the response generation stage.

The language model 1045 may determine further actions/APIs to be performed in a similar manner as described above. Such further actions/APIs may be based on any tasks, included in the task list generated during the task generation stage, that are still to be performed (e.g., a first task of booking a flight may be done, now a second task of booking a hotel is to be performed). Additionally or alternatively, the further actions/APIs may be based on the results included in the action plan response data 1138 (at step 11) (e.g., an API response from a responding component 1060 may indicate that additional information is needed to perform an action).

The language model 1045 may determine a (final) response to the user input, where the response is to be presented to the user 1005 via the user device 110. In other cases, the response may be presented via another user device 110 associated with the user 1005. The language model 1045 may determine the final response based on the results included in the action plan response data 1138 (from step 11). For example, the language model 1045 may summarize the results, may combine the results, may generate an interpretation of the results, etc. In a non-limiting example, the language model 1045 may combine weather information from two or more responding components (e.g., combine high/low temperature information from a first responding component with humidity information from a second responding component). In another non-limiting example, the language model 1045 may interpret results from a knowledge base component to determine a response to the specific user query (e.g., from a biographical search result for a historical person, a birthplace and siblings information may be extracted to determine a response to a user query “tell me about [person's] childhood”).

In some examples, the language model 1045 may generate the further action to be performed is requesting additional information from the user 1005. Such further action, in some embodiments, may be labeled as “Response” so that the action plan generation component 1050 may cause a request to be output to the user 1005.

The second LM response 1146 may be sent (step 13) to the action plan generation component 1050, which may determine (step 14) the (additional/second) action plan data 1152. In some examples, the second LM response 1146 sent to the action plan generation component 1050 may include further action(s)/API(s) to be executed, which may be labeled with “Action.” In some examples, the second LM response 1146 may include a final response to the user input, which may be labeled with “Response.”

Based on the tokens corresponding to the “Action” label, the action plan generation component 1050 may determine the action plan data 1152 to include one or more actions, one or more API calls and/or one or more responding components 1060 corresponding to the action(s)/API(s) determined by the language model 1045.

Based on the tokens corresponding to the “Response” label, the action plan generation component 1050 may determine the action plan data 1152 to include one or more actions, one or more API calls and/or one or more responding components 1060 to present the output tokens to the user 1005 as a response to the user input. For example, the action plan data 1152 may include an identifier for the SSG component 1056 to cause the output tokens, generated by the language model 1045, to be presented as synthesized speech. As another example, the action plan data 1152 may include an identifier for the responding component 1060 capable of generating outputs in more than one form (e.g., a multi-modal output component) to cause the tokens to be presented as synthesized speech, displayed text/graphics, and/or other types of outputs.

The (second) action plan data 1152 may be sent (step 14) to the action plan execution component 1025, and as described herein, the action plan execution component 1025 may determine executable API calls based on the action plan data 1152. If the action plan data 1152 represents additional actions to be performed, then the action plan execution component 1025 may cause the corresponding responding component(s) 1060 to perform the additional action(s) and corresponding response(s) (e.g., API responses 1162) may be communicated to the prompt generation component 1040 (via the action plan execution component 1025 and action plan response data 1138) to initiate another iteration of processing by the language model 1045 with respect to the user input data 1027. If the action plan data 1152 represents a response to be presented to the user 1005, then the action plan execution component 1025 may cause the corresponding responding component(s) 1060 to determine output data (e.g., responsive output data 1062 shown in FIG. 10) that may be presented via the user device 110. For example, the responsive output data 1062 may be sent to the user device 110 via the orchestrator component 1230 or another system component(s) 120 (described in relation to FIG. 12).

In some embodiments, when further actions are generated by the language model 1045 to be performed with respect to the user input data 1027, the language model orchestrator component 1030 may perform another iteration of processing, which may involve generating another prompt 1142 to the language model 1045, generating another LM response 1146 that may be used to determine further action plan data 1152. The language model 1045 may generate tokens corresponding to the action generation stage and/or the response generation stage during the further iteration.

In some embodiments, when a final response is generated by the language model 1045, further processing with respect to the user input data 1027 by the language model orchestrator component 1030 may be ceased (e.g., processing with respect to the user input data 1027 by the language model orchestrator component 1030 may be complete). The language model orchestrator component 1030 may process with respect to a subsequently received user input, which may or may not be part of the same dialog session as the prior/already processed user input data 1027.

The responsive output data 1062 may include one or more of output audio data representing synthesized speech, text data for display, image for display, graphics/icons for display, media (e.g., video, music, background music, notification sounds, etc.) for playback, and other data. In some embodiments, the responsive output data 1062 may include placement information representing where (e.g., top banner, left portion, center of screen, overlay on current visual, etc.) on the display screen of the user device 110 the output data is to be displayed. In some embodiments, the responsive output data 1062 may be determined/provided by the responding component 1060. In some embodiments, another system component 120 may process the responsive output data 1062 prior to sending to the user device 110 to ensure that the responsive output data is formatted for the particular user device 110.

Referring again to FIG. 10, as shown, the system component(s) 120 may include a compliance component 1070. In some embodiments, the compliance component 1070 may be included in the language model orchestrator component 1030. In other embodiments, the compliance component 1070 may be one of the responding components 1060 and the action plan generation component 1050 may cause the action plan execution component 1025 to send an API request to the compliance component 1070 when processing by the compliance component 1070 is to be performed.

The compliance component 1070 may be configured to determine whether an output of the language model 1045 is appropriate for output to the user 1005. In some embodiments, the compliance component 1070 may be configured to process language model output (e.g., the LM response 1146) representing outputs/tokens generated by the language model 1045 during processing of the user input data 1027. The model output may include tokens generated during the task generation stage, the action generation stage or the response generation stage. The compliance component 1025 may also or instead determine whether an input to the language model 1045 (e.g., a user request, an output of another system component of the system 100) is appropriate and/or that the input will result in the language model 1045 generating an output that is appropriate to present to the user 1005. For this determination, the compliance component 1070 may process the user input data 1027 or a portion or representation thereof. In some embodiments, the compliance component 1070 may process other data (e.g., context data, user profile data, system configuration/policy data, etc.) to determine whether the generated response and/or the input is appropriate.

In some embodiments, the compliance component 1070 may determine whether the model output/LM response 1146 and/or the user input data 1027 corresponds to training data used to configure the language model 1045 (e.g., the model output or user input is semantically or lexically similar to the training data, the model output or user input corresponds to functionality (e.g., topics, categories, actions, etc.) that the model is trained for, etc.). Additionally or alternatively, the compliance component 1070 may determine whether the model output/LM response 1146 and/or the user input data 1027 corresponds to one or more words or phrases determined to be confidential, sensitive, or offensive. Additionally or alternatively, the compliance component 1070 may determine whether the user input or the model output corresponds to an inappropriate content category, which may include biased content (e.g., biased toward protected classes including gender, race, age, etc.), harmful content (e.g., violent content, self-harm, etc.), profanity, etc.

In some embodiments, the compliance component 1070 may use one or more techniques to determine whether the model output or the user input is appropriate; such techniques may include a rules-engine, a word-based similarity determination, a machine learning model based determination (e.g., using a classifier to classify model output or user input to appropriate category or inappropriate category), etc.

In some embodiments, the compliance component 1070 may process the user input data 1027 when it is received by the language model orchestrator component 1030 and in some cases may process in parallel to the language model orchestrator component 1030. In some embodiments, the compliance component 1070 may process the model output as the language model 1045 generates the output tokens. In other embodiments, the compliance component 1070 may process the model output after the language model 1045 has generated tokens for a particular processing stage (e.g., after the task generation stage is completed, after the action generation stage is completed, after the response generation stage is completed, etc.).

If the compliance component 1070 determines that the model output or the user input data 1027 is appropriate, then the language model orchestrator component 1030 may continue processing with respect to the user input data 1027. If the compliance component 1070 determines that the model output is not appropriate, then one or more remedial actions may be performed. One example remedial action may involve prompting the language model 1045 to generate a new/modified model output. In such examples, additional prompt data may be determined, which may include the original prompt data, the initial model output, and an indication that the initial model output is not appropriate for output to the user 1005. The additional prompt data may include a request or directive to the language model 1045 to generate model output that is appropriate for output to the user 1005. Another example remedial action may involve the system outputting a generic/template response (e.g., “Sorry, I can't help you with that” or “I cannot answer questions for [inappropriate category])”) or a request for a rephrased input (e.g., “can you rephrase that”).

In some embodiments, the compliance component 1070 may cause the system to output a response indicating where (e.g., a source external to the system components 120) the included/outputted information may be found. For example, the response may include an indication of a source of the training data or the data (e.g., API response 1162) that the response is based on (e.g., the indication may include a description of an owner of the intellectual property rights corresponding to the training data/the response information, a hyperlink to the source, etc.). In some embodiments the compliance component 1070 may determine that the model generated response is based on (e.g., summarizing, using, similar to, etc.) data that protected by intellectual property rights (or other laws), and instead of outputting the language model generated response (e.g., LM response 1146). In some embodiments the responsive output data 1062 may include an indication of the intellectual property rights owner, may include access to a source of the data (e.g., website link), or may include a template response (e.g., “I cannot process this request” or “The requested data is protected by intellectual property rights”, etc.). In some embodiments, the compliance component 1070 may determine that the user input data 1027 involves processing data or outputting data that is protected by certain intellectual property rights (or other laws). An example of such a user input may be “write a story about [protected character]” or “draw an image of [protected character] doing [some action]”, where the owner of intellectual property rights in the [protected character] may not allow use, copying, or other operations. In response, the system may cease or prevent processing by the language model orchestrator component 1030 of the user input data 1027, and the system may output a template response (e.g., “I cannot process this request” or “The requested data is protected by intellectual property rights”, etc.).

As shown in FIG. 10, the system component(s) 120 may include a personalized context component 1065. In some embodiments, the personalized context component 1065 may be included in the language model orchestrator component 1030. In other embodiments, the personalized context component 1065 may be one of the responding components 1060 and the action plan generation component 1050 may cause the action plan execution component 1025 to send an API request to the personalized context component 1065.

The personalized context component 1065 may be configured to determine personalized context data including context data corresponding to the user input data 1027 and/or the user 1005.

In some embodiments, the initial plan generation component 1035 may request personalized context data to include in the prompt 1142. In other embodiments, other system component(s) 120, such as the language model 1045, may request personalized context data (e.g., to determine a personalized response to a user input). The personalized context data may include user preferences, past user inputs, past system outputs for past user inputs from the user 1005, past skill/app usage, user-defined items, etc. The personalized context component 1065 may infer user preferences from user-provided preferences, past user interactions by the user 1005, information related to users similar to the user 1005, etc. In some embodiments, the personalized context component 1065 may employ one or more techniques to determine the personalized context data; such techniques may include using a rules-engine, using one or more machine learning models (including a generative model), topic determination techniques, neural retrieval search techniques, etc.

In examples, the personalized context component 1065 may receive the user input data 1027, task data representing a current task being performed/processed, and/or model output indicating that an ambiguity exists or additional information is needed to generate a response to the user input. The personalized context component 1065 may receive a query in some examples, which may include an identifier for the user 1005. In a non-limiting example, the personalized context component 1065 may receive the following example requests: “Does the user prefer to use [Music Service 1] or [Music Service 2] for playing music,” or “What kind of music does the user like?” The personalized context component 1065 determine example personalized context data including “The user prefers [Music Service 1]” or “The user likes [music genre]”).

Further information related to the SSG component 1056 and the skill/app component 1054 is described herein in relation to FIG. 12.

In some embodiments, the language model 1045 may be fine-tuned to perform a particular task(s). Fine-tuning of the language model(s) may be performed using one or more techniques. One example fine-tuning technique is transfer learning that involves reusing a pre-trained model's weights and architecture for a new task. The pre-trained model may be trained on a large, general dataset, and the transfer learning approach allows for efficient and effective adaptation to specific tasks. Another example fine-tuning technique is sequential fine-tuning where a pre-trained model is fine-tuned on multiple related tasks sequentially. This allows the model to learn more nuanced and complex language patterns across different tasks, leading to better generalization and performance. Yet another fine-tuning technique is task-specific fine-tuning where the pre-trained model is fine-tuned on a specific task using a task-specific dataset. Yet another fine-tuning technique is multi-task learning where the pre-trained model is fine-tuned on multiple tasks simultaneously. This approach enables the model to learn and leverage the shared representations across different tasks, leading to better generalization and performance. Yet another fine-tuning technique is adapter training that involves training lightweight modules that are plugged into the pre-trained model, allowing for fine-tuning on a specific task without affecting the original model's performance on other tasks. Some techniques may involve supervised fine-tuning (SFT), unsupervised fine-tuning, semi-supervised fine-tuning, or other types of learning.

In some embodiments, one or more of the system components 120 described herein may be configured to begin processing with respect to data as soon as the data or a portion of the data is available to the components (e.g., processing in a streaming fashion). Some system components may be generative components/models that can begin processing with respect to portions of data as they are available, instead of waiting to initiate processing after the entirety of data is available. For example, the language model 1045 may start processing a first portion of the prompt 1142 while the prompt generation component 1035 determines a second/subsequent portion of the prompt 1142. As another example, the action plan generation component 1050 may start processing a first portion of the LM response 1146 while the language model 1045 is generating a second/subsequent portion of the LM response 1146.

The system 100 may operate using various components as described in FIG. 12. The various components may be located on same or different physical devices. Communication between various components may occur directly or across a network(s) 199. The user device 110 may include audio capture component(s), such as a microphone or array of microphones of a user device 110, captures audio 1210 and creates corresponding audio data. Once speech is detected in audio data representing the audio 1210, the user device 110 may determine if the speech is directed at the user device 110/system component(s). In at least some embodiments, such determination may be made using a wakeword detection component 1220. The wakeword detection component 1220 may be configured to detect various wakewords. In at least some examples, each wakeword may correspond to a name of a different digital assistant. An example wakeword/digital assistant name is “Alexa.” In another example, input to the system may be in form of text data 1213, for example as a result of a user typing an input into a user interface of user device 110. Other input forms may include indication that the user has pressed a physical or virtual button on user device 110, the user has made a gesture, etc. The user device 110 may also capture images using camera(s) of the user device 110 and may send image data 1221 representing those image(s) to the system component(s). The image data 1221 may include raw image data or image data processed by the user device 110 before sending to the system component(s). The image data 1221 may be used in various manners by different components of the system to perform operations such as determining whether a user is directing an utterance to the system, interpreting a user command, responding to a user command, etc. In some embodiments, the user input data 1027 (described in relation to FIG. 10) may include one or more the audio 1210, the audio data 1211, the text data 1213 and the image data 1221.

The wakeword detection component 1220 of the user device 110 may process the audio data, representing the audio 1210, to determine whether speech is represented therein. The user device 110 may use various techniques to determine whether the audio data includes speech. In some examples, the user device 110 may apply voice activity detection (VAD) techniques. Such techniques may determine whether speech is present in audio data based on various quantitative aspects of the audio data, such as the spectral slope between one or more frames of the audio data; the energy levels of the audio data in one or more spectral bands; the signal-to-noise ratios of the audio data in one or more spectral bands; or other quantitative aspects. In other examples, the user device 110 may implement a classifier configured to distinguish speech from background noise. The classifier may be implemented by techniques such as linear classifiers, support vector machines, and decision trees. In still other examples, the user device 110 may apply hidden Markov model (HMM) or Gaussian mixture model (GMM) techniques to compare the audio data to one or more acoustic models in storage, which acoustic models may include models corresponding to speech, noise (e.g., environmental noise or background noise), or silence. Still other techniques may be used to determine whether speech is present in audio data.

Wakeword detection is typically performed without performing linguistic analysis, textual analysis, or semantic analysis. Instead, the audio data, representing the audio 1210, is analyzed to determine if specific characteristics of the audio data match preconfigured acoustic waveforms, audio signatures, or other data corresponding to a wakeword.

Thus, the wakeword detection component 1220 may compare audio data to stored data to detect a wakeword. One approach for wakeword detection applies general large vocabulary continuous speech recognition (LVCSR) systems to decode audio signals, with wakeword searching being conducted in the resulting lattices or confusion networks. Another approach for wakeword detection builds HMMs for each wakeword and non-wakeword speech signals, respectively. The non-wakeword speech includes other spoken words, background noise, etc. There can be one or more HMMs built to model the non-wakeword speech characteristics, which are named filler models. Viterbi decoding is used to search the best path in the decoding graph, and the decoding output is further processed to make the decision on wakeword presence. This approach can be extended to include discriminative information by incorporating a hybrid DNN-HMM decoding framework. In another example, the wakeword detection component 1220 may be built on deep neural network (DNN)/recursive neural network (RNN) structures directly, without HMM being involved. Such an architecture may estimate the posteriors of wakewords with context data, either by stacking frames within a context window for DNN, or using an RNN. Follow-on posterior threshold tuning or smoothing is applied for decision making. Other techniques for wakeword detection, such as those known in the art, may also be used.

Once the wakeword is detected by the wakeword detection component 1220 and/or input is detected by an input detector, the user device 110 may “wake” and begin transmitting audio data 1211, representing the audio 1210, to the system component(s) 120. The audio data 1211 may include data corresponding to the wakeword; in other embodiments, the portion of the audio corresponding to the wakeword is removed by the user device 110 prior to sending the audio data 1211 to the system component(s) 120. In the case of touch input detection or gesture-based input detection, the audio data may not include a wakeword.

In some implementations, the system 100 may include more than one system component(s). The system component(s) 120 may respond to different wakewords and/or perform different categories of tasks. Each system component(s) may be associated with its own wakeword such that speaking a certain wakeword results in audio data be sent to and processed by a particular system. For example, detection of the wakeword “Alexa” by the wakeword detection component 1220 may result in sending audio data to system component(s) 120a for processing while detection of the wakeword “Computer” by the wakeword detector may result in sending audio data to system component(s) 120b for processing. The system may have a separate wakeword and system for different skills/systems (e.g., “Castle Adventure” for a game play skill/system component(s) 120c) and/or such skills/systems may be coordinated by one or more skill component(s) 1054 of one or more system component(s) 120.

The user device 110/system component(s) 120 may also include a system directed input detector 1285. The system directed input detector 1285 may be configured to determine whether an input to the system (for example speech, a gesture, etc.) is directed to the system or not directed to the system (for example directed to another user, etc.). The system directed input detector 1285 may work in conjunction with the wakeword detection component 1220. If the system directed input detector 1285 determines an input is directed to the system, the user device 110 may “wake” and begin sending captured data for further processing. If data is being processed the user device 110 may indicate such to the user, for example by activating or changing the color of an illuminated output (such as a light emitting diode (LED) ring), displaying an indicator on a display (such as a light bar across the display), outputting an audio indicator (such as a beep) or otherwise informing a user that input data is being processed. If the system directed input detector 1285 determines an input is not directed to the system (such as a speech or gesture directed to another user) the user device 110 may discard the data and take no further action for processing purposes. In this way the system 100 may prevent processing of data not directed to the system, thus protecting user privacy. As an indicator to the user, however, the system may output an audio, visual, or other indicator when the system directed input detector 1285 is determining whether an input is potentially device directed. For example, the system may output an orange indicator while considering an input and may output a green indicator if a system directed input is detected. Other such configurations are possible.

Upon receipt by the system component(s) 120, the audio data 1211 may be sent to an orchestrator component 1230 and/or the language model orchestrator component 1030. The orchestrator component 1230 may include memory and logic that enables the orchestrator component 1230 to transmit various pieces and forms of data to various components of the system, as well as perform other operations as described herein. In some embodiments, the orchestrator component 1230 may optionally be included in the system component(s) 120. In embodiments where the orchestrator component 1230 is not included in the system component(s) 120, the audio data 1211 may be sent directly to the language model orchestrator component 1030. Further, in such embodiments, each of the components of the system component(s) 120 may be configured to interact with the language model orchestrator component 1030, the action plan execution component 1025, the API provider component, and/or other component(s).

In some embodiments, the system component(s) 120 may include an arbitrator component 1282, which may be configured to determine whether the orchestrator component 1230 and/or the language model orchestrator component 1030 are to process with respect to user input data. In some embodiments, the language model orchestrator component 1030 may be selected to process with respect to the audio data 1211 only if the user 1005 associated with the audio data 1211 (or the user device 110 that captured the audio 1210) has previously indicated that the language model orchestrator component 1030 may be selected to process with respect to user inputs received from the user 1005.

In some embodiments, the arbitrator component 1282 may determine the orchestrator component 1230 and/or the language model orchestrator component 1030 are to process with respect to the audio data 1211 based on metadata associated with the audio data 1211. For example, the arbitrator component 1282 may be a classifier configured to process a natural language representation of the audio data 1211 (e.g., output by the ASR component 1250) and classify the corresponding user input as to be processed by the orchestrator component 1230 and/or the language model orchestrator component 1030. For further example, the arbitrator component 1282 may determine whether the device from which the audio data 1211 is received is associated with an indicator representing the audio data 1211 is to be processed by the orchestrator component 1230 and/or the language model orchestrator component 1030. As an even further example, the arbitrator component 1282 may determine whether the user (e.g., determined using data output from the user recognition component 1295) from which the audio data 1211 is received is associated with a user profile including an indicator representing the audio data 1211 is to be processed by the orchestrator component 1230 and/or the language model orchestrator component 1030. As another example, the arbitrator component 1282 may determine whether the audio data 1211 (or the output of the ASR component 1250) corresponds to a request representing that the audio data 1211 is to be processed by the orchestrator component 1230 and/or the language model orchestrator component 1030 (e.g., a request including “let's chat” may represent that the audio data 1211 is to be processed by the language model orchestrator component 1030).

In some embodiments, if the arbitrator component 1282 is unsure (e.g., a confidence score corresponding to whether the orchestrator component 1230 and/or the language model orchestrator component 1030 is to process is below a threshold), then the arbitrator component 1282 may send the audio data 1211 to both of the orchestrator component 1230 and the language model orchestrator component 1030. In such embodiments, the orchestrator component 1230 and/or the language model orchestrator component 1030 may include further logic for determining further confidence scores during processing representing whether the orchestrator component 1230 and/or the language model orchestrator component 1030 should continue processing, as is discussed further herein below.

The arbitrator component 1282 may send the audio data 1211 to an ASR component 1250.

In some embodiments, the component selected to process the audio data 1211 (e.g., the orchestrator component 1230 and/or the language model orchestrator component 1030) may send the audio data 1211 to the ASR component 1250. The ASR component 1250 may transcribe the audio data 1211 into text data. The text data output by the ASR component 1250 represents one or more than one (e.g., in the form of an N-best list) ASR hypotheses representing speech represented in the audio data 1211. The ASR component 1250 interprets the speech in the audio data 1211 based on a similarity between the audio data 1211 and pre-established language models. For example, the ASR component 1250 may compare the audio data 1211 with models for sounds (e.g., acoustic units such as phonemes, senons, phones, etc.) and sequences of sounds to identify words that match the sequence of sounds of the speech represented in the audio data 1211. The ASR component 1250 sends the text data generated thereby to the arbitrator component 1282, the orchestrator component 1230, and/or the language model orchestrator component 1030. In instances where the text data is sent to the arbitrator component 1282, the arbitrator component 1282 may send the text data to the component selected to process the audio data 1211 (e.g., the orchestrator component 1230 and/or the language model orchestrator component 1030). The text data sent from the ASR component 1250 to the arbitrator component 1282, the orchestrator component 1230, and/or the language model orchestrator component 1030 may include a single top-scoring ASR hypothesis or may include an N-best list including multiple top-scoring ASR hypotheses. An N-best list may additionally include a respective score associated with each ASR hypothesis represented therein.

In some embodiments, the orchestrator component 1230 may cause a NLU component (not shown) to perform processing with respect to the ASR data generated by the ASR component 1250. The NLU component may attempt to make a semantic interpretation of the phrase(s) or statement(s) represented in the ASR data input therein by determining one or more meanings associated with the phrase(s) or statement(s) represented in the text data. The NLU component may determine an intent representing an action that a user desires be performed and may determine information that allows a device (e.g., the device 110, the system component(s) 120, a skill/app component 1054, a skill system component(s) 125, etc.) to execute the intent. For example, if the ASR data corresponds to “play the 5th Symphony by Beethoven,” the NLU component may determine an intent that the system output music and may identify “Beethoven” as an artist/composer and “5th Symphony” as the piece of music to be played. For further example, if the ASR data corresponds to “what is the weather,” the NLU component may determine an intent that the system output weather information associated with a geographic location of the device 110. In another example, if the ASR data corresponds to “turn off the lights,” the NLU component may determine an intent that the system turn off lights associated with the device 110 or the user 1005. However, if the NLU component is unable to resolve the entity—for example, because the entity is referred to by anaphora such as “this song” or “my next appointment”—the system can send a decode request to another speech processing system for information regarding the entity mention and/or other context related to the utterance. The natural language processing system may augment, correct, or base results data upon the ASR data as well as any data received from the system.

The NLU component may return NLU results data (which may include tagged text data, indicators of intent, etc.) back to the orchestrator component 1230. The orchestrator component 1230 may forward the NLU results data to a skill component(s) 1054. If the NLU results data includes a single NLU hypothesis, the NLU component and the orchestrator component 1230 may direct the NLU results data to the skill component(s) 1054 associated with the NLU hypothesis. If the NLU results data includes an N-best list of NLU hypotheses, the NLU component and the orchestrator component 1230 may direct the top scoring NLU hypothesis to a skill component(s) 1054 associated with the top scoring NLU hypothesis. The system may also include a post-NLU ranker which may incorporate other information to rank potential interpretations determined by the NLU component.

In some embodiments, after determining that the orchestrator component 1230 and/or the language model orchestrator component 1030 should process with respect to the user input, the arbitrator component 1282 may be configured to periodically determine whether the orchestrator component 1230 and/or the language model orchestrator component 1030 should continue processing with respect to the user input. For example, after a particular point in the processing of the orchestrator component 1230 (e.g., after performing NLU, prior to determining a skill component 1054 to process with respect to the user input, prior to performing an action responsive to the user input, etc.) and/or the language model orchestrator component 1030 (e.g., after selecting a task to be completed, after receiving the action response data from the one or more components, after completing a task, prior to performing an action responsive to the user input, etc.) the orchestrator component 1230 and/or the language model orchestrator component 1030 may query the arbitrator component 1282 has determined that the orchestrator component 1230 and/or the language model orchestrator component 1030 should halt processing with respect to the user input. As discussed above, the system 100 may be configured to stream portions of data associated with processing with respect to a user input to the one or more components such that the one or more components may begin performing their configured processing with respect to that data as soon as it is available to the one or more components. As such, the arbitrator component 1282 may cause the orchestrator component 1230 and/or the language model orchestrator component 1030 to begin processing with respect to a user input as soon as a portion of data associated with the user input is available (e.g., the ASR data, context data, output of the user recognition component 1295.

Thereafter, once the arbitrator component 1282 has enough data to perform the processing described herein above to determine whether the orchestrator component 1230 and/or the language model orchestrator component 1030 is to process with respect to the user input, the arbitrator component 1282 may inform the corresponding component (e.g., the orchestrator component 1230 and/or the language model orchestrator component 1030) to continue/halt processing with respect to the user input at one of the logical checkpoints in the processing of the orchestrator component 1230 and/or the language model orchestrator component 1030.

A skill system component(s) 125 may communicate with a skill/app component(s) 1054 within the system component(s) 120 directly with the orchestrator component 1230 and/or the action plan execution component 1025, or with other components. A skill system component(s) 125 may be configured to perform one or more actions. An ability to perform such action(s) may sometimes be referred to as a “skill.” That is, a skill may enable a skill system component(s) 125 to execute specific functionality in order to provide data or perform some other action requested by a user. For example, a weather service skill may enable a skill system component(s) 125 to provide weather information to the system component(s) 120, a car service skill may enable a skill system component(s) 125 to book a trip with respect to a taxi or ride sharing service, an order pizza skill may enable a skill system component(s) 125 to order a pizza with respect to a restaurant's online ordering system, etc. Additional types of skills include home automation skills (e.g., skills that enable a user to control home devices such as lights, door locks, cameras, thermostats, etc.), entertainment device skills (e.g., skills that enable a user to control entertainment devices such as smart televisions), video skills, flash briefing skills, as well as custom skills that are not associated with any pre-configured type of skill.

The system component(s) 120 may be configured with a skill/app component 1054 dedicated to interacting with the skill system component(s) 125. Unless expressly stated otherwise, reference to a skill, skill device, or skill component may include a skill/app component 1054 operated by the system component(s) 120 and/or skill/app operated by the skill system component(s) 125. Moreover, the functionality described herein as a skill or skill may be referred to using many different terms, such as an action, bot, app, or the like. The skill component 1054 and or skill system component(s) 125 may return output data to the orchestrator component 1230.

The system component(s) includes a SSG component 1256. The SSG component 1256 may generate audio data (e.g., synthesized speech) from text data, text embeddings, text tokens, audio tokens, audio embeddings, etc., using one or more different methods. Data input to the SSG component 1256 may come from a skill/app component 1054, the orchestrator component 1230, the action plan execution component 1025, or another component of the system. In one method of synthesis called unit selection, the SSG component 1256 matches data against a database of recorded speech. The SSG component 1256 selects matching units of recorded speech and concatenates the units together to form audio data. In another method of synthesis called parametric synthesis, the SSG component 1256 varies parameters such as frequency, volume, and noise to create audio data including an artificial speech waveform. Parametric synthesis uses a computerized voice generator, sometimes called a vocoder.

The user device 110 may include still image and/or video capture components such as a camera or cameras to capture one or more images. The user device 110 may include circuitry for digitizing the images and/or video for transmission to the system component(s) 120 as image data. The user device 110 may further include circuitry for voice command-based control of the camera, allowing a user 1005 to request capture of image or video data. The user device 110 may process the commands locally or send audio data 1211 representing the commands to the system component(s) 120 for processing, after which the system component(s) 120 may return output data that can cause the user device 110 to engage its camera.

The system component(s) 120/the user device 110 may include a user recognition component 1295 that recognizes one or more users using a variety of data. However, the disclosure is not limited thereto, and the user device 110 may include the user recognition component 1295 instead of and/or in addition to the system component(s) 120 without departing from the disclosure.

The user recognition component 1295 may take as input the audio data 1211 and/or text data output by the ASR component 1250. The user recognition component 1295 may perform user recognition by comparing audio characteristics in the audio data 1211 to stored audio characteristics of users. The user recognition component 1295 may also perform user recognition by comparing biometric data (e.g., fingerprint data, iris data, etc.), received by the system in correlation with the present user input, to stored biometric data of users assuming user permission and previous authorization. The user recognition component 1295 may further perform user recognition by comparing image data (e.g., including a representation of at least a feature of a user), received by the system in correlation with the present user input, with stored image data including representations of features of different users. The user recognition component 1295 may perform additional user recognition processes, including those known in the art.

The user recognition component 1295 determines scores indicating whether user input originated from a particular user. For example, a first score may indicate a likelihood that the user input originated from a first user, a second score may indicate a likelihood that the user input originated from a second user, etc. The user recognition component 1295 also determines an overall confidence regarding the accuracy of user recognition operations.

Output of the user recognition component 1295 may include a single user identifier corresponding to the most likely user that originated the user input. Alternatively, output of the user recognition component 1295 may include an N-best list of user identifiers with respective scores indicating likelihoods of respective users originating the user input. The output of the user recognition component 1295 may be used to inform processing of the arbitrator component 1282, the orchestrator component 1230, and/or the language model orchestrator component 1030 as well as processing performed by other components of the system.

The system component(s) 120/user device 110 may include a presence detection component that determines the presence and/or location of one or more users using a variety of data.

The system 100 (either on user device 110, system component(s), or a combination thereof) may include profile storage for storing a variety of information related to individual users, groups of users, devices, etc. that interact with the system. As used herein, a “profile” refers to a set of data associated with a user, group of users, device, etc. The data of a profile may include preferences specific to the user, device, etc.; input and output capabilities of the device; internet connectivity information; user bibliographic information; subscription information, as well as other information.

The profile storage 1270 may include one or more user profiles, with each user profile being associated with a different user identifier/user profile identifier. Each user profile may include various user identifying data. Each user profile may also include data corresponding to preferences of the user. Each user profile may also include preferences of the user and/or one or more device identifiers, representing one or more devices of the user. For instance, the user account may include one or more internet protocol (IP) addresses, medium access control (MAC) addresses, and/or device identifiers, such as a serial number, of each additional electronic device associated with the identified user account. When a user logs into to an application installed on a user device 110, the user profile (associated with the presented login information) may be updated to include information about the user device 110, for example with an indication that the device is currently in use. Each user profile may include identifiers of components (e.g., responding component(s) 1060 such as skills/apps, language model-based agents, knowledge bases, components for a particular domain, etc.) that the user has enabled. When a user enables a component, the user is providing the system component(s) with permission to allow the component to execute with respect to the user's inputs. If a user does not enable a component, the system component(s) may not invoke that component to execute with respect to the user's inputs.

The profile storage 1270 may include one or more group profiles. Each group profile may be associated with a different group identifier. A group profile may be specific to a group of users. That is, a group profile may be associated with two or more individual user profiles. For example, a group profile may be a household profile that is associated with user profiles associated with multiple users of a single household. A group profile may include preferences shared by all the user profiles associated therewith. Each user profile associated with a group profile may additionally include preferences specific to the user associated therewith. That is, each user profile may include preferences unique from one or more other user profiles associated with the same group profile. A user profile may be a stand-alone profile or may be associated with a group profile.

The profile storage 1270 may include one or more device profiles. Each device profile may be associated with a different device identifier. Each device profile may include various device identifying information. Each device profile may also include one or more user identifiers, representing one or more users associated with the device. For example, a household device's profile may include the user identifiers of users of the household.

Although the components of FIG. 12 may be illustrated as part of system component(s) 120, user device 110, or otherwise, the components may be arranged in other device(s) (such as in user device 110 if illustrated in system component(s) 120 or vice-versa, or in other device(s) altogether) without departing from the disclosure.

In at least some embodiments, the system component(s) 120 may receive the audio data 1211 from the user device 110, to recognize speech corresponding to a spoken input in the received audio data 1211, and to perform functions in response to the recognized speech. In at least some embodiments, these functions involve sending directives (e.g., commands), from the system component(s) to the user device 110 (and/or other user devices 110) to cause the user device 110 to perform an action, such as output an audible response to the spoken input via a loudspeaker(s), and/or control secondary devices in the environment by sending a control command to the secondary devices.

Thus, when the user device 110 is able to communicate with the system component(s) over the network(s) 199, some or all of the functions capable of being performed by the system component(s) may be performed by sending one or more directives over the network(s) 199 to the user device 110, which, in turn, may process the directive(s) and perform one or more corresponding actions. For example, the system component(s), using a remote directive that is included in response data (e.g., a remote response), may direct the user device 110 to output an audible response (e.g., using SSG processing performed by an on-device SSG component) to a user's question via a loudspeaker(s) of (or otherwise associated with) the user device 110, to output content (e.g., music) via the loudspeaker(s) of (or otherwise associated with) the user device 110, to display content on a display of (or otherwise associated with) the user device 110, and/or to send a directive to a secondary device (e.g., a directive to turn on a smart light). It is to be appreciated that the system component(s) may be configured to provide other functions in addition to those discussed herein, such as, without limitation, providing step-by-step directions for navigating from an origin location to a destination location, conducting an electronic commerce transaction on behalf of the user 1005 as part of a shopping function, establishing a communication session (e.g., a video call) between the user 1005 and another user, and so on.

In at least some embodiments, the user device 110, may send the audio data 1211 to the wakeword detection component 1220. If the wakeword detection component 1220 detects a wakeword in the audio data 1211, the wakeword detection component 1220 may send an indication of such detection to the user device 110. In response to receiving the indication, the audio data 1211 may be sent to the system component(s) 120 and/or the ASR component of the user device 110. The wakeword detection component 1220 may also send an indication, to the user device 110, representing a wakeword was not detected. In response to receiving such an indication, the audio data 1211 may not be sent to the system component(s) 120, and the user device 110 may prevent the ASR component of the user device 110 from further processing the audio data 1211. In this situation, the audio data 1211 can be discarded.

In some embodiments, the user device 110 may include some or all of the components illustrated in FIG. 12 and/or discussed herein above with respect to the system component(s) 120. In other embodiments, the components illustrated in FIG. 12 and/or discussed herein with respect to the system component(s) 120 may be distributed across the user device 110 and the system component(s) 120.

In at least some embodiments, the components of the user device 110 (e.g., on-device components) may not have the same capabilities as the components of the system component(s) 120. For example, on-device components may be configured to generate a response to only a subset of the natural language user inputs that may be handled by the system component(s) 120. For example, such subset of natural language user inputs may correspond to local-type natural language user inputs, such as those controlling devices or components associated with a user's home. In such circumstances the on-device components may be able to more quickly interpret and respond to a local-type natural language user input, for example, than processing that involves the system component(s). If the user device 110 attempts to process a natural language user input for which the on-device components are not necessarily best suited, the language processing results determined by the user device 110 may indicate a low confidence or other metric indicating that the processing by the user device 110 may not be as accurate as the processing done by the system component(s) 120.

In some embodiments, the system component(s) 120 and the user device 110 may process as described herein to generate responses to the user input corresponding to the audio data 1211. The system component(s) 120 may send the response to the user device 110 and the user device 110 may determine whether to output the response generated by the system component(s) 120 or the response generated by the user device 110. In some embodiments, the system component(s) 120 may be configured to perform a portion of the processing described herein, such as a portion of processing not performable by the user device 110 and send the result of such processing to the user device 110. The user device 110 may be configured to determine whether to use the result to complete processing to generate the response to the user device 110.

In at least some embodiments, the user device 110 may include, or be configured to use, one or more skill/app components that may operate similarly to the skill/app component(s) 1054. The skill/app component(s) on the user device 110 may correspond to one or more domains that are used in order to determine how to act on a spoken input in a particular way, such as by outputting a directive that corresponds to the determined intent, and which can be processed to implement the desired operation. The skill component(s) installed on the user device 110 may include, without limitation, a smart home skill component (or smart home domain) and/or a device control skill component (or device control domain) to execute in response to spoken inputs corresponding to an intent to control a second device(s) in an environment, a music skill component (or music domain) to execute in response to spoken inputs corresponding to a intent to play music, a navigation skill component (or a navigation domain) to execute in response to spoken input corresponding to an intent to get directions, a shopping skill component (or shopping domain) to execute in response to spoken inputs corresponding to an intent to buy an item from an electronic marketplace, and/or the like.

Additionally, or alternatively, the user device 110 may be in communication with one or more skill system component(s) 125. For example, a skill system component(s) 125 may be located in a remote environment (e.g., separate location) such that the user device 110 may only communicate with the skill system component(s) 125 via the network(s) 199. However, the disclosure is not limited thereto. For example, in at least some embodiments, a skill system component(s) 125 may be configured in a local environment (e.g., home server and/or the like) such that the user device 110 may communicate with the skill system component(s) 125 via a private network, such as a local area network (LAN).

FIG. 13 is a conceptual diagram of components of a system to detect if input audio data includes system directed speech, according to embodiments of the present disclosure. As shown in FIG. 13, a system directed input detector 1285 may include a number of different components. First, the system directed input detector 1285 may include a voice activity detection (VAD) component 1320. The VAD component 1320 may operate to detect whether the incoming audio data 1311 includes speech or not. The VAD output 1321 may be a binary indicator. Thus, if the incoming audio data 1311 includes speech, the VAD component 1320 may output an indicator 1321 that the audio data 1311 does include speech (e.g., a 1) and if the incoming audio data 1311 does not include speech, the VAD component 1320 may output an indicator 1321 that the audio data 1311 does not include speech (e.g., a 0). The VAD output 1321 may also be a score (e.g., a number between 0 and 1) corresponding to a likelihood that the audio data 1311 includes speech. The VAD component 1320 may also perform start-point detection as well as end-point detection where the VAD component 1320 determines when speech starts in the audio data 1311 and when it ends in the audio data 1311. Thus the VAD output 1321 may also include indicators of a speech start point and/or a speech endpoint for use by other components of the system. (For example, the start-point and end-points may demarcate the audio data 1311 that is sent to the speech processing component.) The VAD output 1321 may be associated with a same unique ID as the audio data 1311 for purposes of tracking system processing across various components.

The VAD component 1320 may operate using a variety of VAD techniques, including those described above with regard to VAD operations performed by device 110. The VAD component 1320 may be configured to be robust to background noise so as to accurately detect when audio data actually includes speech or not. The VAD component 1320 may operate on raw audio data 1311 such as that sent by device 110 or may operate on feature vectors or other data representing the audio data 1311. For example, the VAD component 1320 may take the form of a deep neural network (DNN) and may operate on a single feature vector representing the entirety of audio data 1311 received from the device or may operate on multiple feature vectors, for example feature vectors representing frames of audio data where each frame covers a certain amount of time of audio data (e.g., 25 ms). The VAD component 1320 may also operate on other data 1314 that may be useful in detecting voice activity in the audio data 1311. For example, the other data 1314 may include results of anchored speech detection where the system takes a representation (such as a voice fingerprint, reference feature vector, etc.) of a reference section of speech (such as speech of a voice that uttered a previous command to the system that included a wakeword) and compares a voice detected in the audio data 1311 to determine if that voice matches a voice in the reference section of speech. If the voices match, that may be an indicator to the VAD component 1320 that speech was detected. If not, that may be an indicator to the VAD component 1320 that speech was not detected. (For example, a representation may be taken of voice data in the first input audio data which may then be compared to the second input audio data to see if the voices match. If they do (or do not) that information may be considered by the VAD component 1320.) The VAD component 1320 may also consider other data when determining if speech was detected. The VAD component 1320 may also consider speaker ID information (such as may be output by a user recognition component), directionality data that may indicate what direction (relative to the capture device 110) the incoming audio was received from. Such directionality data may be received from the device 110 and may have been determined by a beamformer or other component of device 110. The VAD component 1320 may also consider data regarding a previous utterance which may indicate whether the further audio data received by the system is likely to include speech. Other VAD techniques may also be used.

If the VAD output 1321 indicates that no speech was detected the system 100 may discontinue processing with regard to the audio data 1311, thus saving computing resources that might otherwise have been spent on other processes (e.g., ASR for the audio data 1311, etc.). If the VAD output 1321 indicates that speech was detected, the system 100 may make a determination as to whether the speech was or was not directed to the speech-processing system. Such a determination may be made by the system directed audio detector 1340. The system directed audio detector 1340 may include a trained model, such as a DNN, that operates on a feature vector which represent certain data that may be useful in determining whether or not speech is directed to the system. To create the feature vector operable by the system directed audio detector 1340, a feature extractor 1330 may be used. The feature extractor 1330 may input ASR results 1313 which include results from the processing of the audio data 1311 by a speech recognition component.

For privacy protection purposes, in certain configurations the ASR results 1313 may be obtained from a language processing component/ASR component located on device 110 or on a home remote component as opposed to a language processing component/ASR component located on a cloud or other system component(s) 120 so that audio data 1311 is not sent remote from the user's home unless the system directed input detector 1285 has determined that the input is system directed. Though this may be adjusted depending on user preferences/system configuration.

The ASR results 1313 may include an N-best list of top scoring ASR hypotheses and their corresponding scores, portions (or all of) an ASR lattice/trellis with scores, portions (or all of) an ASR search graph with scores, portions (or all of) an ASR confusion network with scores, or other such ASR output. As an example, the ASR results 1313 may include a trellis, which may include a raw search graph as scored during ASR decoding. The ASR results 1313 may also include a lattice, which may be a trellis as scored that has been pruned to remove certain hypotheses that do not exceed a score threshold or number of hypotheses threshold. The ASR results 1313 may also include a confusion network where paths from the lattice have been merged (e.g., merging hypotheses that may share all or a portion of a same word). The confusion network may be a data structure corresponding to a linear graph that may be used as an alternate representation of the most likely hypotheses of the decoder lattice. The ASR results 1313 may also include corresponding respective scores (such as for a trellis, lattice, confusion network, individual hypothesis, N-best list, etc.)

The ASR results 1313 (or other data 1315) may include other ASR result related data such as other features from the ASR system or data determined by another component. For example, the system 100 may determine an entropy of the ASR results (for example a trellis entropy or the like) that indicates a how spread apart the probability mass of the trellis is among the alternate hypotheses. A large entropy (e.g., large spread of probability mass over many hypotheses) may indicate the ASR component being less confident about its best hypothesis, which in turn may correlate to detected speech not being device directed. The entropy may be a feature included in other data 1315 to be considered by the system directed audio detector 1340.

The system 100 may also determine and consider ASR decoding costs, which may include features from Viterbi decoding costs of the ASR. Such features may indicate how well the input acoustics and vocabulary match with the acoustic models and language models. Higher Viterbi costs may indicate greater mismatch between the model and the given data, which may correlate to detected speech not being device directed. Confusion network feature may also be used. For example, an average number of arcs (where each arc represents a word) from a particular node (representing a potential join between two words) may measure how many competing hypotheses there are in the confusion network. A large number of competing hypotheses may indicate that the ASR component is less confident about the top hypothesis, which may correlate to detected speech not being device directed. Other such features or data from the ASR results 1313 may also be used as other data 1315.

The ASR results 1313 may be represented in a system directed detector (SDD) feature vector 1335 that can be used to determine whether speech was system-directed. The feature vector 1335 may represent the ASR results 1313 but may also represent audio data 1311 (which may be input to feature extractor 1330) or other information. Such ASR results may be helpful in determining if speech was system-directed. For example, if ASR results include a high scoring single hypothesis, that may indicate that the speech represented in the audio data 1311 is directed at, and intended for, the device 110. If, however, ASR results do not include a single high scoring hypothesis, but rather many lower scoring hypotheses, that may indicate some confusion on the part of the speech recognition component and may also indicate that the speech represented in the audio data 1311 was not directed at, nor intended for, the device 110.

The ASR results 1313 may include complete ASR results, for example ASR results corresponding to all speech between a startpoint and endpoint (such as a complete lattice, etc.). In this configuration the system 100 may wait until all ASR processing for a certain input audio has been completed before operating the feature extractor 1330 and system directed audio detector 1340. Thus the system directed audio detector 1340 may receive a feature vector 1335 that includes all the representations of the audio data 1311 created by the feature extractor 1330. The system directed audio detector 1340 may then operate a trained model (such as a DNN) on the feature vector 1335 to determine a score corresponding to a likelihood that the audio data 1311 includes a representation of system-directed speech. If the score is above a threshold, the system directed audio detector 1340 may determine that the audio data 1311 does include a representation of system-directed speech. The SDD result 1385 may include an indicator of whether the audio data includes system-directed speech, a score, and/or some other data.

The ASR results 1313 may also include incomplete ASR results, for example ASR results corresponding to only some speech between a between a startpoint and endpoint (such as an incomplete lattice, etc.). In this configuration the feature extractor 1330/system directed audio detector 1340 may be configured to operate on incomplete ASR results 1313 and thus the system directed audio detector 1340 may be configured to output an SDD result 1385 that provides an indication as to whether the portion of audio data processed (that corresponds to the incomplete ASR results) corresponds to system directed speech. The system 100 may thus be configured to perform ASR at least partially in parallel with the system directed audio detector 1340 to process ASR result data as it is ready and thus continually update an SDD result 1385. Once the system directed input detector 1285 has processed enough ASR results and/or the SDD result 1385 exceeds a threshold, the system 100 may determine that the audio data 1311 includes system-directed speech. Similarly, once the system directed input detector 1285 has processed enough ASR results and/or the SDD result 1385 drops below another threshold, the system 100 may determine that the audio data 1311 does not include system-directed speech.

The SDD result 1385 may be associated with a same unique ID as the audio data 1311 and VAD output 1321 for purposes of tracking system processing across various components.

The feature extractor 1330 may also incorporate in a feature vector 1335 representations of other data 1315. Other data 1315 may include, for example, word embeddings from words output by the speech recognition component may be considered. Word embeddings are vector representations of words or sequences of words that show how specific words may be used relative to other words, such as in a large text corpus. A word embedding may be of a different length depending on how many words are in a text segment represented by the word embedding. For purposes of the feature extractor 1330 processing and representing a word embedding in a feature vector 1335 (which may be of a fixed length), a word embedding of unknown length may be processed by a neural network with memory, such as an LSTM (long short term memory) network. Each vector of a word embedding may be processed by the LSTM which may then output a fixed representation of the input word embedding vectors.

Other data 1315 may also include, for example, NLU output from a natural language component may be considered. Thus, if natural language output data indicates a high correlation between the audio data 1311 and an out-of-domain indication (e.g., no intent classifier scores from ICs or overall domain scores from recognizers reach a certain confidence threshold), this may indicate that the audio data 1311 does not include system-directed speech. Other data 1315 may also include, for example, an indicator of a user/speaker as output user recognition component. Thus, for example, if the user recognition component does not indicate the presence of a known user, or indicates the presence of a user associated with audio data 1311 that was not associated with a previous utterance, this may indicate that the audio data 1311 does not include system-directed speech. The other data 1315 may also include an indication that a voice represented in audio data 1311 is the same (or different) as the voice detected in previous input audio data corresponding to a previous utterance. The other data 1315 may also include directionality data, for example using beamforming or other audio processing techniques to determine a direction/location of a source of detected speech and whether that source direction/location matches a speaking user. The other data 1315 may also include data indicating that a direction of a user's speech is toward a device 110 or away from a device 110, which may indicate whether the speech was system directed or not.

Other data 1315 may also include image data 1312. For example, if image data is detected from one or more devices that are nearby to the device 110 (which may include the device 110 itself) that captured the audio data being processed using the system directed input detector 1285, the image data may be processed to determine whether a user is facing an audio capture device for purposes of determining whether speech is system-directed as further explained below.

Other data 1315 may also dialog history data. For example, the other data 1315 may include information about whether a speaker has changed from a previous utterance to the current audio data 1311, whether a topic of conversation has changed from a previous utterance to the current audio data, how NLU results from a previous utterance compare to NLU results obtained using the current audio data 1311, other system context information. The other data 1315 may also include an indicator as to whether the audio data 1311 was received as a result of a wake command or whether the audio data 1311 was sent without the device 110 detecting a wake command (e.g., the device 110 being instructed by system component(s) 120 and/or determining to send the audio data without first detecting a wake command).

Other data 1315 may also include information from a user profile associated with the device 110 and/or the system 100.

Other data 1315 may also include direction data, for example data regarding a direction of arrival of speech detected by the device, for example a beam index number, angle data, or the like. If second audio data is received from a different direction than first audio data, then the system 100 may be less likely to declare the second audio data to include system-directed speech since it is originating from a different location.

Other data 1315 may also include acoustic feature data such as pitch, prosody, intonation, volume, or other data descriptive of the speech in the audio data 1311. As a user may use a different vocal tone to speak with a machine than with another human, acoustic feature information may be useful in determining if speech is device-directed.

Other data 1315 may also include an indicator that indicates whether the audio data 1311 includes a wakeword. For example, if a device 110 detects a wakeword prior to sending the audio data 1311 to the system component(s) 120, the device 110 may send along an indicator that the device 110 detected a wakeword in the audio data 1311. In another example, the system component(s) 120 may include another component that processes incoming audio data 1311 to determine if it includes a wakeword. If it does, the component may create an indicator indicating that the audio data 1311 includes a wakeword. The indicator may then be included in other data 1315 to be incorporated in the feature vector 1335 and/or otherwise considered by the system directed audio detector 1340.

Other data 1315 may also include device history data such as information about previous operations related to the device 110 that sent the audio data 1311. For example, the other data 1315 may include information about a previous utterance that was just executed, where the utterance originated with the same device 110 as a current utterance and the previous utterance was within a certain time window of the current utterance. Device history data may be stored in a manner associated with the device identifier (which may also be included in other data 1315), which may also be used to track other information about the device, such as device hardware, capability, location, etc.

The other data 1314 used by the VAD component 1320 may include similar data and/or different data from the other data 1315 used by the feature extractor 1330. The other data 1314/1315 may thus include a variety of data corresponding to input audio from a previous utterance.

That data may include acoustic data from a previous utterance, speaker ID/voice identification data from a previous utterance, information about the time between a previous utterance and a current utterance, or a variety of other data described herein taken from a previous utterance. A score threshold (for the system directed audio detector 1340 and/or the VAD component 1320) may be based on the data from the previous utterance. For example, a score threshold (for the system directed audio detector 1340 and/or the VAD component 1320) may be based on acoustic data from a previous utterance.

The feature extractor 1330 may output a single feature vector 1335 for one utterance/instance of input audio data 1311. The feature vector 1335 may consistently be a fixed length, or may be a variable length vector depending on the relevant data available for particular audio data 1311. Thus, the system directed audio detector 1340 may output a single SDD result 1385 per utterance/instance of input audio data 1311. The SDD result 1385 may be a binary indicator. Thus, if the incoming audio data 1311 includes system-directed speech, the system directed audio detector 1340 may output an indicator 1385 that the audio data 1311 does include system-directed speech (e.g., a 1) and if the incoming audio data 1311 does not include system-directed speech, the system directed audio detector 1340 may output an indicator 1385 that the audio data 1311 does not system-directed includes speech (e.g., a 0). The SDD result 1385 may also be a score (e.g., a number between 0 and 1) corresponding to a likelihood that the audio data 1311 includes system-directed speech. Although not illustrated in FIG. 13, the flow of data to and from the system directed input detector 1285 may be managed by an orchestrator component or by one or more other components.

The trained model(s) of the system directed audio detector 1340 may be trained on many different examples of SDD feature vectors that include both positive and negative training samples (e.g., samples that both represent system-directed speech and non-system directed speech) so that the DNN and/or other trained model of the system directed audio detector 1340 may be capable of robustly detecting when speech is system-directed versus when speech is not system-directed.

A further input to the system directed input detector 1285 may include output data from a TTS component to avoid synthesized speech output by the system being confused as system-directed speech spoken by a user. The output from the TTS component may allow the system to ignore synthesized speech in its considerations of whether speech was system directed. The output from the TTS component may also allow the system to determine whether a user captured utterance is responsive to the TTS output, thus improving system operation.

The system directed input detector 1285 may also use echo return loss enhancement (ERLE) and/or acoustic echo cancellation (AEC) data to avoid processing of audio data generated by the system.

As shown in FIG. 13, the system directed input detector 1285 may simply user audio data to determine whether an input is system directed (for example, system directed audio detector 1340 may output an SDD result 1385). This may be true particularly when no image data is available (for example for a device without a camera). If image data 1312 is available, however, the system 100 may also be configured to use image data 1312 to determine if an input is system directed. The image data 1312 may include image data captured by device 110 and/or image data captured by other device(s) in the environment of device 110. The audio data 1311, image data 1312 and other data 1314 may be timestamped or otherwise correlated so that the system directed input detector 1285 may determine that the data being analyzed all relates to a same time window so as to ensure alignment of data considered with regard to whether a particular input is system directed. For example, the system directed input detector 1285 may determine system directedness scores for every frame of audio data/every image of a video stream and may align and/or window them to determine a single overall score for a particular input that corresponds to a group of audio frames/images.

Image data 1312 along with other data 1314 may be received by feature extractor 1350. The feature extractor may create one or more feature vectors 1355 which may represent the image data 1312/other data 1314. In certain examples, other data 1314 may include data from an image processing component which may include information about faces, gesture, etc. detected in the image data 1312. For privacy protection purposes, in certain configurations any image processing/results thereof may be obtained from an image processing component located on device 110 or on a home remote component as opposed to an image processing component located on a cloud or other system component(s) 120 so that image data 1312 is not sent remote from the user's home unless the system directed input detector 1285 has determined that the input is system directed.

Though this may be adjusted depending on user preferences/system configuration.

The feature vector 1355 may be passed to the user detector 1360. The user detector 1360 (which may use various components/operations of image processing component, user recognition component, etc.) may be configured to process image data 1312 and/or feature vector 1355 to determine information about the user's behavior which in turn may be used to determine if an input is system directed. For example, the user detector 1360 may be configured to determine the user's position/behavior with respect to device 110/system 100. The user detector 1360 may also be configured to determine whether a user's mouth is opening/closing in a manner that suggests the user is speaking. The user detector 1360 may also be configured to determine whether a user is nodding or shaking his/her head. The user detector 1360 may also be configured to determine whether a user's gaze is directed to the device 110, to another user, or to another object. For example, the user detector 1360 may include, or be configured to use data from, a gaze detector. The user detector 1360 may also be configured to determine gestures of the user such as a shoulder shrug, pointing toward an object, a wave, a hand up to indicate an instruction to stop, or a fingers moving to indicate an instruction to continue, holding up a certain number of fingers, putting a thumb up, etc. The user detector 1360 may also be configured to determine a user's position/orientation such as facing another user, facing the device 110, whether their back is turned, etc.

The user detector 1360 may also be configured to determine relative positions of multiple users that appear in image data (and/or are speaking in audio data 1311 which may also be considered by the user detector 1360 along with feature vector 1335), for example which users are closer to a device 110 and which are farther away. The user detector 1360 (and/or other component) may also be configured to identify other objects represented in image data and determine whether objects are relevant to a dialog or system interaction (for example determining if a user is referring to an object through a movement or speech).

The user detector 1360 may operate one or more models (e.g., one or more classifiers) to determine if certain situations are represented in the image data 1312. For example the user detector 1360 may employ a visual directedness classifier that may determine, for each face detected in the image data 1312 whether that face is looking at the device 110 or not. For example, a light-weight convolutional neural network (CNN) may be used which takes a face image cropped from the result of the face detector as input and output a [0,1] score of how likely the face is directed to the camera or not. Another technique may include to determine a three-dimensional (3D) landmark of each face, estimate the 3D angle of the face and predict a directness score based on the 3D angle.

The user detector 1360 (or other component(s) such as those in image processing) may be configured to track a face in image data to determine which faces represented may belong to a same person. The system 100 may user IOU based tracker, a mean-shift based tracker, a particle filter based tracker or other technique.

The user detector 1360 (or other component(s) such as those included in a user recognition component) may be configured to determine whether a face represented in image data belongs to a person who is speaking or not, thus performing active speaker detection. The system 100 may take the output from the face tracker and aggregate a sequence of face from the same person as input and predict whether this person is speaking or not. Lip motion, user ID, detected voice data, and other data may be used to determine whether a user is speaking or not.

The system directed image detector 1370 may then determine, based on information from the user detector 1360, such as the image data 1312, whether an input relating to the image data 1312 is system directed. The system directed image detector 1370 may also operate on other input data, for example image data including raw image data 1312, image data including feature vector data 1355 based on raw image data, other data 1314, or other data. The determination by the system directed image detector 1370 may result in a score indicating whether the input is system directed based on the image data. If no audio data is available, the indication may be output as SDD result 1385. If audio data is available, the indication may be sent to system directed detector 1380 which may consider information from both system directed audio detector 1340 and system directed image detector 1370. The system directed detector 1380 may then process the data from both system directed audio detector 1340 and system directed image detector 1370 to come up with an overall determination as to whether an input was system directed, which may be output as SDD result 1385. The system directed detector 1380 may consider not only data output from system directed audio detector 1340 and system directed image detector 1370 but also other data/metadata corresponding to the input (for example, image data/feature data 1355, audio data/feature data 1335, image data 1312, audio data 1311, or the like discussed with regard to FIG. 13. The system directed detector 1380 may include one or more models which may analyze the various input data to make a determination regarding SDD result 1385.

In one example the determination of the system directed detector 1380 may be based on “AND” logic, for example determining an input is system directed only if affirmative data is received from both system directed audio detector 1340 and system directed image detector 1370. In another example the determination of the system directed detector 1380 may be based on “OR” logic, for example determining an input is system directed if affirmative data is received from either system directed audio detector 1340 or system directed image detector 1370. In another example the data received from system directed audio detector 1340 and system directed image detector 1370 are weighted individually based on other information available to system directed detector 1380 to determine to what extend audio and/or image data should impact the decision of whether an input is system directed.

As illustrated in FIG. 13, the system directed input detector 1285 may also receive information from the UED component 560, such as UED data 570. For example, the UED data 570 may include user engagement decision data 610, which may indicate whether the user is or is not engaged with the device 110 and may be considered by the system directed input detector 1285 (e.g., by system directed audio detector 1340, system directed detector 1380, etc.) as part of the overall consideration of whether a system input was device directed. Additionally or alternatively, in some examples the UED data 570 may also include fused UED input data 620 and/or raw UED input data 630, which may also be considered by the system directed input detector 1285 as part of the overall consideration of whether a system input was device directed.

While FIG. 13 illustrates the UED component 560 as being separate from the system directed input detector 1285, the disclosure is not limited thereto and the UED component 560 may be included within the system directed input detector 1285 without departing from the disclosure. For example, FIG. 13 is intended to conceptually illustrate an example in which the UED component 560 is used to augment the system directed input detector 1285 and improve an accuracy of the SDD result 1385, which may be generated using the system directed audio detector 1340, the system directed image detector 1370, and/or the UED component 560. The disclosure is not limited thereto, however, and the system directed input detector 1285 may generate the SDD result 1385 using only the system directed audio detector 1340 and the UED component 560 without departing from the disclosure. Additionally or alternatively, in some examples the system directed input detector 1285 may generate the SDD result 1385 using only the UED component 560 without departing from the disclosure.

While not illustrated in FIG. 13, in some examples the system directed input detector 1285 may also receive information from a wakeword component. For example, an indication that a wakeword was detected (e.g., WW data) may be considered by the system directed input detector 1285 (e.g., by system directed audio detector 1340, system directed detector 1380, etc.) as part of the overall consideration of whether a system input was device directed. Detection of a wakeword may be considered a strong signal that a particular input was device directed.

If an input is determined to be system directed, the data related to the input may be sent to downstream components for further processing (e.g., to a language processing component). If an input is determined not to be system directed, the system 100 may take no further action regarding the data related to the input and may allow it to be deleted. In certain configurations, to maintain privacy, the operations to determine whether an input is system directed are performed by device 110 (or home server(s) associated with the device 110) and only if the input is determined to be system directed is further data (such as audio data 1311 or image data 1312) sent to system component(s) 120 that are outside a user's home or other direct control.

In some examples, the device 110 and/or the system component(s) 120 may include an image processing component. The image processing component may be located across different physical and/or virtual machines. The image processing component may receive and analyze image data (which may include single images or a plurality of images such as in a video feed). The image processing component may work with other components of the device 110 and/or the system component(s) 120 to perform various operations. For example the image processing component may work with user recognition component to assist with user recognition using image data. The image processing component may also include or otherwise be associated with image data storage which may store aspects of image data used by image processing component. The image data may be of different formats such as JPEG, GIF, BMP, MPEG, video formats, and the like.

Image matching algorithms, such as those used by image processing component, may take advantage of the fact that an image of an object or scene contains a number of feature points. Feature points are specific points in an image which are robust to changes in image rotation, scale, viewpoint or lighting conditions. This means that these feature points will often be present in both the images to be compared, even if the two images differ. These feature points may also be known as “points of interest.” Therefore, a first stage of the image matching algorithm may include finding these feature points in the image. An image pyramid may be constructed to determine the feature points of an image. An image pyramid is a scale-space representation of the image, e.g., it contains various pyramid images, each of which is a representation of the image at a particular scale. The scale-space representation enables the image matching algorithm to match images that differ in overall scale (such as images taken at different distances from an object). Pyramid images may be smoothed and downsampled versions of an original image.

To build a database of object images, with multiple objects per image, a number of different images of an object may be taken from different viewpoints. From those images, feature points may be extracted and pyramid images constructed. Multiple images from different points of view of each particular object may be taken and linked within the database (for example within a tree structure described below). The multiple images may correspond to different viewpoints of the object sufficient to identify the object from any later angle that may be included in a user's query image. For example, a shoe may look very different from a bottom view than from a top view than from a side view. For certain objects, this number of different image angles may be 6 (top, bottom, left side, right side, front, back), for other objects this may be more or less depending on various factors, including how many images should be taken to ensure the object may be recognized in an incoming query image. With different images of the object available, it is more likely that an incoming image from a user may be recognized by the system and the object identified, even if the user's incoming image is taken at a slightly different angle.

This process may be repeated for multiple objects. For large databases, such as an online shopping database where a user may submit an image of an object to be identified, this process may be repeated thousands, if not millions of times to construct a database of images and data for image matching. The database also may continually be updated and/or refined to account for a changing catalog of objects to be recognized.

When configuring the database, pyramid images, feature point data, and/or other information from the images or objects may be used to cluster features and build a tree of objects and images, where each node of the tree will keep lists of objects and corresponding features. The tree may be configured to group visually significant subsets of images/features to ease matching of submitted images for object detection. Data about objects to be recognized may be stored by the system in image data, profile storage, or other storage component.

Image selection component may select desired images from input image data to use for image processing at runtime. For example, input image data may come from a series of sequential images, such as a video stream where each image is a frame of the video stream. These incoming images need to be sorted to determine which images will be selected for further object recognition processing as performing image processing on low quality images may result in an undesired user experience. To avoid such an undesirable user experience, the time to perform the complete recognition process, from first starting the video feed to delivering results to the user, should be as short as possible. As images in a video feed may come in rapid succession, the image processing component may be configured to select or discard an image quickly so that the system can, in turn, quickly process the selected image and deliver results to a user. The image selection component may select an image for object recognition by computing a metric/feature for each frame in the video feed and selecting an image for processing if the metric exceeds a certain threshold. While the image selection component may be described as part of system component(s) 120, it may also be located on device 110 so that the device may select only desired image(s) to send to system component(s) 120, thus avoiding sending too much image data to system component(s) 120 (thus expending unnecessary computing/communication resources). Thus the device may select only the best quality images for purposes of image analysis.

The metrics used to select an image may be general image quality metrics (focus, sharpness, motion, etc.) or may be customized image quality metrics. The metrics may be computed by software components or hardware components. For example, the metrics may be derived from output of device sensors such as a gyroscope, accelerometer, field sensors, inertial sensors, camera metadata, or other components. The metrics may thus be image based (such as a statistic derived from an image or taken from camera metadata like focal length or the like) or may be non-image based (for example, motion data derived from a gyroscope, accelerometer, GPS sensor, etc.). As images from the video feed are obtained by the system, the system, such as a device, may determine metric values for the image. One or more metrics may be determined for each image. To account for temporal fluctuation, the individual metrics for each respective image may be compared to the metric values for previous images in the image feed and thus a historical metric value for the image and the metric may be calculated. This historical metric may also be referred to as a historical metric value. The historical metric values may include representations of certain metric values for the image compared to the values for that metric for a group of different images in the same video feed. The historical metric(s) may be processed using a trained classifier model to select which images are suitable for later processing.

For example, if a particular image is to be measured using a focus metric, which is a numerical representation of the focus of the image, the focus metric may also be computed for the previous N frames to the particular image. N is a configurable number and may vary depending on system constraints such as latency, accuracy, etc. For example, N may be 30 image frames, representing, for example, one second of video at a video feed of 30 frames-per-second. A mean of the focus metrics for the previous N images may be computed, along with a standard deviation for the focus metric. For example, for an image number X+1 in a video feed sequence, the previous N images, may have various metric values associated with each of them. Various metrics such as focus, motion, and contrast are discussed, but others are possible. A value for each metric for each of the N images may be calculated, and then from those individual values, a mean value and standard deviation value may be calculated. The mean and standard deviation (STD) may then be used to calculate a normalized historical metric value, for example STD(metric)/MEAN(metric). Thus, the value of a historical focus metric at a particular image may be the STD divided by the mean for the focus metric for the previous N frames. For example, historical metrics (HIST) for focus, motion, and contrast may be expressed as:

HIST_Focus=STD_Focus/MEAN_Focus
HIST_Motion=STD_Motion/MEAN_Motion
HIST_Contrast=STD_Contrast/MEAN_Contrast

In one embodiment the historical metric may be further normalized by dividing the above historical metrics by the number of frames N, particularly in situations where there are small number of frames under consideration for the particular time window. The historical metrics may be recalculated with each new image frame that is received as part of the video feed. Thus each frame of an incoming video feed may have a different historical metric from the frame before. The metrics for a particular image of a video feed may be compared historical metrics to select a desirable image on which to perform image processing.

Image selection component may perform various operations to identify potential locations in an image that may contain recognizable text. This process may be referred to as glyph region detection. A glyph is a text character that has yet to be recognized. If a glyph region is detected, various metrics may be calculated to assist the eventual optical character recognition (OCR) process. For example, the same metrics used for overall image selection may be re-used or recalculated for the specific glyph region. Thus, while the entire image may be of sufficiently high quality, the quality of the specific glyph region (i.e. focus, contrast, intensity, etc.) may be measured. If the glyph region is of poor quality, the image may be rejected for purposes of text recognition.

Image selection component may generate a bounding box that bounds a line of text. The bounding box may bound the glyph region. Value(s) for image/region suitability metric(s) may be calculated for the portion of the image in the bounding box. Value(s) for the same metric(s) may also be calculated for the portion of the image outside the bounding box. The value(s) for inside the bounding box may then be compared to the value(s) outside the bounding box to make another determination on the suitability of the image. This determination may also use a classifier.

Additional features may be calculated for determining whether an image includes a text region of sufficient quality for further processing. The values of these features may also be processed using a classifier to determine whether the image contains true text character/glyphs or is otherwise suitable for recognition processing. To locally classify each candidate character location as a true text character/glyph location, a set of features that capture salient characteristics of the candidate location is extracted from the local pixel pattern. Such features may include aspect ratio (bounding box width/bounding box height), compactness (4*π*candidate glyph area/(perimeter)2), solidity (candidate glyph area/bounding box area), stroke-width to width ratio (maximum stroke width/bounding box width), stroke-width to height ratio (maximum stroke width/bounding box height), convexity (convex hull perimeter/perimeter), raw compactness (4*π*(candidate glyph number of pixels)/(perimeter)2), number of holes in candidate glyph, or other features. Other candidate region identification techniques may be used. For example, the system 100 may use techniques involving maximally stable extremal regions (MSERs). Instead of MSERs (or in conjunction with MSERs), the candidate locations may be identified using histogram of oriented gradients (HoG) and Gabor features.

If an image is sufficiently high quality it may be selected by image selection for sending to another component (e.g., from device 110 to system component(s) 120) and/or for further processing, such as text recognition, object detection/resolution, etc.

The feature data calculated by image selection component may be sent to other components such as text recognition component, objection detection component, object resolution component, etc. so that those components may use the feature data in their operations. Other preprocessing operations such as masking, binarization, etc. may be performed on image data prior to recognition/resolution operations. Those preprocessing operations may be performed by the device prior to sending image data or by system component(s) 120.

Object detection component may be configured to analyze image data to identify one or more objects represented in the image data. Various approaches can be used to attempt to recognize and identify objects, as well as to determine the types of those objects and applications or actions that correspond to those types of objects, as is known or used in the art. For example, various computer vision algorithms can be used to attempt to locate, recognize, and/or identify various types of objects in an image or video sequence. Computer vision algorithms can utilize various different approaches, as may include edge matching, edge detection, recognition by parts, gradient matching, histogram comparisons, interpretation trees, and the like.

The object detection component may process at least a portion of the image data to determine feature data. The feature data is indicative of one or more features that are depicted in the image data. For example, the features may be face data, or other objects, for example as represented by stored data in profile storage. Other examples of features may include shapes of body parts or other such features that identify the presence of a human. Other examples of features may include edges of doors, shadows on the wall, texture on the walls, portions of artwork in the environment, and so forth to identify a space. The object detection component may compare detected features to stored data (e.g., in profile storage, image data, or other storage) indicating how detected features may relate to known objects for purposes of object detection.

Various techniques may be used to determine the presence of features in image data. For example, one or more of a Canny detector, Sobel detector, difference of Gaussians, features from accelerated segment test (FAST) detector, scale-invariant feature transform (SIFT), speeded up robust features (SURF), color SIFT, local binary patterns (LBP), trained convolutional neural network, or other detection methodologies may be used to determine features in the image data. A feature that has been detected may have an associated descriptor that characterizes that feature. The descriptor may comprise a vector value in some implementations. For example, the descriptor may comprise data indicative of the feature with respect to many (e.g., 256) different dimensions.

One statistical algorithm that may be used for geometric matching of images is the Random Sample Consensus (RANSAC) algorithm, although other variants of RANSAC-like algorithms or other statistical algorithms may also be used. In RANSAC, a small set of putative correspondences is randomly sampled. Thereafter, a geometric transformation is generated using these sampled feature points. After generating the transformation, the putative correspondences that fit the model are determined. The putative correspondences that fit the model and are geometrically consistent and called “inliers.” The inliers are pairs of feature points, one from each image, that may correspond to each other, where the pair fits the model within a certain comparison threshold for the visual (and other) contents of the feature points, and are geometrically consistent (as explained below relative to motion estimation). A total number of inliers may be determined. The above mentioned steps may be repeated until the number of repetitions/trials is greater than a predefined threshold or the number of inliers for the image is sufficiently high to determine an image as a match (for example the number of inliers exceeds a threshold). The RANSAC algorithm returns the model with the highest number of inliers corresponding to the model.

To further test pairs of putative corresponding feature points between images, after the putative correspondences are determined, a topological equivalence test may be performed on a subset of putative correspondences to avoid forming a physically invalid transformation. After the transformation is determined, an orientation consistency test may be performed. An offset point may be determined for the feature points in the subset of putative correspondences in one of the images. Each offset point is displaced from its corresponding feature point in the direction of the orientation of that feature point. The transformation is discarded based on orientation of the feature points obtained from the feature points in the subset of putative correspondences if any one of the images being matched and its offset point differs from an estimated orientation by a predefined limit. Subsequently, motion estimation may be performed using the subset of putative correspondences which satisfy the topological equivalence test.

Motion estimation (also called geometric verification) may determine the relative differences in position between corresponding pairs of putative corresponding feature points. A geometric relationship between putative corresponding feature points may determine where in one image (e.g., the image input to be matched) a particular point is found relative to that potentially same point in the putatively matching image (i.e., a database image). The geometric relationship between many putatively corresponding feature point pairs may also be determined, thus creating a potential map between putatively corresponding feature points across images. Then the geometric relationship of these points may be compared to determine if a sufficient number of points correspond (that is, if the geometric relationship between point pairs is within a certain threshold score for the geometric relationship), thus indicating that one image may represent the same real-world physical object, albeit from a different point of view. Thus, the motion estimation may determine that the object in one image is the same as the object in another image, only rotated by a certain angle or viewed from a different distance, etc.

The above processes of image comparing feature points and performing motion estimation across putative matching images may be performed multiple times for a particular query image to compare the query image to multiple potential matches among the stored database images. Dozens of comparisons may be performed before one (or more) satisfactory matches that exceed the relevant thresholds (for both matching feature points and motion estimation) may be found. The thresholds may also include a confidence threshold, which compares each potential matching image with a confidence score that may be based on the above processing. If the confidence score exceeds a certain high threshold, the system 100 may stop processing additional candidate matches and simply select the high confidence match as the final match. Or if, the confidence score of an image is within a certain range, the system 100 may keep the candidate image as a potential match while continuing to search other database images for potential matches. In certain situations, multiple database images may exceed the various matching/confidence thresholds and may be determined to be candidate matches. In this situation, a comparison of a weight or confidence score may be used to select the final match, or some combination of candidate matches may be used to return results. The system 100 may continue attempting to match an image until a certain number of potential matches are identified, a certain confidence score is reached (either individually with a single potential match or among multiple matches), or some other search stop indicator is triggered. For example, a weight may be given to each object of a potential matching database image. That weight may incrementally increase if multiple query images (for example, multiple frames from the same image stream) are found to be matches with database images of a same object. If that weight exceeds a threshold, a search stop indicator may be triggered and the corresponding object selected as the match.

Once an object is detected by object detection component the system 100 may determine which object is actually seen using object resolution component. Thus one component, such as object detection component, may detect if an object is represented in an image while another component, object resolution component may determine which object is actually represented. Although illustrated as separate components, the system 100 may also be configured so that a single component may perform both object detection and object resolution.

For example, when a database image is selected as a match to the query image, the object in the query image may be determined to be the object in the matching database image. An object identifier associated with the database image (such as a product ID or other identifier) may be used to return results to a user, along the lines of “I see you holding object X” along with other information, such giving the user information about the object. If multiple potential matches are returned (such as when the system can't determine exactly what object is found or if multiple objects appear in the query image) the system 100 may indicate to the user that multiple potential matching objects are found and may return information/options related to the multiple objects.

In another example, object detection component may determine that a type of object is represented in image data and object resolution component may then determine which specific object is represented. The object resolution component may also make available specific data about a recognized object to further components so that further operations may be performed with regard to the resolved object.

Object detection component may be configured to process image data to detect a representation of an approximately two-dimensional (2D) object (such as a piece of paper) or a three-dimensional (3D) object (such as a face). Such recognition may be based on available stored data which in turn may have been provided through an image data ingestion process managed by image data ingestion component. Various techniques may be used to determine the presence of features in image data. For example, one or more of a Canny detector, Sobel detector, difference of Gaussians, features from accelerated segment test (FAST) detector, scale-invariant feature transform (SIFT), speeded up robust features (SURF), color SIFT, local binary patterns (LBP), trained convolutional neural network, or other detection methodologies may be used to determine features in the image data. A feature that has been detected may have an associated descriptor that characterizes that feature. The descriptor may comprise a vector value in some implementations. For example, the descriptor may comprise data indicative of the feature with respect to many (e.g., 256) different dimensions.

In various embodiments, the object detection component may be configured to detect a user or a portion of a user (e.g., head, face, hands) in image data and determine an initial position and/or orientation of the user in the image data. Various approaches can be used to detect a user within the image data. Techniques for detecting a user can sometimes be characterized as either feature-based or appearance-based. Feature-based approaches generally involve extracting features from an image and applying various rules, metrics, or heuristics to determine whether a person is present in an image. Extracted features can be low-level image features, such as points (e.g., line intersections, high variance points, local curvature discontinuities of Gabor wavelets, inflection points of curves, local extrema of wavelet transforms, Harris corners, Shi Tomasi points), edges (e.g., Canny edges, Shen-Castan (ISEF) edges), or regions of interest (e.g., blobs, Laplacian of Gaussian blobs, Difference of Gaussian blobs, Hessian blobs, maximally stable extremum regions (MSERs)). An example of a low-level image feature-based approach for user detection is the grouping of edges method. In the grouping of edges method, an edge map (generated via, e.g., a Canny detector, Sobel filter, Marr-Hildreth edge operator) and heuristics are used to remove and group edges from an input image so that only the edges of the contour of a face remain. A box or ellipse is then fit to the boundary between the head region and the background. Low-level feature-based methods can also be based on gray level information or skin color. For example, facial features such as eyebrows, pupils, and lips generally appear darker than surrounding regions of the face and this observation can be used to detect a face within an image. In one such approach, a low resolution Gaussian or Laplacian of an input image is utilized to locate linear sequences of similarly oriented blobs and streaks, such as two dark blobs and three light blobs to represent eyes, cheekbones, and nose and streaks to represent the outline of the face, eyebrows, and lips. Geometric rules can be applied to analyze the spatial relationships among the blobs and streaks to verify whether a person is located in the image. Skin color can also be used as a basis for detecting and/or tracking a user because skin color comprises a limited range of the color spectrum that can be relatively efficient to locate in an image.

Extracted features can also be based on higher-level characteristics or features of a user, such as eyes, nose, and/or mouth. Certain high-level feature-based methods can be characterized as top-down or bottom-up. A top-down approach first attempts to detect a particular user feature (e.g., head or face) and then validates existence of a person in an image by detecting constituent components of that user feature (e.g., eyes, nose, mouth). In contrast, a bottom-up approach begins by extracting the constituent components first and then confirming the presence of a person based on the constituent components being correctly arranged. For example, one top-down feature-based approach is the multi-resolution rule-based method. In this embodiment, a person is detected as present within an image by generating from the image a set of pyramidal or hierarchical images that are convolved and subsampled at each ascending level of the image pyramid or hierarchy (e.g., Gaussian pyramid, Difference of Gaussian pyramid, Laplacian pyramid). At the highest level, comprising the lowest resolution image of the image pyramid or hierarchy, the most general set of rules can be applied to find whether a user is represented. An example set of rules for detecting a face may include the upper round part of a face comprising a set of pixels of uniform intensity, the center part of a face comprising a set of pixels of a second uniform intensity, and the difference between the intensities of the upper round part and the center part of the face being within a threshold intensity difference. The image pyramid or hierarchy is descended and face candidates detected at a higher level conforming to the rules for that level can be processed at finer resolutions at a lower level according to a more specific set of rules. An example set of rules at a lower level or higher resolution image of the pyramid or hierarchy can be based on local histogram equalization and edge detection, and rules for the lowest level or highest resolution image of the pyramid or hierarchy can be based on facial feature metrics. In another top-down approach, face candidates are located based on the Kanade projection method for locating the boundary of a face. In the projection method, an intensity profile of an input image is first analyzed along the horizontal axis, and two local minima are determined to be candidates for the left and right side of a head. The intensity profile along the vertical axis is then evaluated and local minima are determined to be candidates for the locations of the mouth, nose, and eyes. Detection rules for eyebrow/eyes, nostrils/nose, and mouth or similar approaches can be used to validate whether the candidate is indeed a face.

Some feature-based and appearance-based methods use template matching to determine whether a user is represented in an image. Template matching is based on matching a pre-defined face pattern or parameterized function to locate the user within an image. Templates are typically prepared manually “offline.” In template matching, correlation values for the head and facial features are obtained by comparing one or more templates to an input image, and the presence of a face is determined from the correlation values. One template-based approach for detecting a user within an image is the Yuille method, which matches a parameterized face template to face candidate regions of an input image. Two additional templates are used for matching the eyes and mouth respectively. An energy function is defined that links edges, peaks, and valleys in the image intensity profile to the corresponding characteristics in the templates, and the energy function is minimized by iteratively adjusting the parameters of the template to the fit to the image. Another template-matching method is the active shape model (ASM). ASMs statistically model the shape of the deformable object (e.g., user's head, face, other user features) and are built offline with a training set of images having labeled landmarks. The shape of the deformable object can be represented by a vector of the labeled landmarks. The shape vector can be normalized and projected onto a low dimensional subspace using principal component analysis (PCA). The ASM is used as a template to determine whether a person is located in an image. The ASM has led to the use of Active Appearance Models (AAMs), which further include defining a texture or intensity vector as part of the template. Based on a point distribution model, images in the training set of images can be transformed to the mean shape to produce shape-free patches. The intensities from these patches can be sampled to generate the intensity vector, and the dimensionality of the intensity vector may be reduced using PCA. The parameters of the AAM can be optimized and the AAM can be fit to an object appearing in the new image using, for example, a gradient descent technique or linear regression.

Various other appearance-based methods can also be used to locate whether a user is represented in an image. Appearance-based methods typically use classifiers that are trained from positive examples of persons represented in images and negative examples of images with no persons. Application of the classifiers to an input image can determine whether a user exists in an image. Appearance-based methods can be based on PCA, neural networks, support vector machines (SVMs), naïve Bayes classifiers, the Hidden Markov model (HMM), inductive learning, adaptive boosting (Adaboost), among others. Eigenfaces are an example of an approach based on PCA. PCA is performed on a training set of images known to include faces to determine the eigenvectors of the covariance matrix of the training set. The Eigenfaces span a subspace called the “face space.” Images of faces are projected onto the subspace and clustered. To detect a face of a person in an image, the distance between a region of the image and the “face space” is computed for all location in the image. The distance from the “face space” is used as a measure of whether image subject matter comprises a face and the distances from “face space” form a “face map.” A face can be detected from the local minima of the “face map.”

Neural networks are inspired by biological neural networks and consist of an interconnected group of functions or classifiers that process information using a connectionist approach. Neural networks change their structure during training, such as by merging overlapping detections within one network and training an arbitration network to combine the results from different networks. Examples of neural network-based approaches include Rowley's multilayer neural network, the autoassociative neural network, the probabilistic decision-based neural network (PDBNN), the sparse network of winnows (SNoW). A variation of neural networks are deep belief networks (DBNs) which use unsupervised pre-training to generate a neural network to first learn useful features, and training the DBN further by back-propagation with trained data.

Support vector machines (SVMs) operate under the principle of structural risk minimization, which aims to minimize an upper bound on the expected generalization error. An SVM seeks to find the optimal separating hyperplane constructed by support vectors, and is defined as a quadratic programming problem. The Naïve Bayes classifier estimates the local appearance and position of face patterns at multiple resolutions. At each scale, a face image is decomposed into subregions and the subregions are further decomposed according to space, frequency, and orientation. The statistics of each projected subregion are estimated from the projected samples to learn the joint distribution of object and position. A face is determined to be within an image if the likelihood ratio is greater than the ratio of prior probabilities, i.e., (P(imagelobject))/(P(image|non-object))>(P(non-object))/(P(object)). In HMM-based approaches, face patterns are treated as sequences of observation vectors each comprising a strip of pixels. Each strip of pixels is treated as an observation or state of the HMM and boundaries between strips of pixels are represented by transitions between observations or states according to statistical modeling. Inductive learning approaches, such as those based on Quinlan's C4.5 algorithm or Mitchell's Find-S algorithm, can also be used to detect the presence of persons in images.

AdaBoost is a machine learning boosting algorithm which finds a highly accurate hypothesis (i.e., low error rate) from a combination of many “weak” hypotheses (i.e., substantial error rate). Given a data set comprising examples within a class and not within the class and weights based on the difficulty of classifying an example and a weak set of classifiers, AdaBoost generates and calls a new weak classifier in each of a series of rounds. For each call, the distribution of weights is updated that indicates the importance of examples in the data set for the classification. On each round, the weights of each incorrectly classified example are increased, and the weights of each correctly classified example is decreased so the new classifier focuses on the difficult examples (i.e., those examples have not been correctly classified). An example of an AdaBoost-based approach is the Viola-Jones detector.

After at least a portion of a user has been detected in image data captured by a computing device, approaches in accordance with various embodiments track the detected portion of the user, for example using object tracking component. The object tracking component, gaze detector, or other component(s), may use user recognition data or other information related to the user recognition component to identify and/or track a user using image data, although the disclosure is not limited thereto.

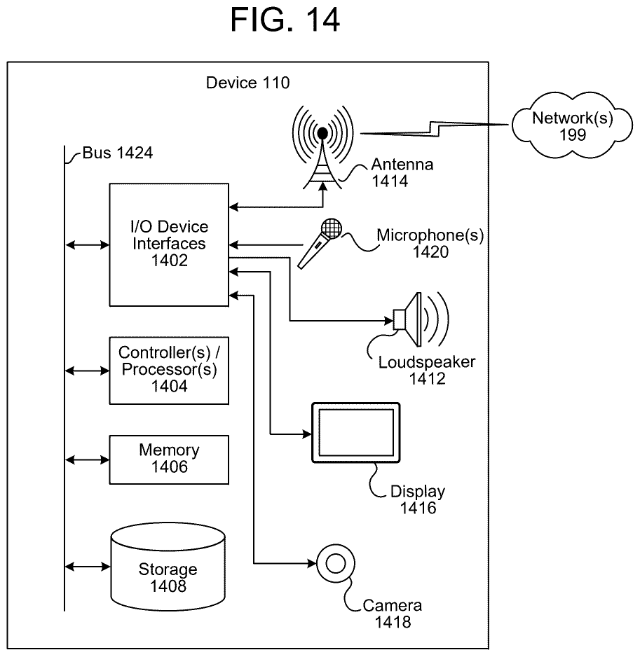

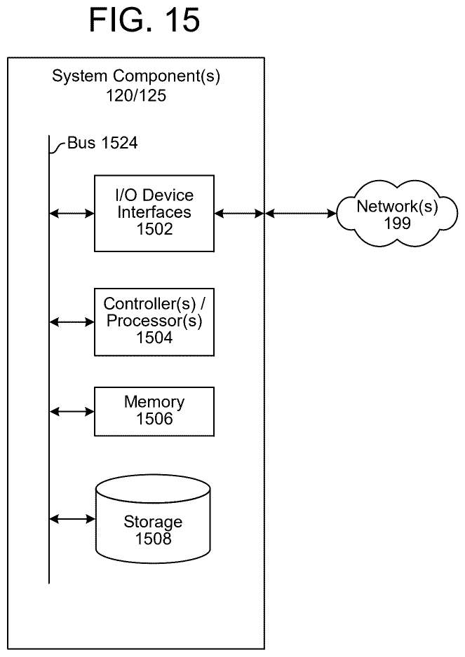

FIG. 14 is a block diagram conceptually illustrating a device 110 that may be used with the system. FIG. 15 is a block diagram conceptually illustrating example components of a remote device, such as the system component(s) 120, which may assist with ASR processing, NLU processing, language model processing, etc., and skill system component(s) 125. System component(s) (120/125) may include one or more servers. A “server” as used herein may refer to a traditional server as understood in a server/client computing structure but may also refer to a number of different computing components that may assist with the operations discussed herein. For example, a server may include one or more physical computing components (such as a rack server) that are connected to other devices/components either physically and/or over a network and is capable of performing computing operations. A server may also include one or more virtual machines that emulates a computer system and is run on one or across multiple devices. A server may also include other combinations of hardware, software, firmware, or the like to perform operations discussed herein. The server(s) may be configured to operate using one or more of a client-server model, a computer bureau model, grid computing techniques, fog computing techniques, mainframe techniques, utility computing techniques, a peer-to-peer model, sandbox techniques, or other computing techniques.

While the user device 110 may operate locally to a user (e.g., within a same environment so the device may receive inputs and playback outputs for the user) the server/system component(s) may be located remotely from the user device 110 as its operations may not require proximity to the user. The server/system component(s) may be located in an entirely different location from the user device 110 (for example, as part of a cloud computing system or the like) or may be located in a same environment as the user device 110 but physically separated therefrom (for example a home server or similar device that resides in a user's home or business but perhaps in a closet, basement, attic, or the like). The system component(s) 120 may also be a version of a user device 110 that includes different (e.g., more) processing capabilities than other user device(s) 110 in a home/office. One benefit to the server/system component(s) being in a user's home/business is that data used to process a command/return a response may be kept within the user's home, thus reducing potential privacy concerns.

Multiple system components (120/125) may be included in the overall system 100 of the present disclosure, such as one or more natural language processing system component(s) 120 for performing ASR processing, one or more natural language processing system component(s) 120 for performing NLU processing, one or more skill system component(s) 125, etc. In operation, each of these systems may include computer-readable and computer-executable instructions that reside on the respective device (120/125), as will be discussed further below.

Each of these devices (110/120/125) may include one or more controllers/processors (1404/1504), which may each include a central processing unit (CPU) for processing data and computer-readable instructions, and a memory (1406/1506) for storing data and instructions of the respective device. The memories (1406/1506) may individually include volatile random access memory (RAM), non-volatile read only memory (ROM), non-volatile magnetoresistive memory (MRAM), and/or other types of memory. Each device (110/120/125) may also include a data storage component (1408/1508) for storing data and controller/processor-executable instructions. Each data storage component (1408/1508) may individually include one or more non-volatile storage types such as magnetic storage, optical storage, solid-state storage, etc. Each device (110/120/125) may also be connected to removable or external non-volatile memory and/or storage (such as a removable memory card, memory key drive, networked storage, etc.) through respective input/output device interfaces (1402/1502).

Computer instructions for operating each device (110/120/125) and its various components may be executed by the respective device's controller(s)/processor(s) (1404/1504), using the memory (1406/1506) as temporary “working” storage at runtime. A device's computer instructions may be stored in a non-transitory manner in non-volatile memory (1406/1506), storage (1408/1508), or an external device(s). Alternatively, some or all of the executable instructions may be embedded in hardware or firmware on the respective device in addition to or instead of software.

Each device (110/120/125) includes input/output device interfaces (1402/1502). A variety of components may be connected through the input/output device interfaces (1402/1502), as will be discussed further below. Additionally, each device (110/120/125) may include an address/data bus (1424/1524) for conveying data among components of the respective device. Each component within a device (110/120/125) may also be directly connected to other components in addition to (or instead of) being connected to other components across the bus (1424/1524).

Referring to FIG. 14, the device 110 may include input/output device interfaces 1402 that connect to a variety of components such as an audio output component such as a loudspeaker 1412, a wired headset or a wireless headset (not illustrated), or other component capable of outputting audio. The device 110 may also include an audio capture component. The audio capture component may be, for example, a microphone 1420 or array of microphones, a wired headset or a wireless headset (not illustrated), etc. If an array of microphones is included, approximate distance to a sound's point of origin may be determined by acoustic localization based on time and amplitude differences between sounds captured by different microphones of the array. The device 110 may additionally include a display 1416 for displaying content and/or a camera 1418 to capture image data, although the disclosure is not limited thereto.

Via antenna(s) 1414/1514, the input/output device interfaces 1402/1502 may connect to one or more networks 199 via a wireless local area network (WLAN) (such as WiFi) radio, Bluetooth, and/or wireless network radio, such as a radio capable of communication with a wireless communication network such as a Long Term Evolution (LTE) network, WiMAX network, 3G network, 4G network, 5G network, etc. A wired connection such as Ethernet may also be supported. Through the network(s) 199, the system 100 may be distributed across a networked environment. The I/O device interface (1402/1502) may also include communication components that allow data to be exchanged between devices such as different physical servers in a collection of servers or other components.

The components of the device(s) (110/120/125) may include their own dedicated processors, memory, and/or storage. Alternatively, one or more of the components of the device(s) (110/120/125) may utilize the I/O interfaces (1402/1502), processor(s) (1404/1504), memory (1406/1506), and/or storage (1408/1508) of the device(s) (110/120/125).

As noted above, multiple devices may be employed in a single system. In such a multi-device system, each of the devices may include different components for performing different aspects of the system's processing. The multiple devices may include overlapping components. The components of the device(s) (110/120/125), as described herein, are illustrative, and may be located as a stand-alone device or may be included, in whole or in part, as a component of a larger device or system.

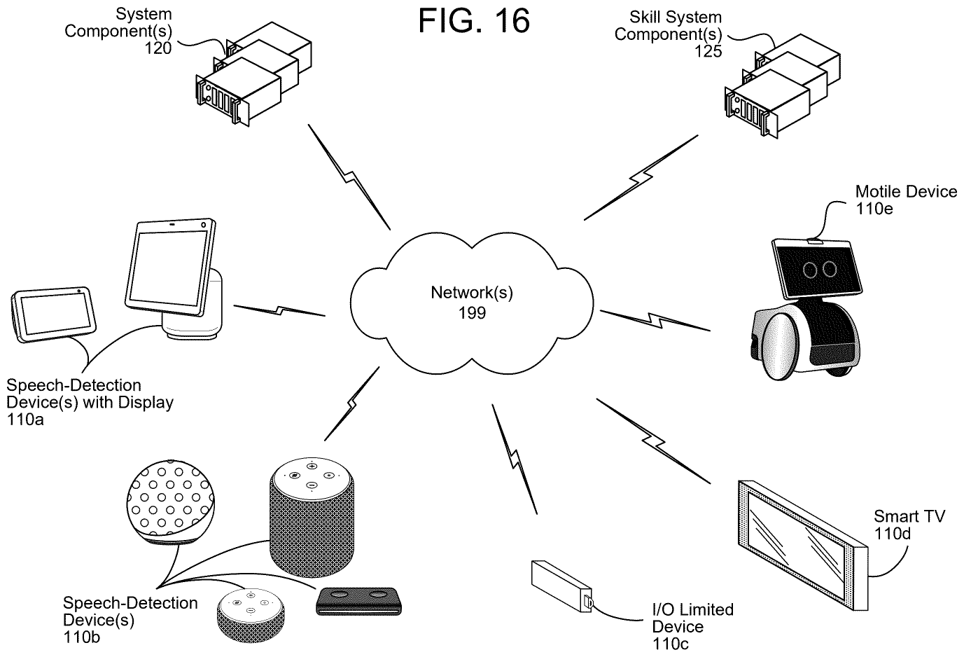

As illustrated in FIG. 16, multiple devices (110a-110e, 120, 125) may contain components of the system and the devices may be connected over a network(s) 199. The network(s) 199 may include a local or private network or may include a wide network such as the Internet. Devices may be connected to the network(s) 199 through either wired or wireless connections. For example, a speech-detection device with display 110a, a speech-detection device 110b, an input/output (I/O) limited device 110c (e.g., a device such as a FireTV stick or the like), a display/smart television 110d, a motile device 110e, and/or the like may be connected to the network(s) 199 through a wireless service provider, over a WiFi or cellular network connection, or the like. Other devices are included as network-connected support devices, such as system component(s) 120, skill system component(s) 125, and/or others. The support devices may connect to the network(s) 199 through a wired connection or wireless connection.

The concepts disclosed herein may be applied within a number of different devices and computer systems, including, for example, general-purpose computing systems, speech processing systems, and distributed computing environments.

The above aspects of the present disclosure are meant to be illustrative. They were chosen to explain the principles and application of the disclosure and are not intended to be exhaustive or to limit the disclosure. Many modifications and variations of the disclosed aspects may be apparent to those of skill in the art. Persons having ordinary skill in the field of computers and speech processing should recognize that components and process steps described herein may be interchangeable with other components or steps, or combinations of components or steps, and still achieve the benefits and advantages of the present disclosure. Moreover, it should be apparent to one skilled in the art, that the disclosure may be practiced without some or all of the specific details and steps disclosed herein.

Aspects of the disclosed system 100 may be implemented as a computer method or as an article of manufacture such as a memory device or non-transitory computer readable storage medium. The computer readable storage medium may be readable by a computer and may comprise instructions for causing a computer or other device to perform processes described in the present disclosure. The computer readable storage medium may be implemented by a volatile computer memory, non-volatile computer memory, hard drive, solid-state memory, flash drive, removable disk, and/or other media. In addition, components of system 100 may be implemented as in firmware or hardware, such as an audio front end (AFE), which comprises, among other things, analog and/or digital filters (e.g., filters configured as firmware to a digital signal processor (DSP)).

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements, and/or steps are in any way required for one or more embodiments or that one or more embodiments necessarily include logic for deciding, with or without other input or prompting, whether these features, elements, and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, Z,” unless specifically stated otherwise, is understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

As used in this disclosure, the term “a” or “one” may include one or more items unless specifically stated otherwise. Further, the phrase “based on” is intended to mean “based at least in part on” unless specifically stated otherwise.

What is claimed is:

1. An electronic device comprising:
a plurality of microphones;
a loudspeaker;
one or more processors; and
one or more computer readable media storing processor executable instructions which, when executed using the one or more processors, cause the electronic device to perform operations comprising:
determining first audio data corresponding to sound captured by at least two microphones of the plurality of microphones;
determining, based on the first audio data, first data indicating an estimated distance between the electronic device and a user;
determining, based on the first audio data, first sound source localization data comprising:
first cell data indicating a first three-dimensional vector and a first power value associated with the first three-dimensional vector, and
second cell data indicating a second three-dimensional vector and a second power value associated with the second three-dimensional vector;
determining, using the first sound source localization data, second data indicating an estimated angle of the user relative to the electronic device;
determining, based on the first audio data and the first sound source localization data, third data indicating an estimated direction in which the user is facing;
determining that speech is represented in the first audio data;
determining that the estimated distance between the electronic device and the user satisfies a first condition;
determining that the estimated angle of the user satisfies a second condition;
determining that the estimated direction in which the user is facing satisfies a third condition;
based on the first condition, the second condition, and the third condition being satisfied, generating fourth data indicating that the user is engaged with the electronic device; and
causing language processing to be performed on the first audio data.

2. The electronic device of claim 1, wherein the one or more computer readable media store further processor executable instructions which, when executed using the one or more processors, cause the electronic device to perform operations comprising:
determining that the estimated distance satisfies the first condition by determining that the estimated distance is below a distance threshold value;
determining that the estimated angle of the user satisfies the second condition by determining that the estimated angle is within a first range of angles relative to a front of the electronic device; and
determining that the estimated direction in which the user is facing satisfies the third condition by determining that the estimated direction is within a first range of directions, wherein the first range of directions face the front of the electronic device.

3. The electronic device of claim 1, wherein the one or more computer readable media store further processor executable instructions which, when executed using the one or more processors, cause the electronic device to perform operations comprising:
prior to determining the first audio data, generating ultrasonic output by emitting one or more ultrasonic signals;
detecting a reflection of the one or more ultrasonic signals represented in the first audio data; and
determining the estimated distance using the reflection of the one or more ultrasonic signals.

4. The electronic device of claim 1, wherein the one or more computer readable media store further processor executable instructions which, when executed using the one or more processors, cause the electronic device to perform operations comprising:
generating, using the first sound source localization data, first feature data representing a series of power values, wherein the series of power values includes the first power value;
generating, using the first sound source localization data, second feature data representing a series of three-dimensional vectors, wherein the series of three-dimensional vectors includes the first three-dimensional vector; and
processing the first feature data and the second feature data using a first machine learning model to determine the third data, wherein the third data includes a first value representing the estimated direction in which the user is facing.

5. An electronic device comprising:
a plurality of microphones;
a loudspeaker;
one or more processors; and
one or more computer readable media storing processor executable instructions which, when executed using the one or more processors, cause the electronic device to perform operations comprising:
determining, based on first audio data corresponding to sound captured by at least two microphones of the plurality of microphones, first data indicating an estimated distance between the electronic device and a user;
determining, based on the first audio data, first sound source localization data indicating, for a first cell of a plurality of cells:
first direction data indicating at least an azimuth of the first cell relative to the electronic device, and
a first power value associated with the first cell;
determining, using the first sound source localization data, second data indicating an estimated angle of the user relative to the electronic device;
determining, based on the first audio data and the first sound source localization data, third data indicating an estimated direction in which the user is facing;
based on the first data, the second data, and the third data, using a first machine learning model to determine model output estimating user engagement with the electronic device; and
executing, based on the model output, a first operation.

6. The electronic device of claim 5, wherein the one or more computer readable media store further processor executable instructions which, when executed using the one or more processors, cause the electronic device to perform operations comprising:
prior to determining the first data, generating ultrasonic output by emitting one or more ultrasonic signals;
generating the first audio data using at least two microphones of the plurality of microphones;
determining that a reflection of the one or more ultrasonic signals is represented in the first audio data; and
determining the estimated distance using the reflection of the one or more ultrasonic signals.

7. The electronic device of claim 5, wherein the one or more computer readable media store further processor executable instructions which, when executed using the one or more processors, cause the electronic device to perform operations comprising:
generating, using the first sound source localization data, first feature data representing a series of power values, wherein the series of power values includes the first power value;
generating, using the first sound source localization data, second feature data representing a series of direction vectors, wherein the series of direction vectors includes the first direction data; and
based on the first feature data and the second feature data, using a second machine learning model to determine the third data, wherein the third data includes a first value representing the estimated direction in which the user is facing.

8. The electronic device of claim 5, wherein the one or more computer readable media store further processor executable instructions which, when executed using the one or more processors, cause the electronic device to perform operations comprising:
determining, using the first sound source localization data, that the first cell corresponds to a sound source;
determining a first value indicating a likelihood that the user corresponds to the first cell;
determining that the first value satisfies a condition; and
determining, using the first direction data associated with the first cell, the estimated angle of the user relative to the electronic device.

9. The electronic device of claim 5, wherein the one or more computer readable media store further processor executable instructions which, when executed using the one or more processors, cause the electronic device to perform operations comprising:
generating first feature data using at least a portion of the first data, the second data, and the third data;
generating, by a first component of the electronic device, second audio data using the first audio data and the first feature data, wherein the first feature data is encoded in in one or more least significant bits of the second audio data;
sending, from the first component to a second component of the electronic device, the second audio data; and
generating, by the second component using the second audio data, second feature data corresponding to the first feature data.

10. The electronic device of claim 5, wherein the one or more computer readable media store further processor executable instructions which, when executed using the one or more processors, cause the electronic device to perform operations comprising:
determining fourth data using the first audio data, wherein the fourth data indicates that speech is represented in the first audio data;
based on the fourth data and the model output, using a second machine learning model to determine that the speech is directed to the electronic device; and
based on determining that the speech is directed to the electronic device, executing a second operation.

11. The electronic device of claim 5, wherein the one or more computer readable media store further processor executable instructions which, when executed using the one or more processors, cause the electronic device to perform operations comprising:
generating feature data using at least a portion of the first data, the second data, and the third data;
determining that speech is represented in the first audio data;
based on the feature data and the model output, using a second machine learning model to determine that the speech is directed to the electronic device; and
based on determining that the speech is directed to the electronic device, executing a second operation.

12. The electronic device of claim 5, wherein the one or more computer readable media store further processor executable instructions which, when executed using the one or more processors, cause the electronic device to perform operations comprising:
determining that a first portion of the model output indicates that the user is engaging with the electronic device;
executing, based on the first portion of the model output, the first operation;
determining that a second portion of the model output indicates that the user is not engaging with the electronic device; and
executing, based on the second portion of the model output, a second operation comprising at least one of:
turning off a light of the electronic device,
powering down a component of the electronic device, and
transitioning to an inactive or sleep state.

13. The electronic device of claim 5, wherein the first operation comprises sending at least a subset of the first audio data to a remote system, and wherein the one or more computer readable media store further processor executable instructions which, when executed using the one or more processors, cause the electronic device to perform operations comprising:
outputting, using the loudspeaker and based on first response data received from the remote system, audio representing speech responding to user speech.

14. A computer-implemented method, the method comprising:
determining, based on first audio data corresponding to sound captured by at least two microphones of a plurality of microphones of an electronic device, first data indicating an estimated distance between the electronic device and a user;
determining, based on the first audio data, first sound source localization data indicating, for a first cell of a plurality of cells:
first direction data indicating at least an azimuth of the first cell relative to the electronic device, and
a first power value associated with the first cell;
determining, using the first sound source localization data, second data indicating an estimated angle of the user relative to the electronic device;
determining, based on the first audio data and the first sound source localization data, third data indicating an estimated direction in which the user is facing;
based on the first data, the second data, and the third data, using a first machine learning model to determine model output estimating user engagement with the electronic device; and
executing, based on the model output, a first operation.

15. The computer-implemented method of claim 14, further comprising:
prior to determining the first data, generating ultrasonic output by emitting one or more ultrasonic signals;
generating the first audio data using at least two microphones of the plurality of microphones;
determining that a reflection of the one or more ultrasonic signals is represented in the first audio data; and
determining the estimated distance using the reflection of the one or more ultrasonic signals.

16. The computer-implemented method of claim 14, further comprising:
generating, using the first sound source localization data, first feature data representing a series of power values, wherein the series of power values includes the first power value;
generating, using the first sound source localization data, second feature data representing a series of direction vectors, wherein the series of direction vectors includes the first direction data; and
based on the first feature data and the second feature data, using a second machine learning model to determine the third data, wherein the third data includes a first value representing the estimated direction in which the user is facing.

17. The computer-implemented method of claim 14, further comprising:
determining, using the first sound source localization data, that the first cell corresponds to a sound source;
determining a first value indicating a likelihood that the user corresponds to the first cell;
determining that the first value satisfies a condition; and
determining, using the first direction data associated with the first cell, the estimated angle of the user relative to the electronic device.

18. The computer-implemented method of claim 14, further comprising:
generating first feature data using at least a portion of the first data, the second data, and the third data;
generating, by a first component of the electronic device, second audio data using the first audio data and the first feature data, wherein the first feature data is encoded in in one or more least significant bits of the second audio data;
sending, from the first component to a second component of the electronic device, the second audio data; and
generating, by the second component using the second audio data, second feature data corresponding to the first feature data.

19. The computer-implemented method of claim 14, further comprising:
determining fourth data using the first audio data, wherein the fourth data indicates that speech is represented in the first audio data;
based on the fourth data and the model output, using a second machine learning model to determine that the speech is directed to the electronic device; and
based on determining that the speech is directed to the electronic device, executing a second operation.

20. The computer-implemented method of claim 14, further comprising:
generating feature data using at least a portion of the first data, the second data, and the third data;
determining that speech is represented in the first audio data;
based on the feature data and the model output, using a second machine learning model to determine that the speech is directed to the electronic device; and
based on determining that the speech is directed to the electronic device, executing a second operation.
